(19) United States
(12) Patent Application Publication
(10) Pub. No.: US 2007/0126667 A1
(43) Pub. Date: Jun. 7, 2007

(54) EL DISPLAY APPARATUS AND METHOD FOR DRIVING EL DISPLAY APPARATUS

(75) Inventors: Norio NAKAMURA, Kanazawa-shi (JP); Hiroshi Takahara, Neyagawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/565,182

(22) Filed: Nov. 30, 2006

(30) Foreign Application Priority Data
Dec. 1, 2005 (JP) 2005-348486

(51) Int. Cl. G09G 3/30

(52) U.S. Cl. 345/76

(57) ABSTRACT

An EL display apparatus in which pixels having EL elements are formed in a matrix, has a constant current circuit which generates a predetermined constant current; and a gradation voltage circuit which generates a gradation voltage; wherein the constant current generated by the constant current circuit is supplied to the pixels via a source signal line; and the gradation voltage generated by the gradation voltage circuit is supplied to the pixels via the source signal line.

### CROSS-REFERENCE TO RELATED APPLICATIONS

This application claims priority to Japanese Patent Application No.2005-348486, filed in the Japanese Patent Office on Dec. 1, 2005, the entire contents of which are hereby incorporated herein by reference.

### BACKGROUND OF THE INVENTION

1. Field of the Invention

The present invention relates to a driving method, driving circuits and a display apparatus of a self-luminous display panel (display apparatus) such as an EL display panel (display apparatus), which employs organic or inorganic electroluminescence (EL) elements or the like, and relates to a display panel (display apparatus) using the driving circuits.

2. Description of the Related Art

An active-matrix image display apparatus using an organic electroluminescence (EL) material or an inorganic EL material as an electro-optic conversion material changes its emitting brightness according to a current written in pixels. The EL display panel is a self-luminous type with a light-emitting element for each pixel. The EL display panel has an advantage of higher image viewability, higher emission efficiency, unnecessity of a backlight and faster responding speed than they are in a liquid crystal display panel.

An active matrix organic EL display panel is disclosed in Japanese Patent Laid-Open No.8-234683. FIG. 3 shows an equivalent circuit of a pixel of the display panel. The pixel 16 includes an EL element 15, which is a light-emitting element, a first transistor (driver transistor) 11a, a second transistor (switching transistor) 11b and a storage capacitance (capacitor) 19. The light-emitting element 15 is an organic electroluminescence (EL) element.

A driver circuit, which drives a pixel configuration of FIG. 3, outputs a video signal shown by the strength of voltage. The driver circuit has a configuration similar to that of a driver circuit which drives a liquid crystal display panel. A voltage signal as a video signal is applied from the driver circuit to a source signal line 18. The applied voltage signal is applied to the pixel 16 and kept in the capacitor 19.

In this specification, the transistor 11a for supplying a current to the EL element 15 is referred to as a driver transistor. A transistor that operates as a switch like the transistor 11b of FIG. 3 is referred to as a switching transistor.

Organic EL display panels are made of low-temperature or high-temperature polysilicon transistor arrays. However, organic EL elements have a problem in that variations in the characteristics of the transistors of the polysilicon transistor array will cause display irregularities.

FIG. 3 shows a pixel configuration in a voltage program system. The voltage program system means a configuration, a circuit or a driving method for applying a voltage signal such as a video signal shown by the amount or the strength of voltage (program voltage) to a data signal line, a source signal line, a pixel or the like, converting the voltage signal into a current signal with a transistor of a pixel or the like and applying it to an EL element.

The current program system means a configuration, a circuit or a driving method for applying a current signal such as a video signal shown by the amount or the strength of current (program current) to a data signal line, a source signal line, a pixel or the like and applying the current signal that is applied by way of a transistor of a pixel, to an EL element as it is.

Both the current flowing into the EL element and the current flowing out from the EL element are referred to as application. The term “to drive the EL element” may also be used synonymous with “to apply a current” or “to supply a current to the EL element”. Alternatively, the current program system means a configuration, a circuit or a driving method for directly or indirectly applying a current signal almost proportional to the applied current signal or a current signal that is obtained by performing predetermined conversion on the applied current (program current) to the EL element.

In the image configuration shown in FIG. 3, a video signal shown by the strength of voltage is converted into a current signal at the driver transistor 11a. Therefore, if the transistor 11a varies in the characteristics, the converted current signals also vary. Generally, the transistor 11a has the variations in the characteristic of 50% or more. The configuration of FIG. 3 has aproblem in that it has display irregularities corresponding to the variations in the characteristics. However in the voltage program system, charging and discharging capacity of a signal line is high in either a low gradation region or a high gradation region so that display irregularities due to insufficient writing seldom occur.

With a configuration in the current program system adopted, the display irregularities due to the variations in the characteristics of the transistors can be reduced. The current program system, however, has a small driving current in the low gradation region, and has a problem in that it is not driven well due to a parasitic capacity of the source signal line 18.

### SUMMARY OF THE INVENTION

The present invention intends to provide an EL display apparatus and a method for driving the EL display apparatus, which causes insufficient writing more hardly than in the conventional art in all gradation regions and can reduce display irregularity due to the variations in the characteristics of the transistors to lower than in the conventional art in consideration of the abovementioned conventional problems.

The 1^{st} aspect of the present invention is an EL display apparatus in which pixels having EL elements are formed in a matrix, comprising:

a constant current circuit which generates a predetermined constant current; and

a gradation voltage circuit which generates a gradation voltage;

wherein said constant current generated by said constant current circuit is supplied to said pixels via a source signal line; and

said gradation voltage generated by said gradation voltage circuit is supplied to said pixels via said source signal line.

The 2^{nd} aspect of the present invention is a driving method of an EL display apparatus in which pixels having EL elements are formed in a matrix, wherein said EL display apparatus comprises:

a constant current circuit which generates a predetermined constant current; and

a gradation voltage circuit which generates a gradation voltage;

wherein said pixel has a driver transistor for supplying a driving current to said EL element and a switching transistor for forming a current path between a source signal line and said driver transistor;

said driving method of the EL display element comprises the steps of:

applying a constant current generated by said constant current circuit to said pixel via said source signal line;

obtaining a potential of said source signal line, while said constant current is applied to said source signal line; and

adding said obtained potential to said gradation voltage or subtracting said gradation voltage from said obtained potential, and applying the result of said addition or subtraction to said driver transistor of said pixels via said source signal line.

The 3^{rd} aspect of the present invention is the driving method of the EL display apparatus according to the 2^{nd} aspect of the present invention, wherein a pre-charge voltage is applied to said source signal line or said pixel during or before a period in which said constant current is applied to said pixel.

The 4^{th} aspect of the present invention is the driving method of the EL display apparatus according to the 2^{nd} aspect of the present invention, wherein a constant current circuit is formed by a plurality of unitary transistors.

The 5^{th} aspect of the present invention is an EL display apparatus in which pixels having EL elements are formed in a matrix, comprising:

a constant current circuit which generates a predetermined constant current; and

a gradation voltage circuit which generates a gradation voltage;

wherein said pixel has a driver transistor for supplying a driving current to said EL element, a capacitor connected to a gate terminal of said driver transistor, a first switching transistor for forming a current path between a source signal line and said driver transistor, and a second switching transistor for applying said gradation voltage to said driving transistor via said capacitor.

The 6^{th} aspect of the present invention is an EL display apparatus in which pixels having EL elements are formed in a matrix, comprising:

a constant current circuit which generates a predetermined constant current; and

a gradation voltage circuit which generates a gradation voltage;

a first signal line which supplies said constant current to said pixel; and

a second source signal line which supplies said gradation voltage to said pixel:

wherein said pixel has a driver transistor for supplying a driving current to said EL element, a capacitor connected to a gate terminal of said driver transistor, a first switching transistor for forming a current path between said first source signal line and said driver transistor, and a second switching transistor for forming an electronic path between said second source signal line and a capacitor.

The 7^{th} aspect of the present invention is an EL display apparatus in which pixels having EL elements are formed in a matrix, comprising:

a constant current circuit which generates a predetermined constant current;

a gradation voltage circuit which generates a gradation voltage;

a capacitor; and

a source signal line which supplies said constant current to said pixel;

wherein said gradation voltage is applied to said source signal line via said capacitor.

The 8^{th} aspect of the present invention is an EL display apparatus, comprising:

a display unit in which pixels having EL elements are formed in a matrix;

a constant current output circuit which outputs a reset current to a driver transistor of said EL element

a voltage holding circuit which obtains a gate terminal potential of said driver transistor while said reset current is applied;

a gradation voltage circuit which outputs a gradation voltage corresponding to a video signal; and

a voltage applying circuit which adds said gate terminal potential, to said gradation voltage or subtracts said gradation voltage from said gate terminal potential, and applying the result of said addition or subtraction to a gate terminal of said driver transistor.

The driver circuit and the EL display apparatus of the present invention include a current generating circuit and a voltage generating circuit. The constant current outputted from the current generating circuit is applied to the driver transistor that drives the EL elements (current program). As the constant current is applied to the driver transistor, a gate voltage of the driver transistor is subjected to a current program to flow the applied constant current. The constant current is referred to as a reset current Ia. The reset current Ia may be used to mean a standard current.

A current outputted from the source driver circuit 14 or a current written into the driver transistor is called a program current. A current, which is set for flowing a standard current to the driver transistor 11a or the like, is called a reset current Ia. Therefore, if a current outputted from the source driver circuit 14 is the reset current, the program current=reset current.

The state where the constant current is applied or changed as mentioned above is referred to as a current reset state. A voltage to be applied to the gate terminal of the driver transistor or a voltage to be generated therein, when the driver transistor flows the constant current, is referred to as a reset voltage Va. A voltage, which will be a certain standard, may be referred to as a reset voltage Va.

The voltage generating circuit outputs the gradation voltage Vx or a target gradation voltage Vc corresponding to a video signal to be inputted to the EL display apparatus. The gradation voltage or the like is applied to a gate terminal of the driver transistor with the reset voltage Va as a standard (voltage program). For example, if the reset voltage Va is 3V, ± gradation voltage Vx is applied with the reset voltage Va of 3V as a standard. If Vx=0, the driver transistor 11a flows the reset current Ia, which has been subjected to the current program, to the EL element 15 as a luminous current. That is to say, the current to be flown into the EL element 15 is decided with the reset voltage Va as a standard.

The driver circuit or the EL display apparatus in another embodiment of the present invention includes a voltage holding circuit which measures a gate terminal voltage (reset voltage Va) of the driver transistor or holds it for a predetermined period with a constant current (reset current Ia) being applied.

The current program (system) may be referred to as a current driving (system). The voltage program (system) may be referred to as a voltage driving (system).

The driver circuit means not only what includes a semiconductor IC such as silicon but also what is formed on a glass substrate with a low temperature polysilicon.

The present invention is effective in that insufficient writing more hardly occurs in all the gradation regions than in the conventional art and it can reduce display irregularities due to the variations in the characteristics of the transistors to lower than in the conventional art.

According to the present invention, the reset current Ia is applied to the driver transistor 11a of each pixel and is generated the reset voltage Va of the driver transistor 11a. The reset voltage Va of the driver transistor 11a for each pixel varies depending on the characteristics of each driver transistor 11a. This is because the variation occurs due to a laser annealing state. If the target gradation voltage Vc is applied with the reset voltage Va as a standard, an accurate gradation current can be applied to the EL element 15 even with different characteristics of each driver transistor 11a. As an absolute value of the gradation voltage increases, variations of the current to be flown into the EL element 15 increase. The variation, however, is actually not so much as to cause a problem.

The voltage program system has a disadvantage in that the characteristics of the driver transistor 11a of the pixel 16 are not compensated sufficiently. The present invention, however, implements the current program system for applying a constant current to the transistor of the pixel 16. According to the present invention, the gradation voltage Vx is applied with a gate terminal voltage (reset voltage Va) of the driver transistor 11a, which is generated by implementation of the current program, as a standard (origin) (voltage program). Therefore, the target gradation voltage Vc to be applied to the gate terminal of the driver transistor 11a is Va±Vx. Thus, even with the variations of the characteristics of the driver transistor 11a, a gradation current corresponding to an accurate gradation voltage can be flown into the EL element 15.

By making the reset current Ia a current value of a predetermined value or more, the problem of insufficient writing in the low gradation region (low current region), which is a disadvantage of the current program system, does not occur. By adding or subtracting the gradation voltage Vx with the reset voltage Va as a standard, the advantage that insufficient writing does not occur in all the gradation regions, which is characteristics of the voltage driving, can be implemented.

### BRIEF DESCRIPTION OF THE DRAWINGS

FIG. 1 is a schematic diagram of the display apparatus of the present invention;

FIG. 2 is a schematic diagram of a pixel of the display apparatus of the present invention;

FIG. 3 is a schematic diagram of a conventional display apparatus;

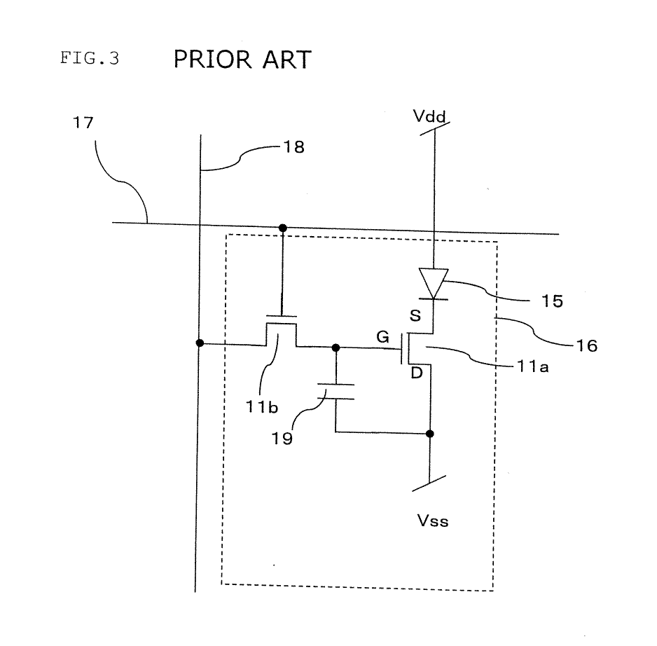

FIG. 4A to FIG. 4C are illustrations of an operation of the display apparatus of the present invention;

FIG. 5 is a schematic diagram of the display apparatus of the present invention;

FIG. 6 is a schematic diagram of the display apparatus of the present invention;

FIG. 7 is an illustration of the display apparatus of the present invention;

FIG. 8 is a schematic diagram of the display apparatus of the present invention;

FIG. 9 is a schematic diagram of the display apparatus of the present invention;

FIG. 10A and FIG. 10B are schematic diagrams of the display apparatus of the present invention;

FIG. 11 is an illustration of the display apparatus of the present invention;

FIG. 12 is an illustration of the display apparatus of the present invention;

FIG. 13 is an illustration of the display apparatus of the present invention;

FIG. 14 is an illustration of the display apparatus of the present invention;

FIG. 15 is an illustration of a driving method of the display apparatus of the present invention;

FIG. 16A and FIG. 16B are illustrations of a driving method of the display apparatus of the present invention;

FIG. 17A and FIG. 17B are illustrations of the display apparatus of the present invention;

FIG. 18A and FIG. 18B are illustrations of a driving method of the display apparatus of the present invention;

FIG. 19A to FIG. 19C are illustrations of a driving method of the display apparatus of the present invention;

FIG. 20 is a schematic diagram of the display apparatus of the present invention;

FIGS. 21A and FIG. 21B are illustrations of a driving method of the display apparatus of the present invention;

FIGS. 22A and 22B are schematic diagrams of a driving method of the display apparatus of the present invention;

FIG. 23 is an illustration of the display apparatus of the present invention;

FIG. 24 is an illustration of the display apparatus of the present invention;

FIG. 25A and FIG. 25B are illustrations of the display apparatus of the present invention;

FIG. 26 is an illustration of the display apparatus of the present invention;

FIG. 27 is an illustration of the display apparatus of the present invention;

FIG. 28 is a schematic diagram of the display apparatus of the present invention;

FIG. 29A and FIG. 29B are schematic diagrams of the display apparatus of the present invention;

FIG. 30A and FIG. 30B are schematic diagrams of the display apparatus of the present invention;

FIG. 31A and FIG. 31B are schematic diagrams of the display apparatus of the present invention;

FIG. 32 is a schematic diagram of the display apparatus of the present invention;

FIG. 33 is a schematic diagram of the display apparatus of the present invention;

FIG. 34 is a schematic diagram of the display apparatus of the present invention;

FIG. 35 is a schematic diagram of the display apparatus of the present invention;

FIG. 36 is a schematic diagram of the display apparatus of the present invention;

FIG. 37 is a schematic diagram of the display apparatus of the present invention;

FIG. 38 is a schematic diagram of the display apparatus of the present invention;

FIG. 39 is a schematic diagram of the display apparatus of the present invention;

FIG. 40 is a schematic diagram of the display apparatus of the present invention;

FIG. 41 is a schematic diagram of the display apparatus of the present invention;

FIG. 42 is a schematic diagram of the display apparatus of the present invention;

FIG. 43 is a schematic diagram of the display apparatus of the present invention;

FIG. 44 is a schematic diagram of the display apparatus of the present invention;

FIG. 45 is a schematic diagram of the display apparatus of the present invention;

FIG. 46 is a schematic diagram of the display apparatus of the present invention;

FIG. 47 is a schematic diagram of the display apparatus of the present invention;

FIG. 48 is a schematic diagram of the display apparatus of the present invention;

FIG. 49 is a schematic diagram of the display apparatus of the present invention;

FIG. 50 is a schematic diagram of the display apparatus of the present invention;

FIG. 51 is a schematic diagram of the display apparatus of the present invention;

FIG. 52 is a schematic diagram of the display apparatus of the present invention;

FIG. 53 is a schematic diagram of the display apparatus of the present invention;

FIG. 54 is a schematic diagram of the display apparatus of the present invention; and

FIG. 55 is a schematic diagram of the display apparatus of the present invention.

### DESCRIPTION OF SYMBOLS

10 constant current output circuit
11 Transistor (thin-film transistor, TFT)
12 Gate driver IC (circuit)
14 Source driver IC (circuit)
15 EL (element, light-emitting element)
16 Pixel
17 Gate signal line
18 Source signal line
19 Storage capacitance (additional capacitor, additional capacitance)
20 Voltage gradation circuit
21 Output terminal
55 DA conversion circuit
52 capacitor (DC component cut circuit)
53 operation amplifier
61 additional circuit
62 AD conversion circuit
91 emitter follower circuit
181 written line
182 non-display area (non-lighting area, black display area
183 display area (lighting area, image display area)
184 display area (display screen, display part)
201 shift register circuit
202 buffer circuit
281 switch (on-off unit)
282 inside wiring (output wiring)
283 gate wiring
284 unitary transistor
291 operation amplifier
292 transistor
331 electronic volume
341 coincidence circuit
342 counter
343 AND circuit
351 latch circuit
352 selector circuit
353 pre-charge circuit
361 sample holding circuit (voltage holding unit)
381 switch circuit
411 gradation voltage circuit
413 constant current circuit(current generating circuit)
501 current holding circuit
521 temperature detecting circuit
522 external storage circuit
523 A/D conversion circuit
524 Selector circuit
525 Data comparing circuit
526 Temperature compensation circuit
531 antenna
532 key
533 cabinet
534 display panel
541 pointing support (rotation unit)
542 shooting lens (shooting unit)
543 storage unit
544 switch
551 body
552 shooting unit
553 shutter switch

### DETAILED DESCRIPTION OF THE PREFERRED EMBODIMENTS

Embodiments of the EL display apparatus and the method for driving EL display apparatus of the present invention will be described hereinafter.

### First Embodiment

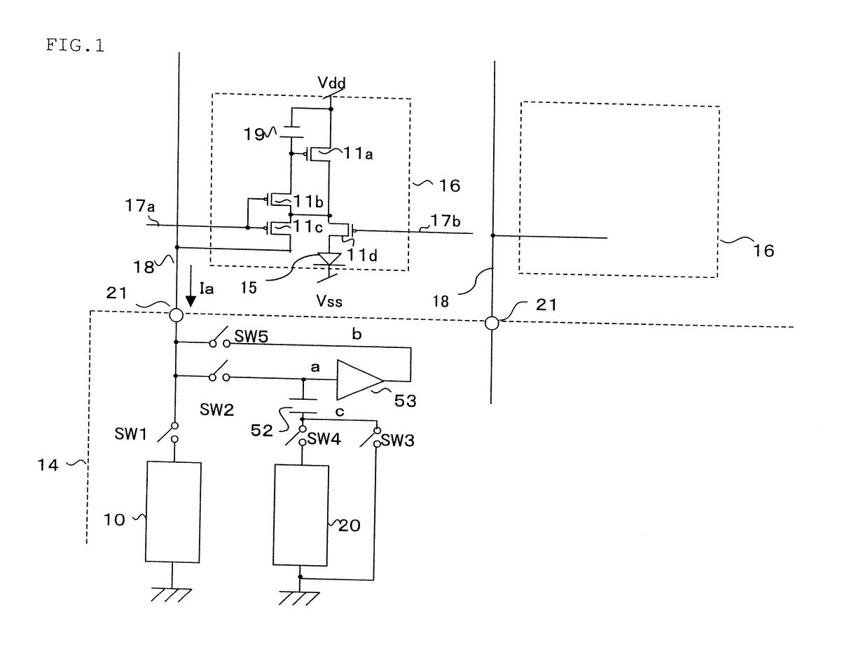

FIG. 1 is a schematic diagram of a driving circuit of an EL display apparatus of the present invention. An output terminal 21 of the source driver IC (circuit) 14 is connected to a source signal line 18. A plurality of pixels 16 are connected to each source signal line 18. An EL element 15 is formed on a pixel 16 and the pixels 16 are arranged in a matrix.

A constant current output circuit (current gradation circuit) 10 and a voltage gradation circuit 20 are configured or formed on each of the output terminals 21. The constant current output circuit 10 preferably outputs a gradation current such as a program current. In a first embodiment, however, the constant gradation output circuit 10 needs not to be able to output gradation current and only needs to output a predetermined constant current (program current).

By making it possible to output various amounts of constant current, the amount of the reset current Ia can be changed or altered according to the gradation voltage Vx. The amount of the constant current can be modified or set according to the panel size or the amount of the parasitic capacity of the source signal line 18. Therefore, the advantage is provided in that the current program can be realized well.

To each output, switches SW1, SW2, SW3, SW4 and SW5 are formed or arranged. A capacitor 52, and a buffer 53 are also formed or arranged. The capacitor 52 may be any capacitor if only it has a function of cutting a direct current (DC) component. The capacitor 52 may be any capacitor if only it can shift the level of a potential.

The buffer 53 may be any buffer if only a part “a” of its input is at high impedance and a part “b” of its output is at low impedance. For example, a buffer amplifier or an operation amplifier is exemplified. Alternatively an emitter follower circuit may be formed by a transistor element.

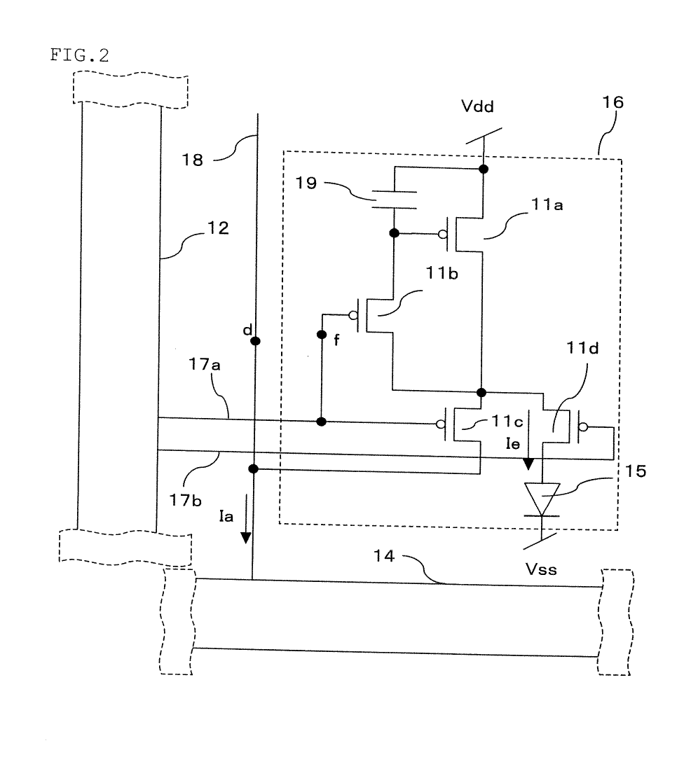

The pixels 16 of the EL display panel (EL display apparatus) of the present invention are structured such that a pixel 16 includes four transistors 11 and an EL element 15 as shown in FIG. 2. The pixel 16 is configured such that at least a current path via the transistor 11a, which drives the EL element 15, can extend to the source signal line 18.

In the pixel configuration of FIG. 2, a current flowing into the transistor 11a (driver transistor 11a), which supplies a current to the EL element 15, can be retrieved to the source signal line as the transistor 11c is turned on (closed). Alternatively, it is a pixel configuration, in which at least a voltage applying to (being applied to) a gate terminal of the transistor for driving the EL element 15 can be read from the source signal line 18.

In the pixel configuration of FIG. 2, a gate terminal voltage of the transistor 11a for supplying a current to the EL element 15 (driver transistor 11a) can be read from the source signal line 18 as the transistors 11b and 11c are turned on (closed).

The pixel circuit of FIG. 2 has four transistors 11 (11a, 11b, 11c, 11d) in a pixel. A gate terminal of the driver transistor 11a is connected to the source terminal of the transistor 11b. Gate terminals of the transistor 11b and the transistor 11c are connected to the gate signal line 17a. A drain terminal of the transistor 11b is connected to the source terminal of the transistor 11c and the source terminal of the transistor 11d. A drain terminal of the transistor 11c is connected to the source signal line 18. A gate terminal of the transistor 11d is connected to the gate signal line 17b, and a drain terminal of the transistor 11d is connected to an anode electrode (terminal) of the EL element 15.

The transistor 11 is formed by a P channel transistor. The P channel transistor is preferable as it has a high reliability in long life. In the configuration of FIG. 2, the current Ia flowing from the driver transistor 11a to the source driver circuit 14 is sunk into the source driver circuit 14. A transistor with N channels is formed on the source driver circuit 14. The transistor with N channels can well absorb the sink current Ia. The transistor with N channels has small variations in the characteristics. That can downsize the source driver circuit 14.

In the pixel configuration of FIG. 2, gate terminals of the transistors 11b, and 11c are connected to the gate signal line 17a. The transistors 11b, and 11c are controlled between on (close) and off (open) by an on-off control signal applied to the gate signal line 17a. The gate terminal of the transistor 11d is connected to the gate signal line 17b. The transistor 11d is controlled between on (close) and off (open) by the on-off control signal applied to the gate signal line 17b.

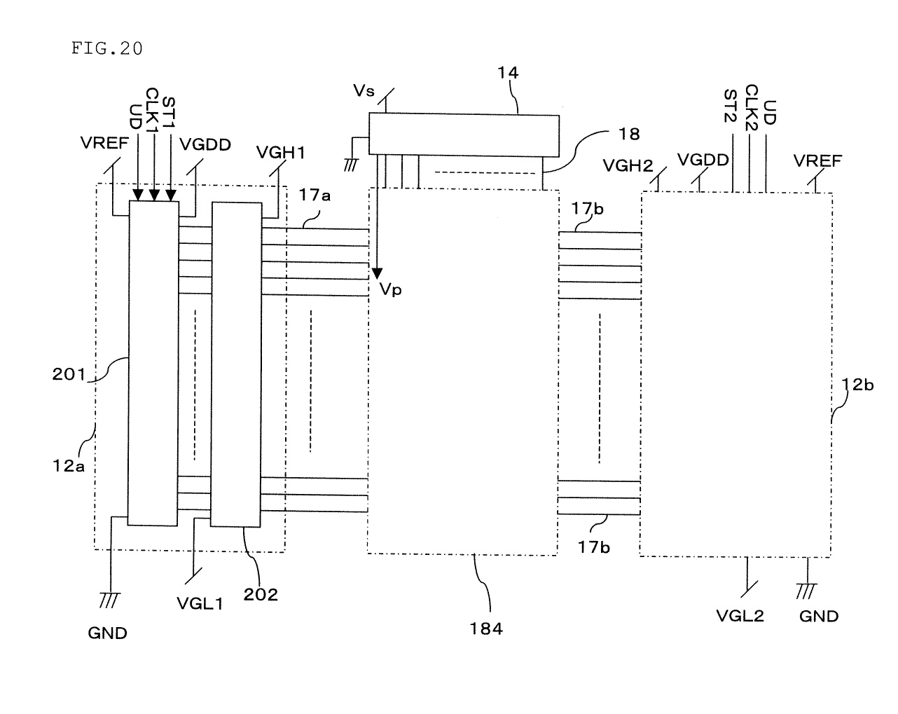

The gate driver 12 (gate driver circuits 12a, and 12b in FIG. 20) controls the gate signal lines 17a, and 17b. As shown in FIG. 20, a gate driver circuit 12a can be formed or arranged to the left of a display area 184 and a gate driver circuit 12b can be formed or arranged to the right of the display area 184. The gate driver circuit 12a controls the gate signal line 17a and the gate driver circuit 12b controls the gate signal line 17b. The gate driver circuit 12a and the gate driver circuit 12b have shift register circuits formed inside so that they can operate independently.

In the pixel configuration of the organic EL shown in FIG. 2, the transistor 11b functions as a switching transistor for selecting a pixel. A transistor 11a functions as a driver transistor for supplying a current to the EL element 15.

The transistor 11b is structured as a multi-gate, which is a dual gate or more. The transistor 11b forming the pixels 16 of the display panel of the present invention works as a switch between the source and the drain of the transistor 11a. Therefore, the transistor 11b is required to have low leak current characteristics as much as possible. The low leak current characteristics can be achieved as a multi-gate structure of a dual gate structure or more is used for the gate structure of the transistor 11b.

It is preferable that all the transistors 11 forming a pixel be formed as a P channel and the gate driver circuit 12 be also formed as a P channel for manufacturing a panel in a low cost. With an array formed by a transistor only made up with the P channel, five masks are formed so that the cost can be reduced and a yield rate can be increased.

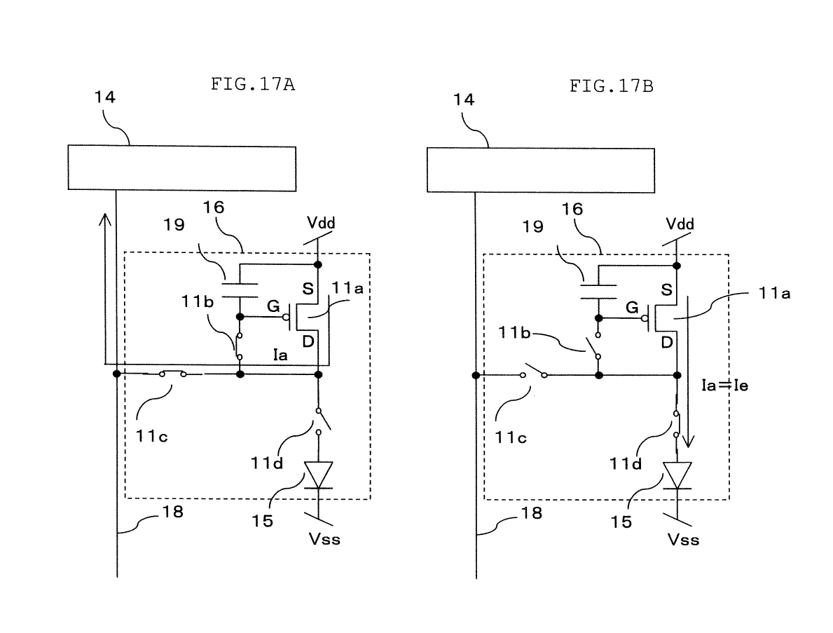

Description will be given with reference to FIGS. 17A and 17B. The description below is for helping to understand a pixel configuration in a current driving system. The present invention has a pixel configuration (pixel configuration which can be subjected to current program) in a current driving system. The present invention is characterized in that a program current (reset current Ia) is caused to flow to the driver transistor 11a of the pixel 16 and the gate terminal potential of the driver transistor 11a is measured or kept for a certain period, while a program current is flowing. The present invention is characterized by adding or subtracting a gradation voltage to or from the gate terminal potential to write the added or subtracted voltage in the gate terminal of the driver transistor 11a of a pixel.

An operation of the pixel of the present invention is controlled by two operations of the first operation and the second operation. FIGS. 17A and 17B are schematic diagrams of an operation in the pixel configuration of FIG. 2. The first operation is an operation of a current program (operation for setting a current to be flown into the EL element 15). The first operation is largely divided into a current reset operation, a voltage reading operation for applying the reset current Ia and reading a reset potential of the gate terminal of the driver transistor 11a, a gradation voltage applying operation for applying a gradation voltage or a target gradation voltage with the reset voltage Va as a standard (a center or an origin). The second operation is an operation for flowing a current in the EL element 15 so that the EL element 15 emits light. FIG. 17A is a schematic diagram of the first operation. FIG. 17B is a schematic diagram of the second operation.

The EL display panel and a method for driving the EL display panel of the present invention will be described with reference to FIG. 1 and FIGS. 17A and 17B.

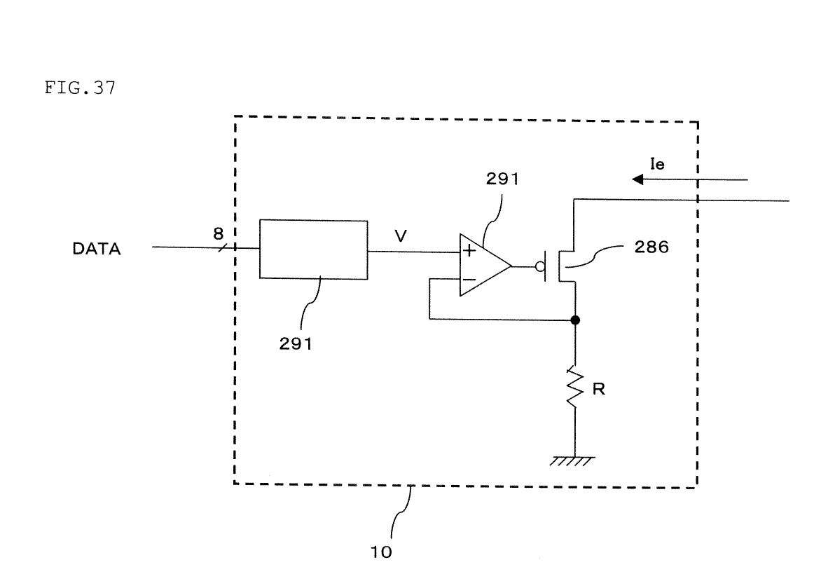

The first operation is an operation for storing a current value to be flown into the EL element 15. First, the reset current Ia, which is a predetermined constant current, is applied from the constant current output circuit 10 of the source driver IC (circuit) 14 to the source signal line 18. FIG. 37 shows an example of the constant current output circuit 10.

The constant current output circuit 10 includes an operation amplifier 291, a transistor 286 and a resistor R as an example. To a + side terminal of the operation amplifier 291, an electronic volume 331 is connected. The electronic volume 331 operates as a DA conversion circuit, which converts digital data into analog data. The output volume V of the electronic volume 331 is altered by set data (digital data). The current Ia flowing into the source signal line 18 has a value of the output voltage V of the electronic volume 331 divided by the resistance R.

The reset current Ia is not limited to be generated by the constant current output circuit 10 and may be generated by any circuit if only it can generate the reset current Ia with the amount in a predetermined or certain range. For example, an emitter follower circuit can generate the reset current Ia. Preferably, the constant current output circuit 10 is adapted to generate the reset current Ia of a plurality of amounts. More preferably, the reset current Ia can be generated corresponding to each of gradation voltages.

The reset current Ia includes a state of the current 0 (Ia=0, no current flows). In the pixel configuration of FIG. 2, the driver transistor 11a fluctuates (makes variable) the potential of the gate terminal (potential of a terminal of the capacitor 19) so that no current flows, where the program current Ia=0. The reset voltage Va of the gate terminal of the fluctuated driver transistor 11a shows characteristics of the driver transistor 11a. The reset voltage Va with the reset current Ia=0 is an operation start voltage of the driver transistor 11a.

When the program current Ia is applied from the source driver IC (circuit) 14 to the source signal line 18, the transistor 11b and the transistor 11c are turned on (closed) as shown in FIG. 17A. The transistor 11d is controlled to be in an open state. The transistors 11b, 11c and 11d are controlled with an on-off signal to be applied to the gate signal lines 17a, and 17b.

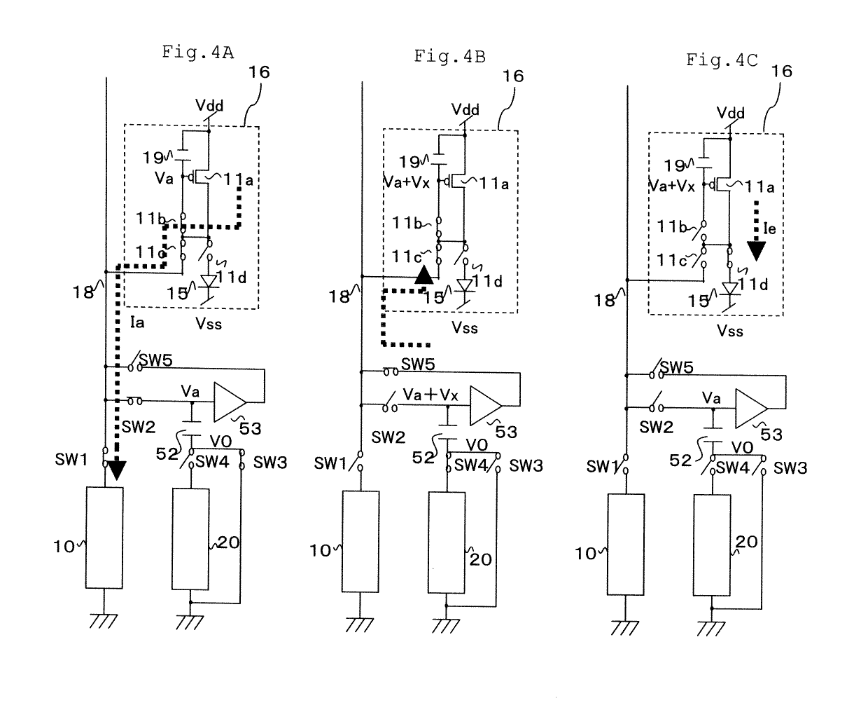

As shown in FIG. 4A, the source driver IC (circuit) 14 performs a reset operation before applying the program current (reset current Ia). In the reset operation, the switches SW4 and SW5 shown in FIG. 1 and FIGS. 4A to 4C are set in an open (OFF) state. The switches SW2 and SW3 are closed (turned on) and a grand potential or a predetermined fixed voltage is applied to the capacitor 52. A program current may be applied to the source signal line 18 with the switch SW1 closed.

The abovementioned operation is the reset operation. In the reset operation, a fixed (given) voltage is applied to a terminal c of the capacitor 52. The given voltage includes a grand voltage. The capacity of the capacitor 52 preferably ranges from 0.05 pF to 2 pF.

In the voltage reading operation below, the switch SW1 is closed and the program current (reset current) Ia is applied to the source signal line 18. Here, the switches SW4 and SW5 are in an open state, while the switch SW2 is in a closed state (see FIG. 4A).

The driver transistor 11a of the pixel 16 shown in FIGS. 17A and 17B flows the program current Ia and changes the gate terminal potential so as to flow the program current Ia. As the transistors 11b and 11c are in a closed state, the gate terminal potential is outputted (read out) to the source signal line 18. The switch SW2 in the source driver IC (circuit) 14 is closed. As a result, the gate terminal potential of the driver transistor 11a for flowing the program current (reset current) Ia is applied (read out) to the part “a” of the source driver IC (circuit) 14 (see FIG. 1).

The amount of the program current (reset current) Ia is preferably set in a range from ⅛ times of the maximum gradation current to the maximum gradation current. The amount may beset in a range from the maximum gradation current to ten times of the maximum gradation current to shorten the writing period. The maximum gradation current is the amount of the current to be flown into the EL element 15 or the amount of the program current to be programmed in the pixel 16 in the maximum gradation. For example, for 256 gradations, the maximum gradation current is a current which is programmed to the EL element 15 at the 256^{th} gradation (the gradation number is assumed to start at 0 gradation).

When a program current (reset current Ia) is small, charging or discharging a parasitic capacity of the source signal line 18 requires a long time. Thus, change in the gate potential of the driver transistor 11a does not converge in the first short time of one horizontal scanning period (1H period). A high program current (reset current Ia) lowers the characteristic compensation in a low gradation region, in which an influence of the variations of the characteristics of the driver transistor 11a is relatively apt to appear as an image display.

With the abovementioned operation, the gate terminal potential of the driver transistor 11a is read out to the part “a” of the capacitor 52. Alternatively, it is kept in the part “a” of the capacitor 52. In the embodiment of FIG. 1, the gate terminal potential of the driver transistor 11a is read out to the part “a” of the capacitor 52 and kept there. The present invention is not limited to that. For example, a potential of the part “a” may be subjected to AD (analog-digital) conversion to obtain digital data. The obtained digital data is kept in a memory circuit formed or configured inside or outside the source driver IC (circuit) 14. It is a matter of course that the data may be kept in storage means or the like inside or outside the source driver IC (circuit) 14 for a certain period in a form of analog data.

The next operation is for applying a gradation voltage with the read voltage as a standard (a center position or an origin position) (see FIG. 4B). In the operation, switches SW1, SW2 and SW3 are controlled in the open state, while switches SW4 and SW5 are controlled in a closed state. The gate terminal voltage (reset voltage Va (see FIG. 4A)) of the driver transistor 11a of the selected pixel 16 is being kept in the part “a” of the capacitor 52 (see FIG. 4A). A voltage which is held when the reset current Ia is flown is referred to as a reset voltage Va.

The gate terminal voltage is required for the driver transistor 11a to flow the program current (reset current Ia) to the EL element 15. If a grand (GND) voltage is applied to a part “c”, the gate terminal voltage of the driver transistor 11a is kept between both electrodes of the capacitor 52.

When a gain of the operation amplifier 53 is 1, a voltage of the part “a” is applied to the source signal line 18 via the switch SW5. The transistors 11b and 11c of the pixel 16 close for the selected one horizontal scanning period (1H period) In that state, the read-out gate terminal voltage of the driver transistor 11a is applied to the gate terminal of the driver transistor 11a of the pixel 16 again.

Thus, the driver transistor 11a flows a current corresponding to the reset current Ia to the EL element 15. In the abovementioned state, the variations of the characteristics of the driver transistor 11a are compensated and the reset current Ia (programmed current) is accurately flown into the EL element 15.

It is a matter of course that the reset voltage Va for each pixel differs according to the characteristics of the driver transistor 11a. However, the current to be flown into the EL element 15 is program current (reset current Ia) accurately applied thereto.

The voltage gradation circuit 20 outputs a gradation voltage Vx corresponding to each gradation. The gradation voltage Vx means voltage which corresponds to a gradation number of the video signal. It can be considered as a video signal. An image can be displayed as a gradation voltage Vx is applied to the driver transistor 11a as a program voltage as it is or after being subjected to certain processing (proportion processing, shifting processing, addition, subtraction processing or the like).

The gradation voltage Vx is applied to the part “c” of the capacitor 52 via the switch SW4. The potential Va of the part “a” of the capacitor 52 increases by such a portion of the gradation voltage Vx that is outputted from the voltage gradation circuit 20. Thus, the potential of the part “a” is ideally Va+Vx.

Va+ the gradation voltage Vx is made into a low impedance at the operation amplifier 53, which has a gain 1, and outputted from there. Va+ the gradation voltage Vx is applied to the source signal line 18 via the switch SW5 and the output terminal 21, and applied to the gate terminal of the driver transistor 11a of the pixel 16. Thus, the driver transistor 11a applies a current corresponding to Va+Vx to the EL element 15.

Although the operation amplifier 53 is described to have a gain 1 in FIG. 1, the present invention is not limited to that and it may be other than 1. For example, if it is doubled, the operation amplifier 53 doubles the voltage applied to the part “a” and applies it to the source signal line 18. It is also possible to perform a reverse operation on the polarity of the applied voltage of the part “a”. The gradation voltage Vx is an arbitrary voltage corresponding to each gradation. The gradation voltage Vx is generated or set with the reset voltage Va as a center. The gradation voltage Vx may be set in the plus direction or in the minus direction. With the configuration, it may be set in the ± directions.

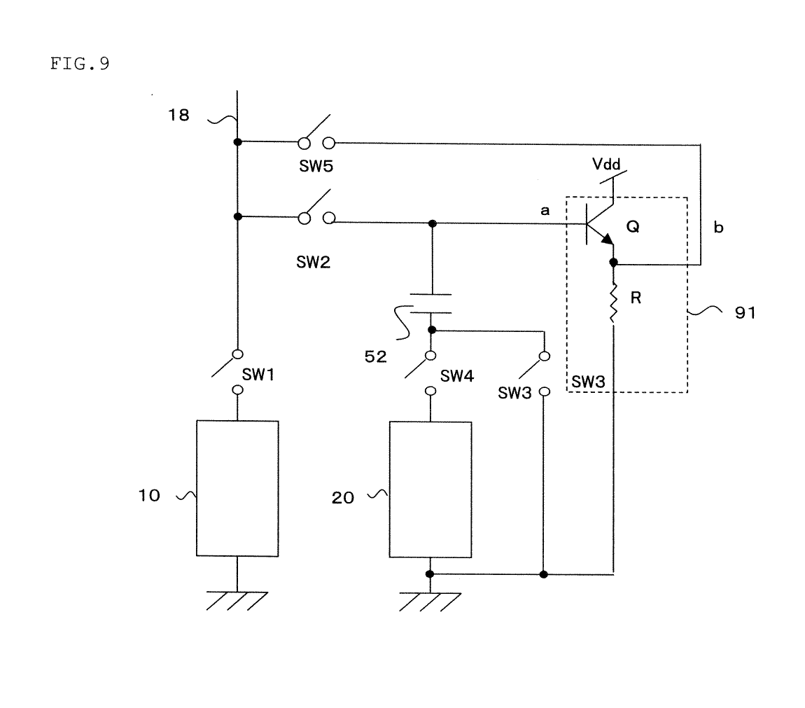

Although it is described that the operation amplifier 53 is used in FIG. 1, the present invention is not limited to that. Any operation amplifier can be used if only input impedance is high and output impedance is low. For example, FIG. 9 is an example of a configuration, in which the emitter follower circuit 91 formed by a transistor is used. The transistor Q and the resistance R form the emitter follower circuit 91.

The impedance seen from the part “a” toward the transistor Q is high, and the output impedance from the part “b” is low. Thus, the potential of the capacitor 52 can be stably kept and the source signal line 18 can be charged or discharged well with a voltage to be applied via the switch SW5 so that the gradation voltage can be applied well to the driver transistor 11a of the pixel 16.

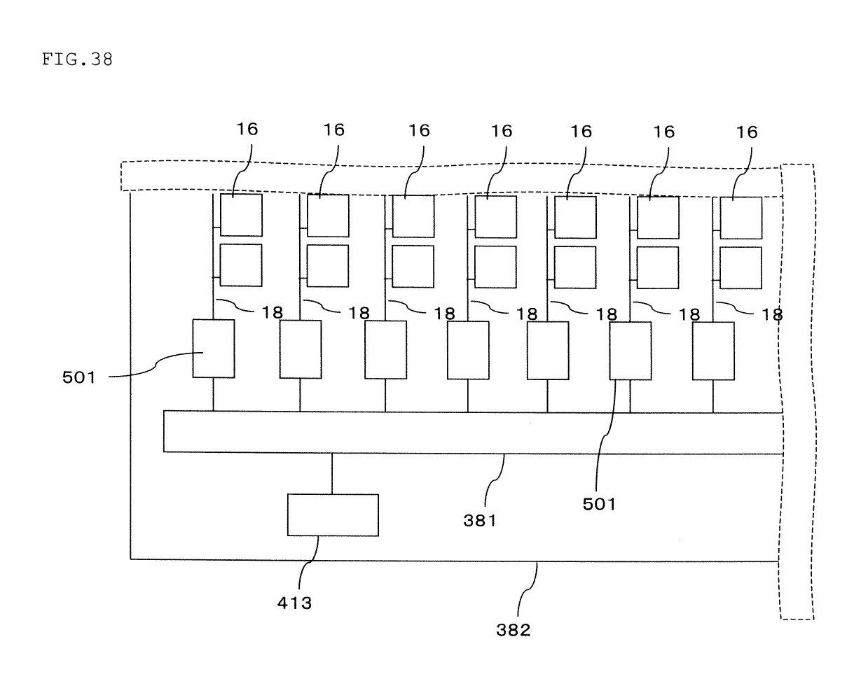

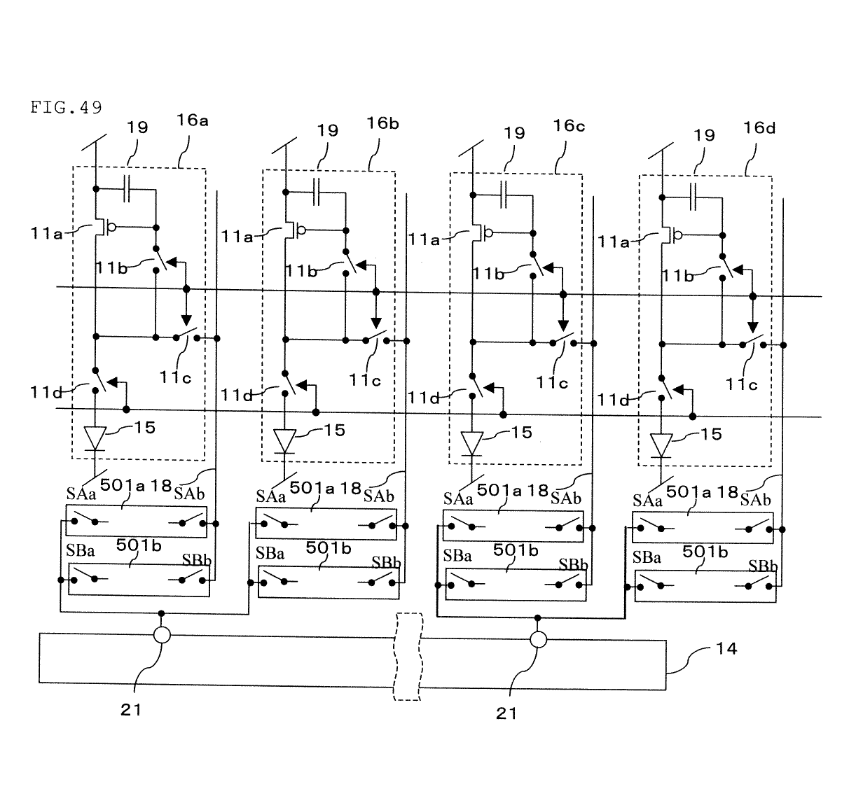

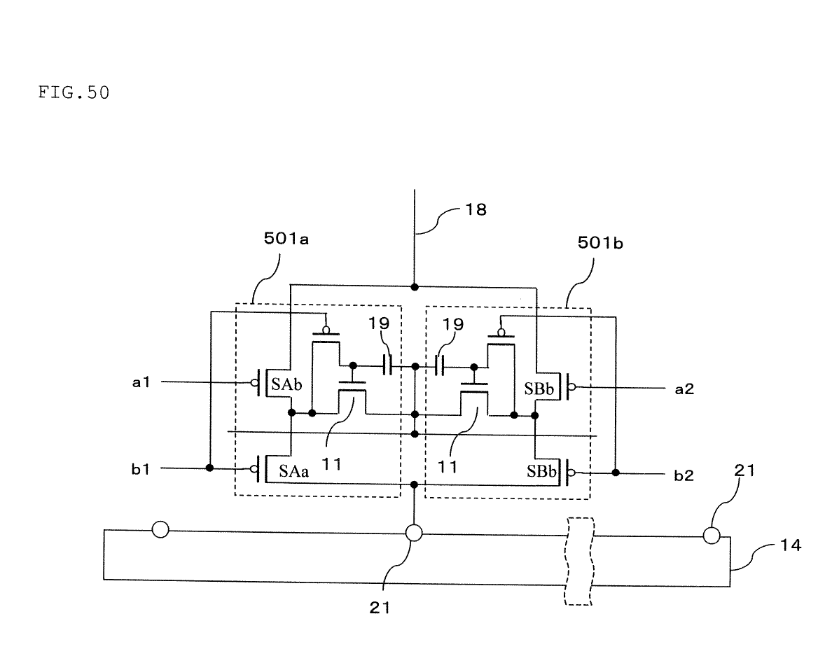

Although it is described that the constant current output circuit 10 is arranged or formed in the source driver IC (circuit) 14 corresponding to each source signal line 18 in FIG. 1, the present invention is not limited to that. For example, a configuration, in which a constant current generated by a current generating circuit 413 (reset current Ia) is applied to a plurality of current holding circuits 501 (refer to FIG. 49, FIG. 50 and description thereof) by a switch circuit (selective switching circuit) is exemplified as shown in FIG. 38. The current holding circuit 501 is connected to or arranged in each source signal line 18.

The current holding circuit 501 applies the reset current Ia to the pixel 16. The current holding circuit 501 has a function of applying the reset current Ia to the pixel 16 and obtaining the reset voltage Va of the driver transistor 11a of the pixel 16. The reset voltage Va, which is applied to each source signal line 18, or the reset voltage Va, which is obtained or kept by each current holding circuit 501, is read out by controlling the switch circuit 381. The target gradation voltage Vc is obtained from the read out reset voltage Va and applied to each pixel 16.

The amount of the reset current Ia outputted from the constant current output circuit 10 or the current generating circuit 413 may be amplified at the current holding circuit 501 or the like. Amplification can be easily realized at an operation amplifier or a differential amplifying circuit or the like. The meaning of “amplification” includes not only amplifying to 1 or more but also amplifying to 1 or below in this specification.

The current holding circuit 501 is formed by using a polysilicon technique such as a low temperature polysilicon on the array substrate 382. The current generating circuit 413 maybe formed on the array substrate 382. If current accuracy is required, the current generating circuit 413 is preferably formed in the source driver circuit 14 formed by semiconductor chips.

Output currents (reset current Ia) from the constant current output circuit 10 or the current generating circuit 413 may be switched by the switch circuit 381 and applied to the current holding circuit 501 which is formed or configured in each source signal line 18 or each output terminal 21. As shown in FIG. 50 or the like, the current holding circuit 501 is formed with a current mirror circuit or a current copier circuit.

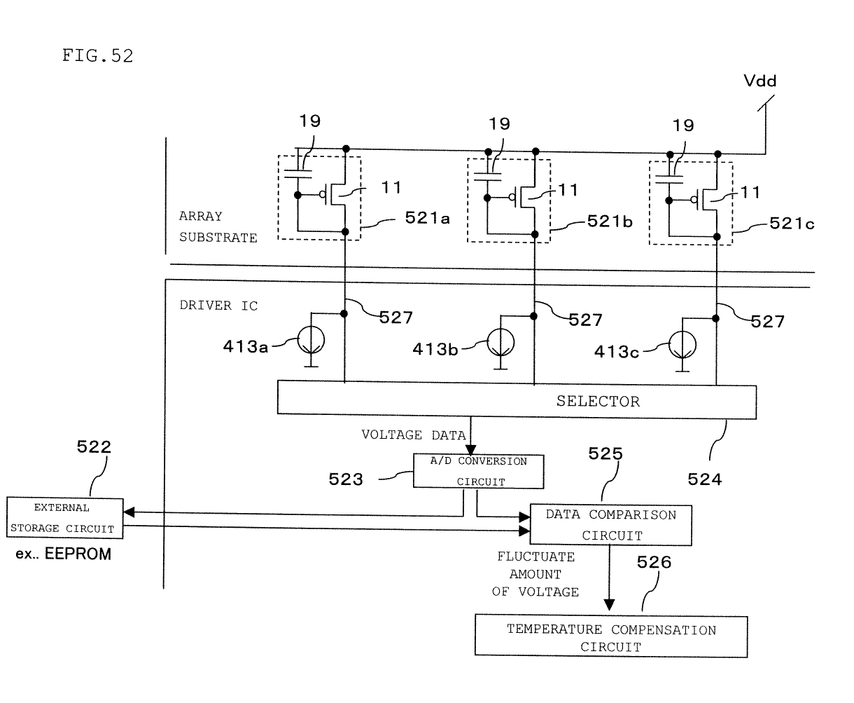

The reset current Ia outputted from the constant current output circuit 10 or the current generating circuit 413 is not limited to the reset current Ia of a certain value. A plurality kind of gradations such as 64 gradations or 256 gradations on a various amounts of the current may be outputted. The reset current value Ia may be configured to be able to change its value for each of the horizontal synchronizing signal (HD) and the vertical synchronizing signal (VD). The reset current Ia may also be configured to be able to change its value for each pixel in sync with a dot clock. The reset current value Ia may be changed correlated to a panel temperature by using a panel temperature detecting circuit as shown in FIG. 52.

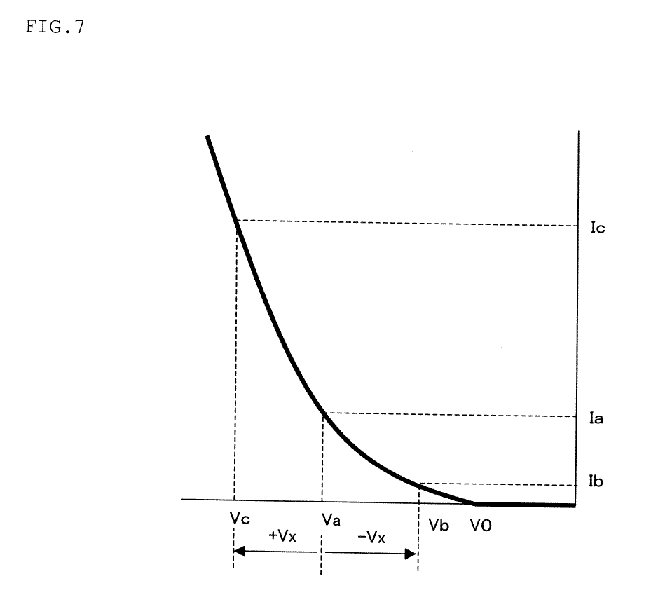

A gradation number may substitute the gradation voltage Vx. It is assumed that the reset voltage Va is the 128^{th} gradation in the 256 gradations and Vx=Vc−Va corresponds to a voltage for 64 gradations. When the voltage gradation circuit 20 outputs Vx, Vc is 128+64=192 gradations. When the voltage gradation circuit 20 outputs Vx, Vb is 128−64=64 gradations, assuming that Vx acts in one direction and Va−Vx corresponds to the voltage for 64 gradations. In FIG. 7, the current corresponding to Vb is Ib. It is a matter of course that the gradation voltage Vx may be in any unit and any amount if only it is a voltage.

The current to be flown into the EL element 15 by the abovementioned gradation voltage Vx is shown in FIG. 7. The solid line in FIG. 7 indicates V-I characteristics of the driver transistor 11a of the pixel 16. In FIG. 7, the current Ia is flown into the EL element 15 by the reset voltage Va. Ideally, if the reset voltage Va is applied to the gate terminal of the driver transistor 11a, the reset current Ia is flown into the EL element 15. Actually, a current that has a difference from the reset current Ia due to an influence of a punch-through voltage generated between the gate terminal of the driver transistor 11a and the gate signal line 17a or the like is flown into the EL element 15. It is a matter of course that the present invention can be also applied to this case. In this specification, an ideal state is exemplified for description. The reset voltage Va differs depending on characteristics of each driver transistor.

The gradation voltage Vx corresponds to each gradation. The gradation voltage changes in the + side (+ Vx) or the − side (−Vx) at either side of the reset voltage Va. When the gradation voltage changes to the + side, the current to be applied to the EL element 15 is Ic. When the gradation voltage changes to the − side, the current to be flown into the EL element 15 is Ib. The voltage gradation circuit 20 adds or subtracts the voltage at the + side or at the − side with the reset voltage Va as a standard and holds the result in the part “a”. It is a mater of course that the gradation voltage Vx may be set only in the plus direction (addition) with the reset voltage Va as a standard. The gradation voltage Vx may be set only in the minus direction (subtraction) with the reset voltage Va as a standard. Addition/subtraction is not limited to addition/subtraction of an analog voltage and may be realized by adding/subtracting digital data.

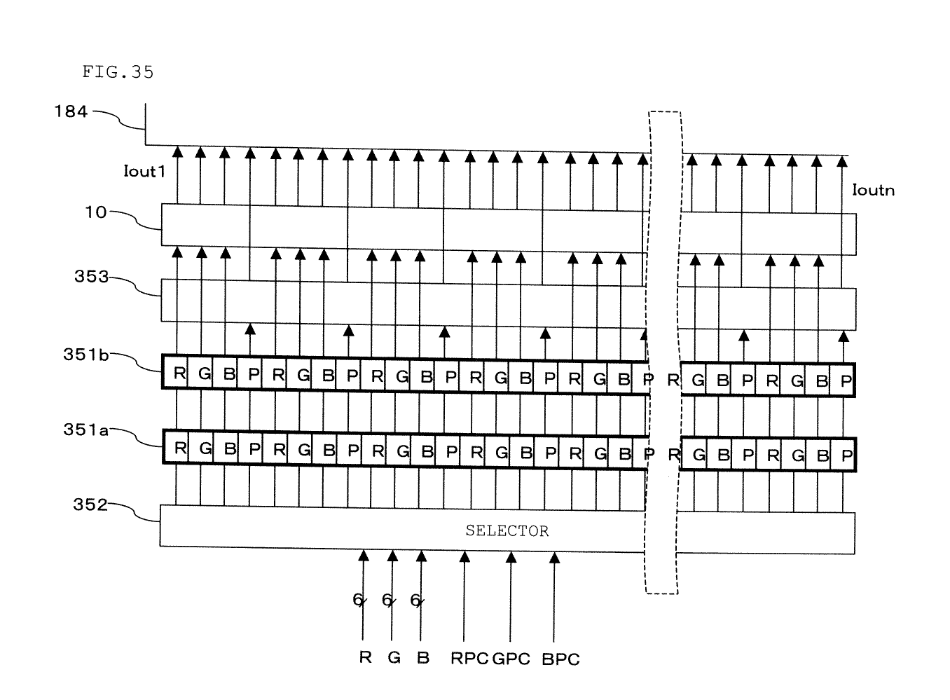

The voltage gradation circuit 20 is not limited to being formed by a semiconductor IC chip. It maybe formed on the array substrate 382 by using the polysilicon technique. In such a case, the voltage gradation circuit 20 is formed with a dot sequential circuit and a line sequential circuit. As shown in FIG. 35, it maybe formed with a sample holding circuit or the like.

It is a matter of course that the voltage outputted from the voltage gradation circuit 20 may also be 0. In such a case, the output current from the constant current output circuit 10 is assumed as 0 (the constant current output circuit 10 is not required). Thus, the present invention may omit the constant current output circuit 10.

The reset voltage Va of the driver transistor of each pixel is measured in advance and the gradation voltage Vx to be applied to each pixel may be corrected by using the measured reset voltage Va.

In such a case, the constant current output circuit 10 is not required in the image display state with only the reset current Ia that is outputted from the constant current output circuit 10 or the like being required when the reset current Va is measured. Thus, the reset current Ia only needs to be separately supplied from a circuit arranged outside the source driver IC 14.

The reset voltage Va may be measured optically in an indirect manner. This is because that the variations of the characteristics of each driver transistor are optically displayed as irregularity when the EL display apparatus is driven by voltage. The reset voltage Va of the driver transistor of each pixel or a voltage similar to that can be easily obtained as the optically displayed variations are measured. The target gradation voltage Vc and the gradation voltage Vx may also be corrected accordingly.

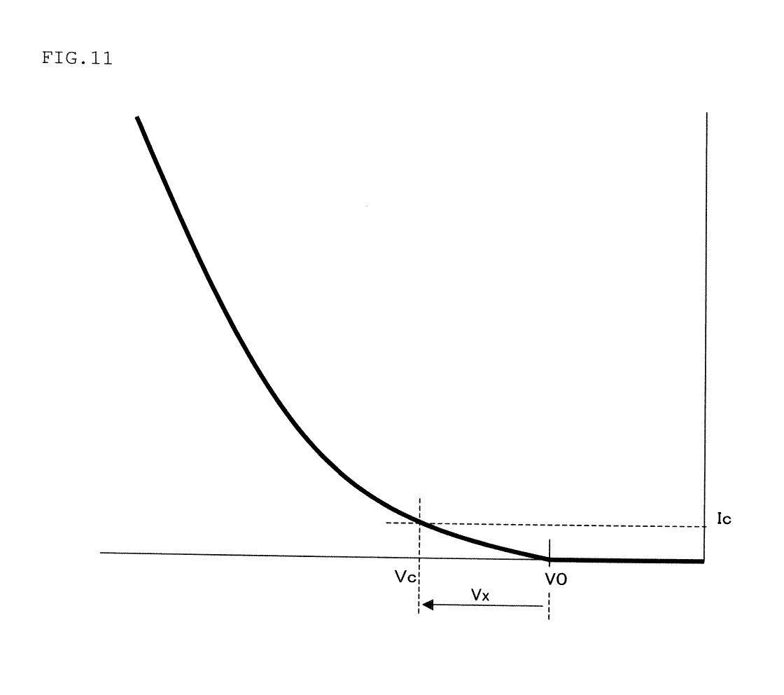

The on voltage is applied to the gate signal line 17a of the corresponding selected pixel 16. The driver transistor 11a fluctuates a gate terminal potential by applying the on voltage to the gate signal line 17a so that the current to be flown into the EL element 15 is 0. The voltage Va which makes the current to be flown into the EL element 15 zero is held in the part “a” of the operation amplifier 53. The voltage gradation circuit 20 outputs the voltage at the + side, and the voltage at the + side and the voltage held in the part “a” are added and outputted to the part “b” of the operation amplifier 53 (see FIG. 11).

As shown in FIG. 11, the potential V0 of the source signal line 18, after the operation for making the current to be flown from the constant current output circuit 10 to the source signal line 18 zero and making the current which is flown by the driver transistor 11a into the EL element 15 zero, is measured. V0 is a voltage after a reset operation. No current flows into the EL element 15 even if the reset voltage Va=V0 is applied to the gate terminal of the driver transistor 11a. If the gradation voltage Vx is applied with the reset voltage V0 as a standard, the current Ie flows into the EL element 15.

The second operation shown in FIG. 4C and FIG. 17B is the second operation for applying a current to the EL element 15. The second operation is that the driver transistor 11a applies the current Ie to the EL element 15 based on the voltage applied to the gate terminal of the driver transistor 11a in FIG. 2. The EL element 15 of each pixel 16 operates to emit light with the applied current Ie.

The abovementioned operation is implemented as the gate driver circuit 12a selects the line of pixels in order. Thus, a line of pixels is selected during one horizontal scanning period. First, the reset current Ia is applied to the line of pixels selected at the beginning of the one horizontal scanning period. The reset voltage Va required for the driver transistor 11a to flow the reset current Ia is read, while the reset current Ia is applied. Alternatively, the reset voltage Va is held in the part “a”.

Next, the gradation voltage Vx is added to or subtracted from the reset voltage Va. The added or subtracted voltage is applied to the gate terminal of the driver transistor 11a. The one horizontal scanning period has thus completed. For the selected line of pixels, the current is supplied from the driver transistor to the EL element 15 and the EL element 15 emits light during a predetermined period after the next one horizontal scanning period.

During the next one horizontal scanning period, the next adjacent line of pixels is selected. A line of pixels is selected during one horizontal scanning period, the reset current Ia is applied to the line of pixels selected at the beginning of the horizontal canning period, and Va required for the driver transistor 11a to flow the reset current Ia is read.

Then, the gradation voltage is added to or subtracted from the reset current Va and the result is applied to the gate terminal of the driver transistor 11a. One horizontal scanning period has thus completed.

The amount of the reset current Ia to be applied to each pixel 16 may be variable, changed or adjusted according to the amount of the current Ie to be flown into the EL element 15 of each pixel 16, current differential to be rewritten, a lighting cycle and the like. The amount of the reset current Ia may also be variable, changed or adjusted according to the ratio of the current to be used in displaying each image (lighting ratio) to the maximum current to be used in the entire display area 184.

Particularly in the case in which the lighting ratio is 25% or below with the maximum value being 100%, the reset current Ia is preferably increased. That is to say, the amount of the reset current Ia is changed (controlled) according to the lighting ratio.

The amplifier magnification of the operation amplifier 53 may be changed according to the amount of the current to be flown into the EL element 15 of each pixel 16, the currents differential to be rewritten, the lighting cycle and the like. The period during which the reset current Ia is applied may be variable.

The gain of the gradation voltage Vx which is outputted from the voltage gradation circuit 20, may be changed according to the amount of the current to be flown into the EL element 15 of each pixel 16, the current differential to be rewritten, the lighting cycle and the like. A certain amount of voltage for correction may be used against the reset voltage Va and the reset voltage V0, and the corrected voltage Va, and V0 may be used as a standard voltage. The switch SW2 or the like may be omitted.

Although the reset voltage Va is calculated or obtained in the present invention, what to be obtained is not limited to the reset voltage Va. What to be obtained maybe what is similar to the reset voltage Va. A voltage proportional to the reset voltage Va and a voltage shifted by certain level are exemplified. The amplified voltage is also exemplified. The optically obtained voltage or digital data are also exemplified.

The reset voltage Va does not need to be calculated or obtained for each pixel. The reset voltage Va may be one thinned out for a certain period and extracted from the selected pixels. This is because that the reset currents Va in neighbor pixels are relatively matched. The extracted reset voltage Va is used directly as the reset voltage Va of the neighbor pixel or is used as the reset voltage Va of the neighbor pixel after being subjected to processing such as calculation.

Pixels are thinned out, the reset voltage Va of the selected pixel is obtained and the reset current Va of the pixel which is not selected is obtained by using the reset current Va of the selected pixel. Alternatively, the reset voltage is inferred from analogy.

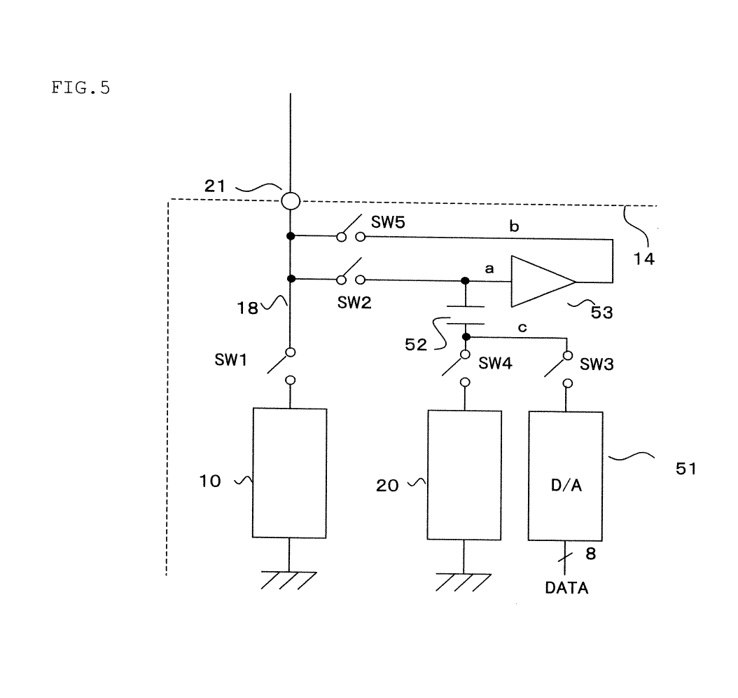

FIG. 1 may be configured as FIG. 5. FIG. 5 is a configuration in which a DA (digital-analog) conversion circuit 51 is connected to the switch SW3. The DA conversion circuit 51 applies a voltage to the part “c” via the switch SW3 based on the digital data DATA of eight bits. Various voltages may be applied to the part “c”, instead of limiting the voltage to the grand (GND) potential.

For example, the reset voltage Va read from the gate terminal of the driver transistor 11a can be applied to an electrode part “c” of the capacitor 52. Thus, initialization of the capacitor 52 can be easily implemented.

With the configuration of FIG. 5, a certain voltage shift may be performed on a voltage to be applied to the part “a”. When the gate signal line 17a is changed from the on voltage applied state to the off voltage applied state, a punch-through voltage is generated. With the punch-through voltage, a potential of the gate terminal of the driver transistor 11a shifts. In the configuration of FIG. 5, the potential shift can be easily corrected. The other configurations are the same as or similar to that of FIG. f1 and thus description thereof will be omitted.

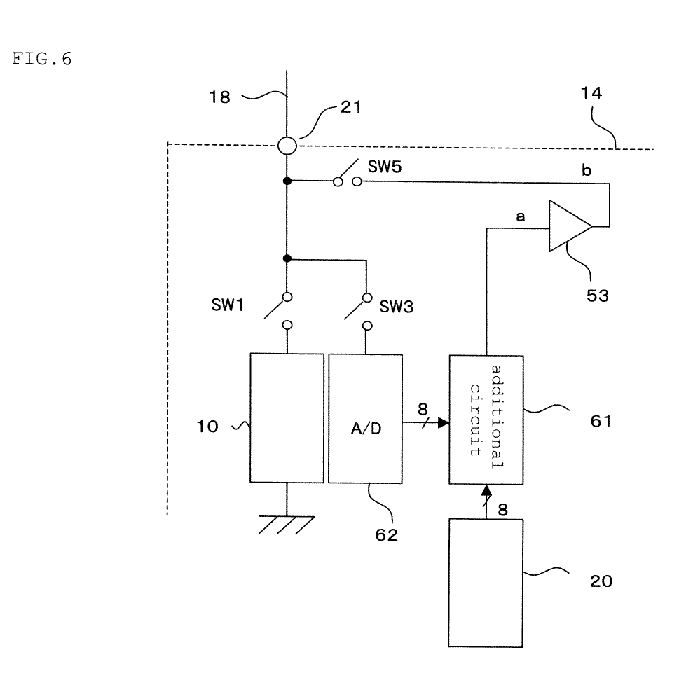

Although the potential of the source signal line 18 is held in the analog manner by the capacitor 52 or the like in FIG. 1, the present invention is not limited to that. For example, the present invention may be configured as in FIG. 6.

In FIG. 6, the potential of the source signal line 18 is subjected to analog-digital conversion at an analog-digital (AD) conversion circuit 62. The digital-data that is subjected to the AD conversion is added to the output voltage from the voltage gradation circuit 20 by an addition circuit 61. The added voltage is applied to an input part “a” of the operation amplifier 53, subjected to an impedance conversion and outputted from the part “b” as in FIG. 1. The other operations and configurations are the same as or similar to those of FIG. 1, and thus description thereof will be omitted.

The addition circuit 61 executes a function the same as or similar to that of the voltage gradation circuit of the capacitor 52 of FIG. 1. As the AD conversion circuit 62 has functions of measuring and holding a potential, it has the function of the capacitor 52 of FIG. 1. The addition circuit 61 may perform addition (or subtraction, alternatively, addition and subtraction) of the output data from the AD conversion circuit 62 to the output data from the voltage gradation circuit 20 and output the result to the part “a”.

Therefore, the operation is the same as that of adding the reset voltage Va of the part “a” of the capacitor 52 and the output voltage Vx of the voltage gradation circuit and shifting the potential of the part “a”. The addition circuit 61 may be a subtraction circuit. Addition maybe either analog addition or digital addition. The concept of addition includes a concept of the level shift and the like.

Although the AD conversion circuit 62 is described to apply the measured or held voltage to the addition circuit 61 as digital data, the present invention is not limited to that. For example, digital data from the AD conversion circuit 62 may be held in the memory circuit (not shown), which is configured or formed outside or inside the source driver IC (circuit) 14. The digital data is read out at anytime and applied or outputted to the addition circuit 61.

The potential of the source signal line 18 varies according to the voltage or the current outputted from the source driver IC (circuit) 14. Basically, the potential of the source signal line 18 is rewritten for each horizontal scanning period. According to the present invention, the reset current Ia is applied at the beginning of one horizontal scanning period (1H), the driver transistor 11a is caused to operate, and measurement is made to the gate potential of the driver transistor 11a whose operation completed and which has entered in a static state. By applying the gradation voltage to the driver transistor 11a with the measured voltage as a standard, the variations of the characteristics of the driver transistor 11a are compensated.

The reset current Ia is not limited to a predetermined reset current Ia steadily in one horizontal scanning period (1H period). For example, the reset current Ia may be made a large current at an initial stage when the reset current Ia starts to be applied and set at a predetermined reset current Ia after a certain period. With the operation, the parasitic capacity of the source signal line 18 or the like can be charged or discharged in a short time. That is to say, the reset current Ia maybe changed in multiple stages in 1H period. The amount of the reset current Ia to be switched by multiple stages may be changed or adjusted, based on the potential of the source signal line 18.

In order to adjust the potential of the gate terminal of the driver transistor 11a and compensate the variations of the characteristic of the driver transistor 11a, a parasitic capacity of the source signal line 18 first needs to be charged or discharged by the reset current Ia (It is a matter of course that the operation of the driver transistor 11a is included.). A charging and discharging time depends on the potential of the source signal line 18 before one horizontal scanning period. Accordingly, a predetermined time is not enough for charging and discharging in some potential states of the source signal line 18.

In order to solve the problem, according to the present invention, a pre-charge voltage Vp is applied to the source signal line 18 during the first period of the one horizontal scanning period (1H). The pre-charge voltage Vp (to be described later) is adapted to be formed in the source driver IC (circuit) 14 so that a predetermined voltage can be applied to the source signal line 18. The pre-charge voltage Vp maybe adapted to be directly applied to the pixel 16. It is allowed, for example, that a method of applying a cathode voltage to a pixel as the pre-charge voltage Vp by turning on a switching transistor for short-circuiting the cathode voltage Vss and the gate terminal of the driver transistor 11a formed in a pixel beforehand is applied.

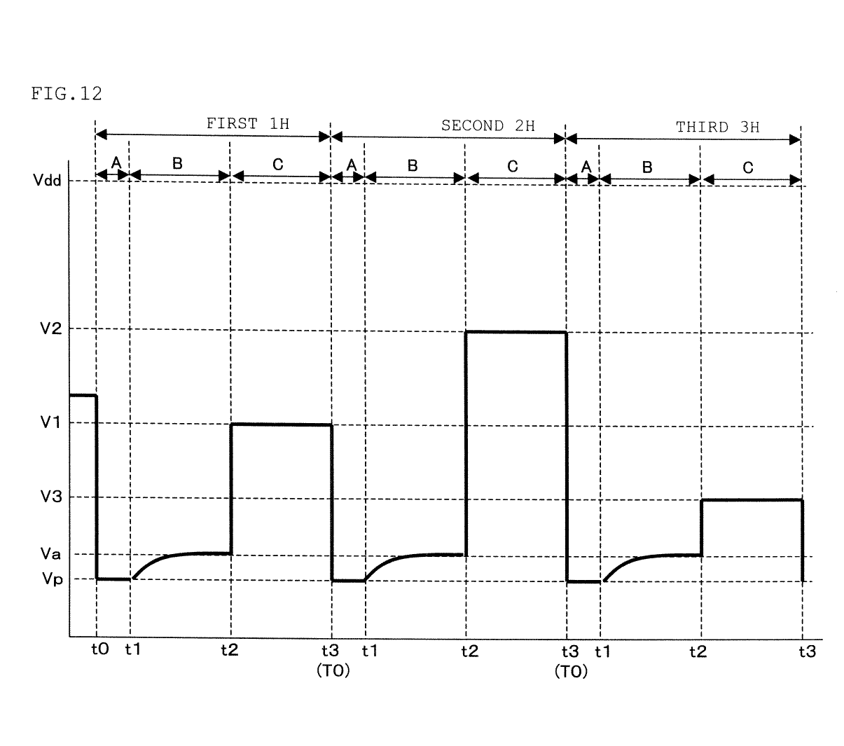

In FIG. 12, the pre-charge voltage Vp during a period “A” in each horizontal scanning period. Each source signal line is charged or discharged at a second as the pre-charge voltage Vp is applied, and reaches the potential Vp. In the embodiment, the configuration of the pixel 16 is described with an example of FIG. 2. The driver transistor 11a of the pixel 16 will be described as a P channel transistor. If the driver transistor 11a is an N channel transistor, those skilled in the art can implement the pixel 16 only with a little change to the descriptions below. The present invention is not limited to the channel polarity of the driver transistor 11a.

In the case of the P channel transistor, the nearer the gate terminal potential of the driver transistor 11a is to a Vdd voltage (anode voltage), the smaller the current Ie of the driver transistor 11a (black display or low brightness display) is. The near the gate terminal potential of the driver transistor 11a is to the GND voltage (grand voltage or cathode voltage), the bigger the current Ie of the driver transistor 11a (white display or high brightness display) is.

The pre-charge voltage Vp is set near to the voltage corresponding to the maximum gradation (white display or high brightness display). The pre-charge voltage Vp maybe a predetermined fixed voltage, but it is preferably adapted to be variable or able to be adjusted according to the reset voltage Va or the reset voltage V0.

In FIG. 12, each of the first 1H to 3H (the first to the third horizontal scanning period) is one horizontal scanning period (1H). The first 1 to 3H (the first to the third horizontal scanning period) are the order for lines of pixels to be selected. Assuming that there are n lines of pixels, a field (frame) period includes n horizontal scanning periods (line of pixels) and blanking periods. The pre-charge voltage Vp is applied to the first period A in each horizontal scanning period.

Therefore, no matter that the potential of the source signal line 18 before 1 H is, the voltage becomes the pre-charge voltage Vp at a time. During a period B, which is after the period A of 1H, the reset current Ta is outputted from the constant current output circuit 10. The reset current Ia may be applied also in the period A. The reset current Ia flows from the driver transistor 11a of the pixel 16 to the constant current output circuit 10 via the source signal line 18.

The reset current Ia makes the gate terminal of the driver transistor 11a of the pixel 16 the reset voltage Va. It is a matter of course that the reset voltage Va differs according to the variations of the characteristics of the driver transistor 11a of the pixel 16. The difference between the minimum and the maximum of the reset voltage Va is about 0.5 V. The potential difference between the reset voltage Va and Vp voltage is almost constant. No matter what the potential of the source signal line 18 before 1H is, applying of the pre-charge voltage Vp changes the pre-charge voltage Vp to Va when the reset current Ia is applied. Therefore, a converging time is almost constant.

During a period “C” next to the period “B”, the target gradation voltage Vc is applied as a video signal. Therefore, the target gradation voltage Vc=Va+Vx is applied to the source signal line 18 with the reset voltage Va as a standard. FIG. 12 shows an example, in which the target gradation voltage is V1 during the 1H period, the target gradation voltage is V2 during the 2H period, and the target gradation voltage is V3 during the 3H period. Thereafter, the selected position of the line of pixels is shifted to nH and the same operation as the above is implemented. As mentioned above, applying of the pre-charge voltage Vp makes it easier to apply the reset current Ia to the driver transistor 11a of the pixel 16 so that the converging time can be shortened. The pre-charge voltage Vp may be generated in the array substrate circuit or maybe generated from a circuit formed in the source driver IC 14.

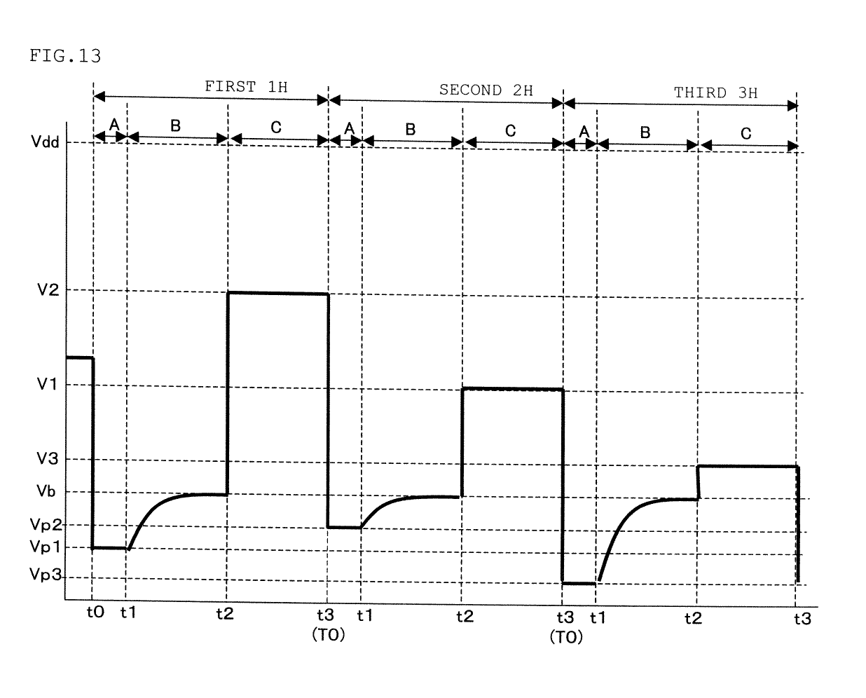

FIG. 12 shows an embodiment with the pre-charge voltage Vp as constant, though, the present invention is not limited to that. For example, the pre-charge voltage Vp may be changed as shown in FIG. 13.

In FIG. 13, the pre-charge voltage is Vp1 during 1H, the pre-charge voltage is Vp2 during the 2H, and the pre-charge voltage is Vp3 during the 3H. Thereafter, the selected position of the line of pixels is shifted to nH and the same operation as the above is implemented. The pre-charge voltage Vp is preferably changed in relation to the gradation voltage or the target gradation voltage Vc. It is exemplified that the pre-charge voltage Vp is set so that the potential difference between the target gradation voltage Vc=Va+Vx and the pre-charge voltage Vp is in a predetermined voltage range.

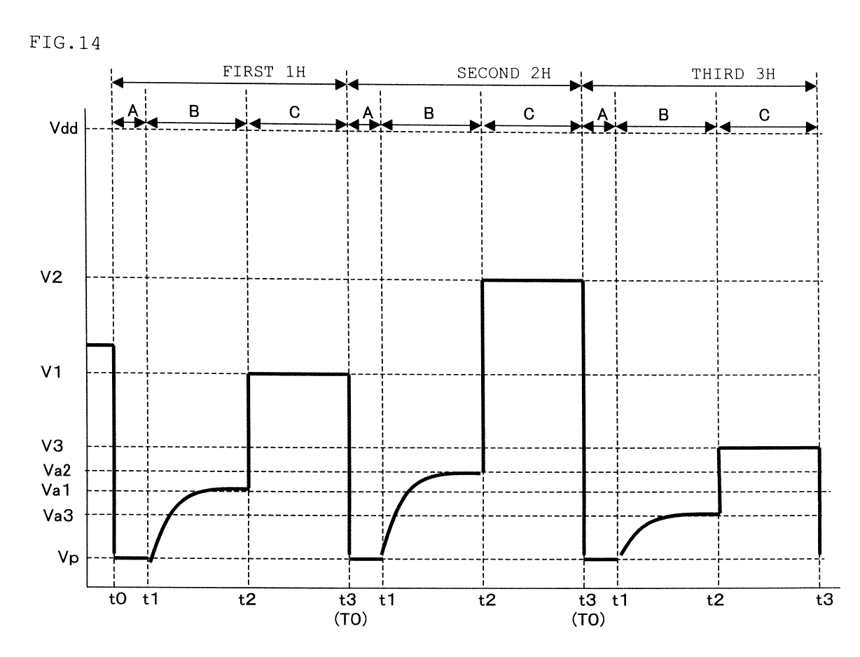

Although FIG. 12 shows an embodiment, in which the pre-charge voltage Vp is constant, the present invention is not limited to that. For example, the reset voltage Va may be changed as shown in FIG. 14. In FIG. 14, the reset voltage is Va1 during the 1H period. The reset voltage is Va2 during the 2H period, and the reset voltage is Va3 during the 3H period. Thereafter, the selected position of the line of pixels is shifted to the nH and the same operation as the above is implemented. In the embodiment of FIG. 14, the reset voltage Va is what is obtained by correcting the reset voltage Va of the driver transistor 11a of each pixel 16.

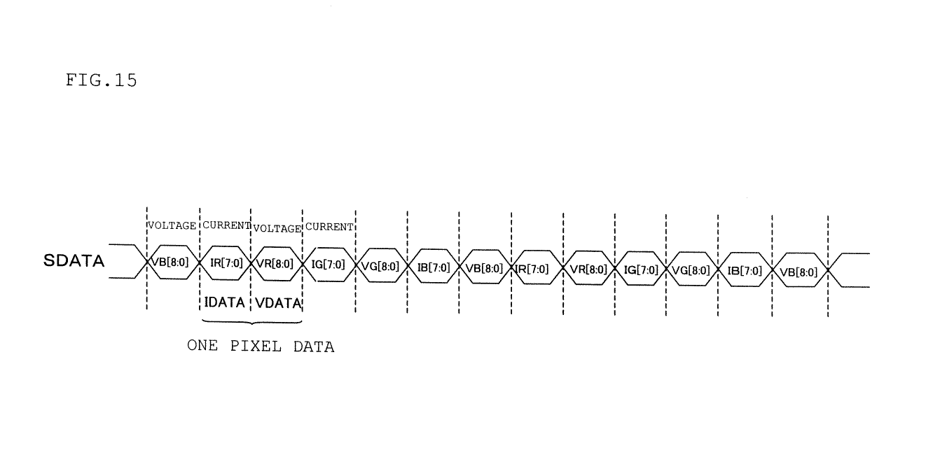

In order to change the reset current Ia by gradation or in multiple stages, the current data needs to be sent to the source driver IC (circuit) 14. In order to change the gradation voltage Vx for each pixel, the voltage data needs to be sent to the source driver IC (circuit) 14. FIG. 15 shows an example of that. The reset current data ID (7:0) of eight bits and the gradation voltage data VD (7:0) of eight bits are sent in combination or alternatively. The reset current data ID (7:0) is data for generating the reset current Ia, which is outputted from the constant current output circuit 10. The voltage data VD (7:0) is for generating the gradation voltage Vx, which is outputted from the voltage gradation circuit 20.

According to the abovementioned embodiment, the potential of the source signal line 18 is initialized by applying the pre-charge voltage Vp. After the initialization, the reset current Ia is applied to the source signal line 18. The pre-charge voltage Vp may be directly applied to the pixel 16.

In the above description of the present invention the reset current Ia is applied to the transistor, and the gate terminal voltage of the driver transistor 11a is directly or indirectly measured or held. The present invention is not limited to that. The reset current Ia also includes the case where the current value is 0 (does not flow reset current Ia). Measurement of the voltage by applying the reset current Ia is not limited to the measurement of the amount of the voltage, and it may be the measurement of the amount of change in voltages before and after, the speed of the voltage change, or a difference value of voltages.

Measurement of the voltage includes operations or configurations of performing the analog-digital conversion (AD conversion) on the measured voltage and holding it outside or inside the driver circuit. It also includes an operation of holding the voltage in a memory as digital data. It also includes an operation or a configuration of temporally holding, latching or storing the data in the holding medium such as a capacitor.

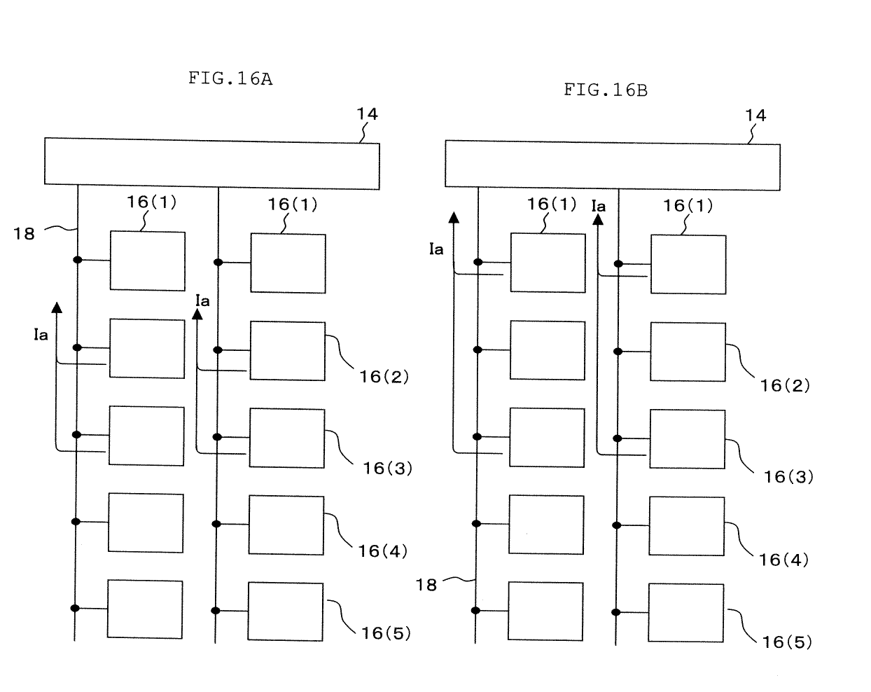

Although the gate driver circuit 12a selects a line of pixels in order and the reset current Ia is applied to a pixel of each line of pixels in the embodiments in FIG. 1 or the like, the present invention is not limited to that. For example, a plurality of lines of pixels are selected for the reset current Ia to be applied to as shown in FIGS. 16A and 16B. The reset voltage Va or the reset voltage V0 (see FIG. 11) may be measured, etc, for a plurality of pixels at a time or common to the plurality of the pixels. This is because that the reset voltage Va and the reset voltage V0 are approximated among the adjoining lines of pixels.

The embodiment of FIG. 16A is adapted to select the adjoining two lines of pixels at a time and apply the reset current Ia from the constant current output circuit 10 for the two lines of pixels. When two pixels 16 are selected at a time, the reset current Ia is a double of that for one pixel. When three pixels 16 are selected at a time, the reset current Ia is a triple of that for one pixel. The reset current Ia needs not to be multiplied by an integer and may be any number if only it is multiplied by a real number. If a plurality of pixels 16 are selected, the reset current Ia may be the same amount of that for selecting a pixel 16.

The currents outputted from respective driver transistors 11a of each line of pixels of the selected two lines of pixels are different as the characteristics of the driver transistors 11a are different. But in the adjoining lines of pixels, the difference is a slight. The selection of the line of pixels may be such that two lines of pixels are selected in order like the 1^{st} and the 2^{nd} lines of pixels, the 3^{rd} and the 4^{th} lines of pixels, the 5^{th} and the 6^{th} lines of pixels . . . , or may be selected in order with a line of pixels overlapped like the 1^{st} and the 2^{nd} lines of pixels, the 2^{nd} and the 3^{rd} lines of pixels, the 3^{rd} and the 4^{th} lines of pixels . . . .

FIG. 16B shows an embodiment, in which lines of pixels apart from each other by one line are selected instead of adjoining lines of pixels. For example, the 1^{st} and the 3^{rd} lines of pixels may be selected, then the 2^{nd} and the 4^{th} lines of pixels may be selected, and then the 3^{rd} and the 5^{th} lines of pixels may be selected.

In FIGS. 16A and 16B, the other configurations and operations are the same as that of the embodiment described in FIG. 1 or the like, and thus the description thereof will be omitted. As mentioned above, as a plurality of lines of pixels are selected at a time and the reset current Va or the like are measured, an operation time of the constant current output circuit 10 may be shorten. They may also simplify the configuration of the constant current output circuit 10 and the like.

The embodiment of FIGS. 16A and 16B is a driving system for selecting two lines of pixels at a time. The present invention is not limited to the two lines of pixels. Three lines of pixels may be selected at a time. The selection of a line of pixels is not limited to scanning and selecting of lines of pixels in order, and the lines of pixels may be selected randomly. The odd fields (frames) may be selected from the top to the bottom of the screen in order and the even fields (frames) may be selected from the bottom to the top of the screen in order.

A plurality of lines of pixels may be selected during 1H period in order, the reset current Ia may be applied to respective lines of pixels, and the reset voltage Va may be measured. For example, there is a driving method of selecting the line of pixels in the first line and applying the reset current Ia during the ½ H period, which is the first half of 1H period, and selecting the lines of pixels in the following second line during the ½ H period, which is the latter half.

Although the measurement of the reset voltage Va (see FIG. 7) and the measurement of the reset voltage V0 (see FIG. 11) are described to be done by selecting and measuring lines of pixels in order, the present invention is not limited to that. For example, the line of pixels in a display area may be selected and scanned in order in a blanking time of the video signal and the reset voltages Va, and V0 are measured or the like to be stored in a memory. A plurality of lines of pixels may be selected at a time or in order, the reset voltages Va, and V0 may be measured and held for a certain period, and the held reset voltages Va, and V0 may be read out in order, the target gradation voltage may be obtained or generated by adding or subtracting the reset voltages Va, and Vy to or from the gradation voltage Vx and the result is applied to each of the source signal lines 18 in order.

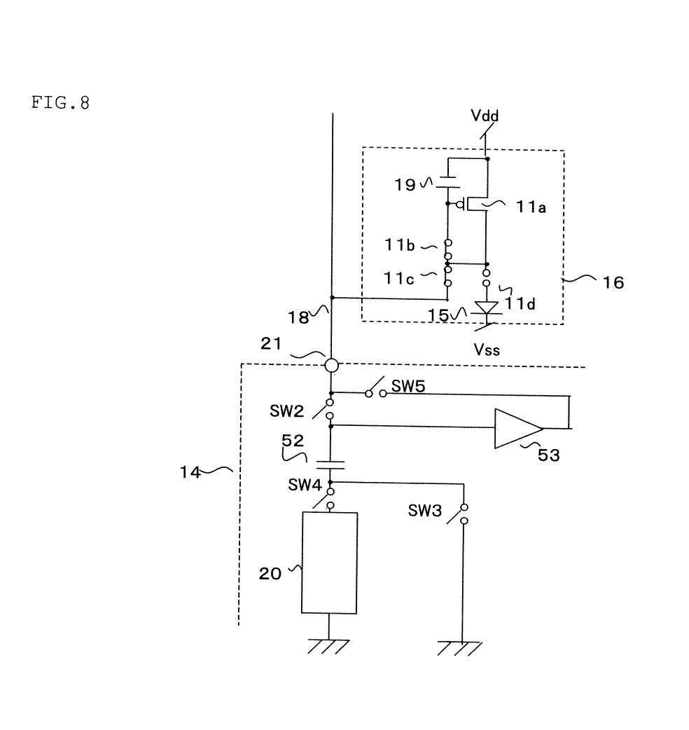

The device of FIG. 8 is also implemented as the gate driver circuit 12 selects a pixel string in order as in FIG. 1. That is to say, a line of pixels is selected in one horizontal scanning period. First, the switch SW3 is closed at first and the switches SW4, SW2 and SW5 are opened. As the switch SW3 is closed, the grand (GND) voltage is applied to a terminal “c” part of the capacitor 52 and kept to the grand voltage. As described in FIG. 5, the device of FIG. 8 may be adapted to apply a predetermined voltage.

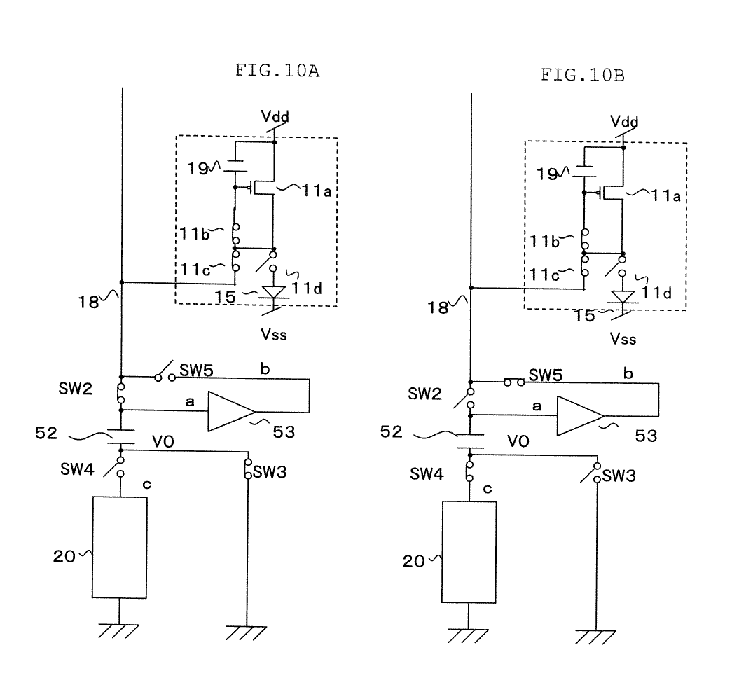

After the grand voltage is applied to the “c” part of the capacitor 52 and the reset is done, the switches SW2 and SW3 are closed and the switches SW4 and SW5 are opened as shown in FIG. 10A. To the part “a” of the capacitor 52, a voltage in which no current is flown into the EL element 15 by the driver transistor 11a (=the gate terminal voltage of the driver transistor 11a) is held. The line of pixels is also selected during the period. The gate terminal potential of the driver transistor 11a of each pixel 16 of the line of pixels is kept at the offset state (a state in which no current flows into the EL element 15 even if the transistor 11d is closed).

With the operation shown in FIG. 10A, the reset voltage V0 required to make the driver transistor 11a offset is read (held). Thus, the driver transistor 11a will be in a cut-off state (a state in which a current to be flown into the EL element 15 is 0) if the reset voltage V0 is applied to the gate terminal of the driver transistor 11a as it is, as shown in FIG. 11.

Next, as shown in FIG. 10B, the switches SW4 and SW5 are closed and the switches SW2 and SW3 are opened. The voltage gradation circuit 20 outputs the gradation voltage Vx. The target gradation voltage Vc=V0+Vx. The line of pixels is also selected during the period.

The voltage Vx outputted to the voltage gradation circuit 20 shifts the potential of the part “a” of the capacitor 52. With the potential shifting of the part “a”, the reset voltage V0 and the gradation voltage Vx are added. The one horizontal scanning period has thus completed. The selected line of pixels applies the current to the EL element 15 during the next one horizontal scanning period, and the EL element 15 emits light.

The abovementioned embodiment of the present invention is described by focusing on the measurement of the reset voltage Va and V0 and that the gradation voltage Vx is added to or subtracted from the voltages and the result is applied to the driver transistor 11a of the pixel 16. The image display of the EL display apparatus of the present invention will be focused on in the description below.

In the present invention, the potential of the gate terminal of the driver transistor 11a (shown by f of FIG. 2) is measured (the potential is obtained), while the program current (reset current) Ia flows. Alternatively, the potential is held in the capacitor 52 of FIG. 1. Alternatively, data corresponding to the potential is held in the storage unit such as a memory.

In FIG. 2, as the transistors 11b and 11c are in the on state, the potential f of the gate terminal is the same as the potential of the source signal line 18 (shown by d). Thus, the potential f of the gate terminal of the transistor 11a is measured as the potential of the source signal line 18 is measured via the terminal 93 of the source driver circuit 14.

The second operation is an operation state, in which the transistor 11b and the transistor 11c close and the transistor 11d opens with an equivalent circuit being shown in FIG. 17B. The voltage between the source and the gate of the transistor 11a is held as it is. In such a case, as the transistor 11a always operates in a saturation region, the current of Ie=Ia is constant. The Ie is the current, which the driver transistor 11a flows into the EL element 15. The Ie=Ia is an ideal state without any punch-through voltage or the like affecting the pixel 16. The description of this specification will present an operation in the ideal state as mentioned above. As long as the operation is implemented according to the technical idea of the present invention even if it is not in the ideal state, such operation is included in the technical range of the present invention and an implementation of the present invention.

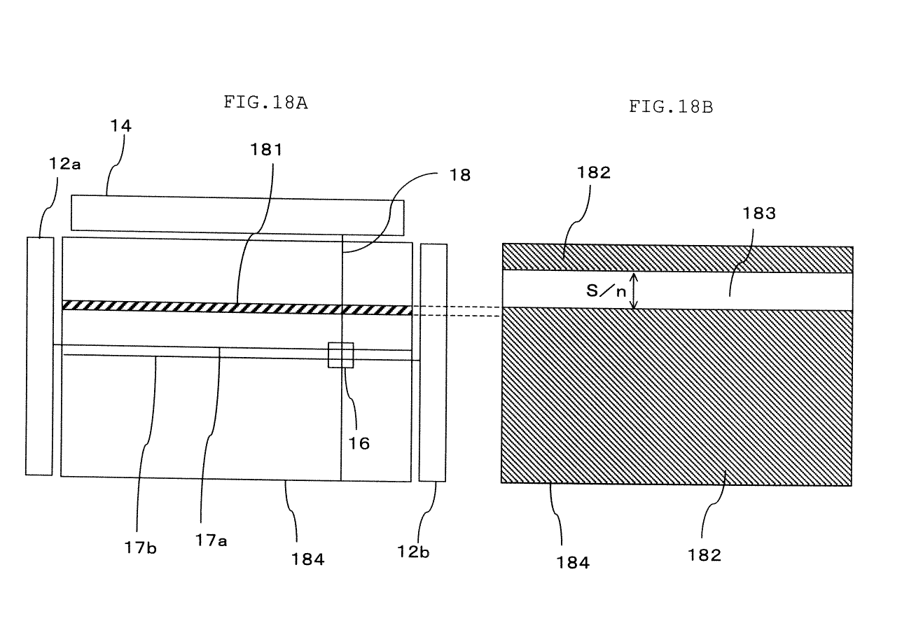

The abovementioned operation is shown on the display screen 184 as shown in FIGS. 18A and 18B. The reference numeral 81 of FIG. 18A indicates the pixel (line) (written line of pixels), which is programmed in its current at a certain time on the display screen 184. Alternatively, it indicates the line of pixels (pixels), in which the reset voltage Va and the reset voltage V0 are measured. Alternatively, it indicates the line of pixels (pixels), in which the target gradation voltage Vc is written. The pixels (line) 181 are non-lighting (non-display pixel (line)). In order to make the pixels non-lighting, the gate driver circuit 12b only needs to be controlled to open the transistor 11d of the pixel 16.

The non-lighting (non-display) means the state in which no current flows into the EL element 15. Alternatively, it means the state in which a small current in a certain range flows (a state of dark display). That is to say, it means a dark display state. Thus, the non-lighting line of pixels means the state in which no current flows into the EL element 15 of the line of pixels or the relatively dark display state. The range of non-display (non-lighting) of the display area 184 is referred to as a non-display area 182. The range of display (lighting) of the display area 184 is referred to as the display (lighting) area 183. The switching transistor 11d of the pixel 16 of the display area 183 closes and the current flows into the EL element 15. It is a matter of course that no current flows into the EL element 15 in the image display of the black display. The area, in which the switching transistor 11d opens, is the non-display area 182.

In the case of the pixel configuration in FIG. 2, the program current (reset current) Ia flows into the source signal line 18 during the first period of 1H (Va or V0 measuring period) as shown in FIG. 17A. The voltage is set (programmed) in the capacitor 19 so that the program current Ia flows in the driver transistor 11a and the current, which flows the program current Ia, is held. Alternatively, the voltage is held in the capacitor 19 so that the current, which flows the program current Ia into the gate terminal of the driver transistor 11a, flows. At this moment, the transistor 11d is in the open state (off state).

The transistors 11c and 11b are turned off and the transistor 11d operates during the period for flowing the current into the EL element 15 as shown in FIG. 17B. That is to say, the off voltage (Vgh) is applied to the gate signal line 17a and the transistors 11b and 11c are turned off. On the other hand, on voltage (Vg1) is applied to the gate signal line 17b and the transistor 11d is turned on.

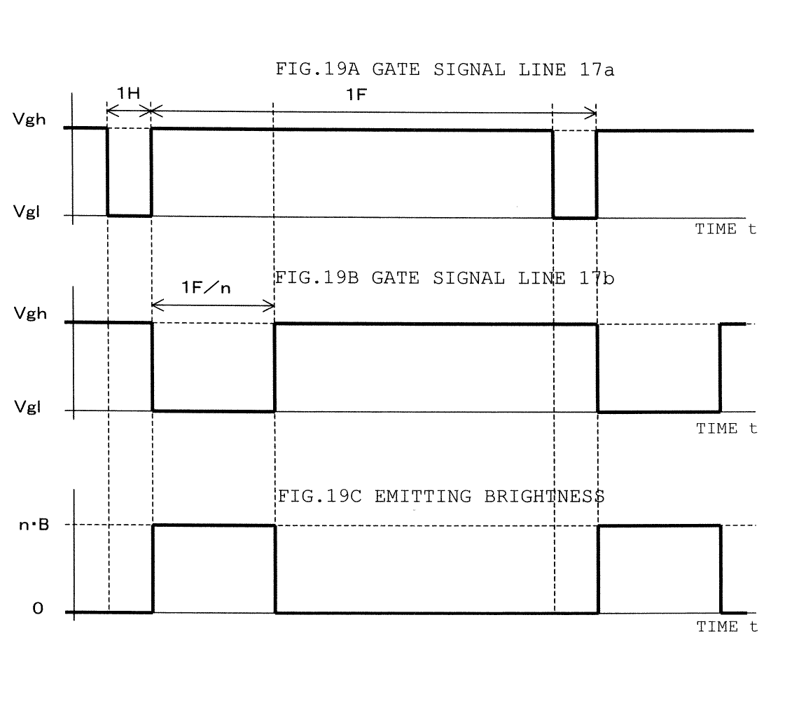

A timing chart of the driving method described in FIGS. 17A and 17B and FIGS. 18A and 18B is shown in FIGS. 19A to 19C. In FIGS. 19A to 19C, the off voltage (Vgh) is applied to the gate signal line 17b when the on voltage (Vg1) is applied to the gate signal line 17a (see FIG. 19A) in the selected line of pixels in FIG. 19 (see FIG. 19B). During the period, no current flows into the EL element 15 of the selected line of pixels (non-lighting state). The selecting period is one horizontal scanning period (1H).

The on voltage (Vg1) is applied to the gate signal line 17b in the line of pixels in the lighting state of the lines of pixels in which on voltage is not applied (not selected) to the gate signal line 17a. The current flows into the EL element 15 of the line of pixels and the EL element 15 emits light.

The off voltage (Vgh) is applied to the gate signal line 17b in the line of pixels in the non-lighting state of the lines of pixels in which on voltage is not applied (not selected) to the gate signal line 17a. No current flows into the EL element 15 in the line of pixels and the EL element 15 is in the non-light emitting state.

If charging and discharging the source signal line 18 is performed fast to measure or obtain the reset voltage Va, or if black insertion is performed on the image display (non-display area insertion) to improve the motion picture visibility, the amount of the reset current Ia is multiplied by N. The current flown into the EL element 15 is multiplied by N as the amount of the reset current Ia is multiplied by N. If the gradation voltage Vx is multiplied by 1 as in the conventional case, an effect of enabling the charging and discharging of the source signal line 18 to be performed fast is exerted by the effect of writing the reset current Ia multiplied by N. In such a case, as the reset voltage Va, which is a standard, has been a voltage, which makes the EL current multiplied by N, the gradation voltage Vx to be added or subtracted also needs to be set in consideration of this. This also applies to the target gradation voltage Vc.

At least one of the reset voltage Va, the target gradation voltage Vc, the gradation voltage Vx, and the reset current Ia preferably has a relation of being proportional to or correlating with N of the multiplication of N. The present invention is preferably implemented in combination with the embodiments shown in FIGS. 18A and 18B, FIGS. 21A and 21B, FIGS. 22A and 22B or the like.

For simplicity of the description, it is assumed that the reset current Ia in measuring the reset voltage Va is also multiplied by N and Vx to be added to Va and V0 is also set so that the driver transistor 11a flows the current multiplied by N into the EL element 15. Brightness of the screen 184 which is displayed by the EL display apparatus is B when the current is multiplied by 1 and brightness of the light-emitting part is displayed by the brightness of B×N when the current multiplied by N flows.

The reset current Ia to be flown into the EL element 15 is N-fold of the current required for obtaining the average (predetermined) brightness B of the screen 184. The EL element 15 lights with N-fold of the average brightness B, (N·B). The lighting period is 1 F/N. 1 F is one field (frame). For simplicity of the description, it is assumed that no blanking period is in a field (frame). Actually, the brightness is not correctly N·B due to the blanking period. The EL element 15 emits light with N-fold of the brightness B, (N·B) for the 1/N period of 1 F. Therefore, the display brightness of the display panel with 1 F averaged is (N·B)×(1/N)=B (predetermined brightness).

N can be any actual number if only it is bigger than 1. If N is too big, an instantaneous carrying current to be flown into the EL element 15 is also big. Thus, N is preferably 10 or below. It is a matter of course that N=1 and those other than the writing line of pixels 181 are made a display (lighting) area 183. In such a case, the current Ia to be flown into the EL element 15 is a current required for obtaining the average (predetermined) brightness B of the screen 184. Therefore, the EL element 15 lights (emits) with predetermined brightness B. In order to implement a low brightness display, N may be smaller than 1.

One of the reasons for flowing the reset current Ia multiplied by N to make the emitting brightness N·B is to reduce an influence of the parasitic capacity of the source signal line 18. With big current being flown, the charge of the parasitic capacity can be charged or discharged in a short time.

A voltage to be used in the EL display panel of the present invention will be described with reference to FIG. 20. The gate driver circuit 12 is formed by the buffer circuit 202 and the shift register circuit 201. The buffer circuit 202 uses the off voltage (Vgh) and the on voltage (Vg1) as a voltage. On the other hand, the shift register circuit 201 uses the voltage VGDD of the shift register and the grand (GND) voltage and also uses the VREF voltage for generating an inverted signal of the input signal (CLK, UD, ST). The source driver circuit (IC) 14 uses the voltage Vs and the grand (GND) voltage. The line of pixels, to which the reset voltage Ia is applied, is specified by operating the gate driver circuit 12.

Agate driver circuit 12a has a shift register circuit 201a and the buffer circuit 202. Therefore, the gate driver circuit 12a performs on-off control on the gate signal line 17a. For simplicity of the description, the pixel configuration will be described as exemplifying FIG. 1.

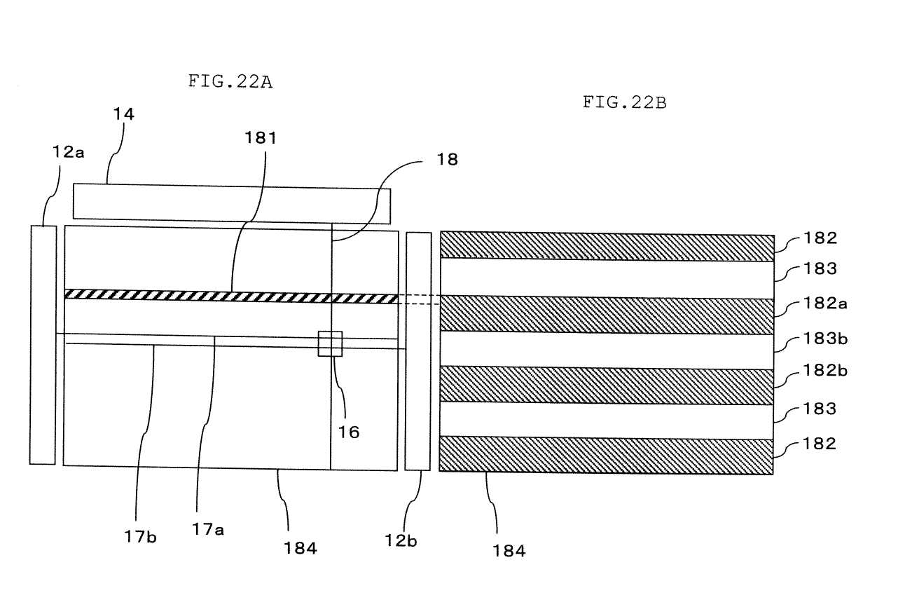

FIGS. 18A and 18B show a method with one display area 183. The present invention is not limited to that. For example, as shown in FIGS. 22A and 22B, the display area 183 and the non-display area 182 are dispersed for a plurality of areas.

As shown in FIGS. 22A and 22B, an intermittent interval (non-display area 182/display area 183) is not limited to being equally spaced. For example, it may be random (it is allowed when as a whole, the display period or the non-display period becomes a predetermined value (a certain proportion)). It may differ depending on RGB. The display period or the non-display period of R, G, and B only needs to be adjusted (set) to be a predetermined value (a certain value) so that the white balance will be optimized.

The non-display area 182 is an area of the pixel 16 of the non-lighting EL element 15 at a certain time. The display area 183 is an area, in which the EL element 15 lights at a certain time. If the video signal is black display, the EL element 15 does not light. Even in such a case, as the EL element 15 operates to light the black display, it is the lighting area. The non-display area 182 and the display area 183 shifts by one line of pixels in sync with a horizontal synchronizing signal.

The embodiment of FIG. 11 shows a method of obtaining a voltage V0, adding the gradation voltage Vx with the voltage V0 as a standard, and generating the target gradation voltage Vc. FIGS. 4A to 4C show a method of obtaining the reset voltage Va, adding or subtracting the gradation voltage Vx with the voltage as a standard, and generating the target gradation voltage Vc. The present invention is not limited to them. For example, the reset current Ia to be applied may be the current corresponding to the maximum gradation (Iam) when the reset voltage Va is obtained.

As the reset current corresponding to the maximum gradation (Iam) is applied to the driver transistor 11a, the driver transistor 11a generates the reset voltage Vam on the gate terminal to flow the current with the maximum gradation. The target gradation voltage Vc is generated as the gradation voltage Vx is subtracted with the Vam as a standard. The generated voltage Vcm is applied to the gate terminal of the driver transistor 11a.

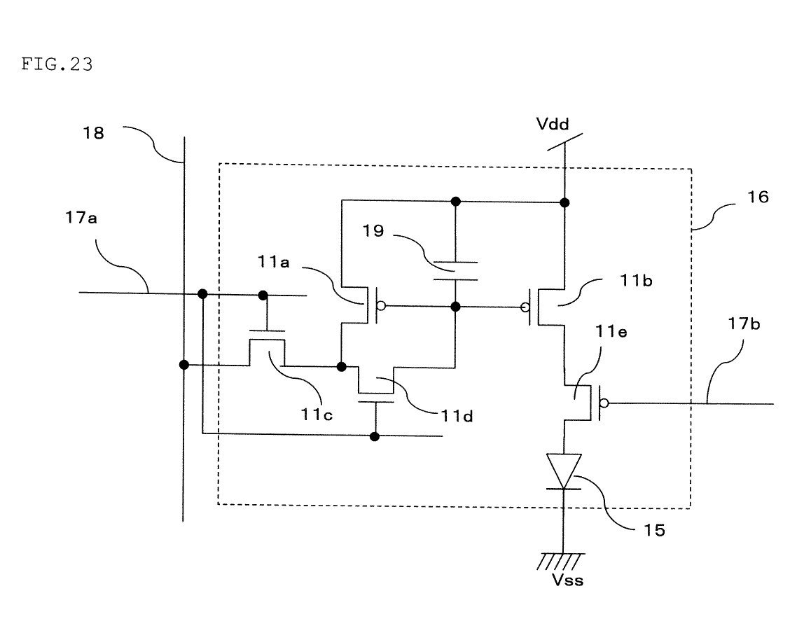

The present invention relates to the EL display apparatus with a pixel configuration mainly in the current driving system. The present invention also relates to the EL display apparatus having a pixel structure in which the drain terminal or the source terminal of the driver transistor 11a or the transistor 11b that is current-mirror-combined with the driver transistor 11a is connected by a wire to the source signal line 18 in a direct current manner. The present invention further relates to the EL display panel in a configuration for retrieving the current flowing to the driver transistor 11a (FIG. 2, FIG. 23 or the like) to the source signal line 18 or obtaining the current from the source signal line 18.

The driving method of the present invention measures (obtains) the gate terminal potential of the driver transistor 11 after the driver transistor 11 is almost in the steady state by applying the reset current Ia to the driver transistor 11 or flowing the reset current Ia from the driver transistor 11.

The driving method of the present invention generates the target gradation voltage Vc by adding or subtracting the voltage corresponding to the gradation voltage with the measured (obtained) potential as a standard (an origin or a corresponding position). The generated target gradation voltage is applied to the gate terminal of the driver transistor 11. The driving method is for causing the driver transistor 11 to flow the current corresponding to the target gradation voltage to the EL element 15. The term “to flow the current into the EL element 15” includes both of supplying the current to the EL element 15 and flowing the current from the EL element 15 to the driver transistor 11.

The abovementioned embodiment is the embodiment of flowing the current Ie, which is multiplied by about 1, to the driver transistor 11 with the reset voltages Va, V0, or Vam as standards. The present invention is not limited to them. For example, it is the matter of course that in the driving method of “flowing the current to the EL element 15 only during 1 F/N period and not flowing the current during the other periods (1 F (N−1)/N)” as described in FIGS. 18A and 18B, FIGS. 21A and 21B, and FIGS. 22A and 22B, the reset current Ia may be set as multiplied by N (N is a real number). The reset voltage Va corresponding to the constant current multiplied by N (reset current Ia) is obtained and the target gradation voltage Vc is generated with the reset voltage Va as a standard.

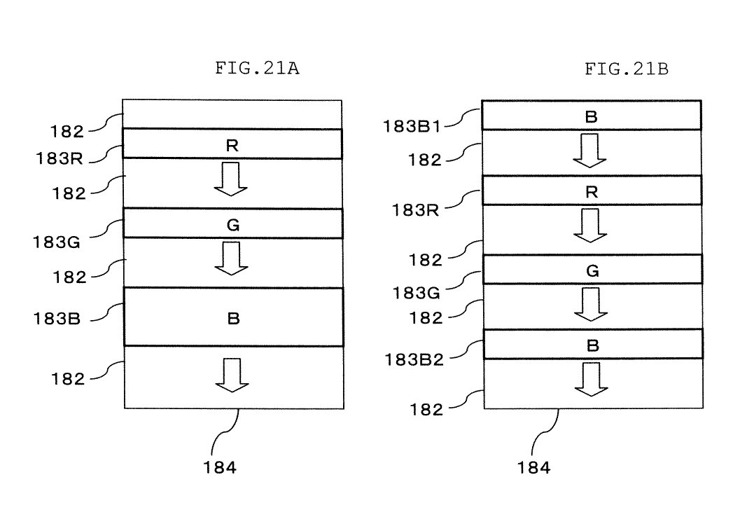

In the driving method of the present invention, intermittent display can be implemented for each of red (R), green (G), and blue (B) as shown in FIGS. 21A and 21B. In FIG. 21A, an area of the lighting area 183 differs among R, G and B. In FIG. 21B, the area of the lighting area 183 is the same for R, G and B but the total of the lighting areas differs by adopting multiple lighting areas of B. The white balance of the image display can be adjusted as the area of the lighting areas 183 of R, G and B differs, is changed or adjusted.

Although the area of the lighting area 183 is described as different in the abovementioned embodiment, it may be considered that the area of the non-lighting area 182 is made different.

In the display of FIGS. 18A and 18B, one display area 183 or one non-display area 182 moves from the top to the bottom of the screen. If the frame is low, movement of the display area 183 is visually recognized. Specifically, when eyelids are closed, or the face is moved upward or downward, the movement can be easily recognized.

To solve the problem, the display area 183 may be divided into multiple areas as shown in FIGS. 22A and 22B. If the total of the divided areas is the area of S (N−1)/N, the brightness is the same as that of FIGS. 18A and 18B. The divided display area 183 needs not to be divided equally. Nor the divided non-display area 182 needs to be divided equally.

The pixel configuration of the present invention is described by exemplifying a configuration of FIG. 2, but the present invention is not limited to that. For example, it may be in another pixel configuration such as in FIG. 23.

With the pixel configuration of FIG. 23, the transistors 11c and 11d are turned on (closed) at programming. The source driver IC (circuit) 14 outputs the program current (reset current) Ia. The program current (reset current Ia) Ia flows into the driver transistor 11a which, which forms the current mirror circuit with the transistor 11b, and the voltage corresponding to the program current is held in the capacitor 19. The transistor 11e implements intermittent control or the like described in FIGS. 18A and 18B, FIGS. 21A and 21B, FIGS. 22A and 22B or the like as it is subjected to the on-off (close-open) control by the control signal (on-off signal) applied to the gate signal line 17b.

The embodiment of FIG. 23 is not an embodiment for flowing the program current (reset current) Ia to the transistor 11b which applies the current Ie to the EL element 15. The embodiment of FIG. 2 is an embodiment for flowing the program current (reset current) Ia to the transistor 11a which applies the current Ie to the EL element 15. The technical concept of the present invention is in that the reset current Ia or the like is flown from the source driver IC (circuit) 14 or the like to compensate characteristics of the driver transistor 11b which flows the current directly to the driver transistor 11a or indirectly to the EL element 15. Therefore, the configuration of FIG. 23 is also included in the technical range of the present invention. With the configuration of FIG. 23, the transistor lie may be omitted. This is because that the reset current Ia is divided when Va is measured and does not flow into the EL element 15.

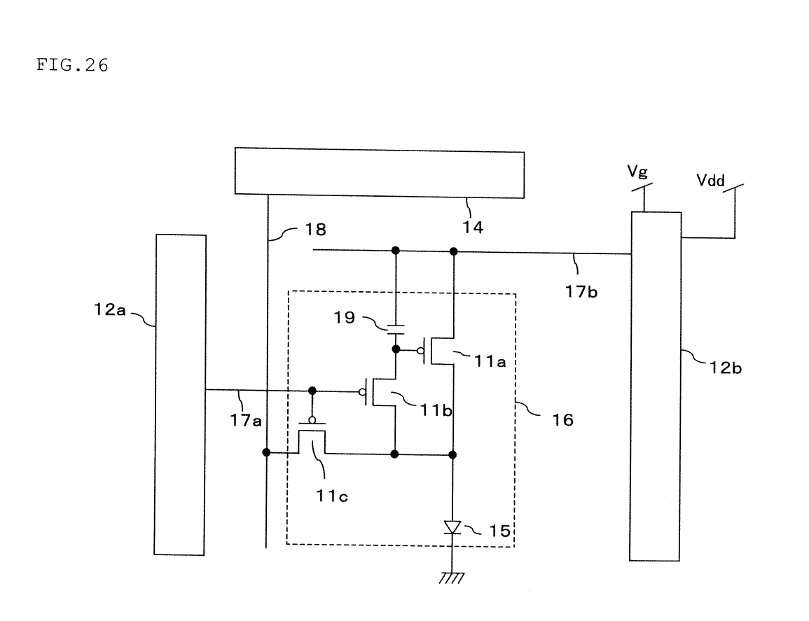

Although the pixel configuration of FIG. 2 or the like is for the transistor lid to control the current to be flown by the transistor 11d into the EL element 15, the present invention is not limited to that. For example, the current to be applied to the EL element 15 may be subjected to on-off control without the transistor 11d as shown in FIG. 26.

In FIG. 26, the gate driver circuit 12b controls the gate signal line 17b, and the potential of the gate signal line 17b is driven by the Vdd voltage and the voltage Vg, which is lower than Vdd and by which no current flows into the EL element 15. That is to say, the Vdd voltage and the Vg voltage are outputted to the gate signal line 17b. When the Vdd voltage is applied to the gate signal line 17b, a current flows into the EL element 15. When the Vg voltage is applied to the gate signal line 17b, no current flows into the EL element 15. FIG. 26 is the same as FIG. 2 in that the reset current Ia is applied to the driver transistor 11a. Therefore, a configuration without the gate driver 12b is also included in the technical range of the present invention as in FIG. 26.

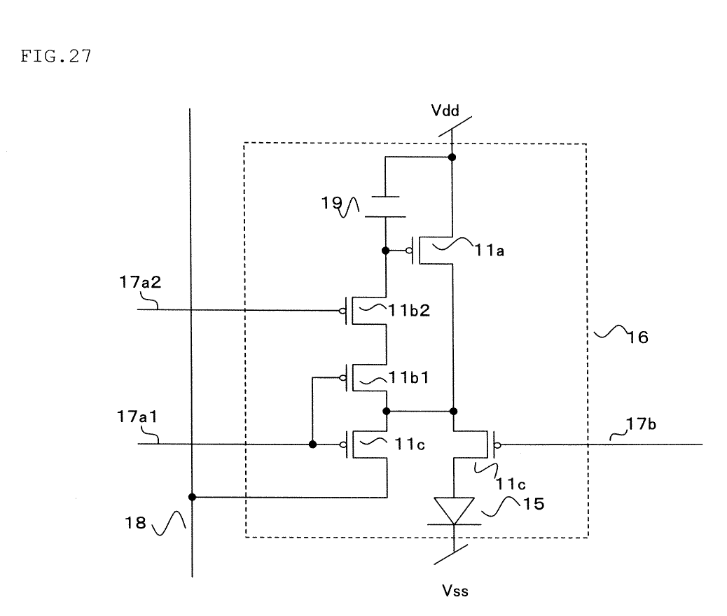

As a modification of FIG. 2, a pixel configuration of FIG. 27 is exemplified. FIG. 27 is different from FIG. 2 in that the transistor 11b is separated into a transistor 11b1 and a transistor 11b2 and the gate signal line 17a is separated into a gate signal lines 17a1 and 17a2.

The transistor 11b1 is controlled by the gate signal line 17a1 with the transistor 11c. The transistor 11b2 is controlled by the gate signal line 17a2. When the program current (reset current) Ia is applied, the reset voltage Va or the reset voltage V0 are measured, and the gradation voltage Vc is applied to the selected pixel 16, the transistors 11b1, 11b2 and 11c are closed.

When the selection period of the pixel completes (1H), first, the off-voltage is applied to the gate signal line 17a2 and the transistor 11b2 enters in the open state. Next, during the period ranging from 0.5 micro seconds to 5 micro seconds (both inclusive), the off voltage is applied to the gate signal line 17a1 and the transistors 11b1 and 11c enter into the off state. The period for selecting a line of pixels (1H period) continues until the off voltage is applied to the gate signal line 17a1 or until the transistor 11b1 enters into the open state.

As the transistor 11b2 enters into the open (off) state before the transistor 11b1 does, an influence of the punch-through voltage, which is generated when the on voltage applied to the gate signal line 17a1 changes to the off voltage, can be reduced. This is because that the transistor 11b2 is already in the off (open) state when the off voltage is applied to the gate signal line 17a1. Therefore, the influence of the punch-through voltage does not affect the gate terminal of the transistor 11a.

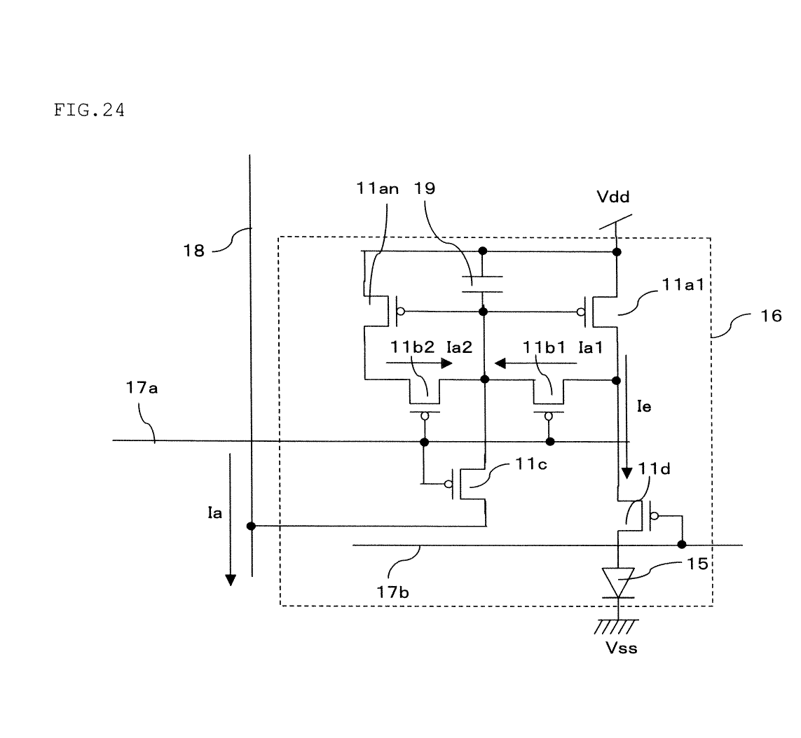

In the pixel configuration described in FIG. 2 or the like, one driver transistor 11a is included in each pixel 16. In the present invention, however, the driver transistor 11a is not limited to one. For example, the pixel configuration shown in FIG. 24 is exemplified.

FIG. 24 is an embodiment, in which the number of transistors forming the pixel 16 is six, the program transistor 11an is connected to the source signal line 18 via two transistors of the transistor 11b2 and the transistor 11c2, and the driver transistor 11a1 is connected to the source signal line 18 via two transistors of the transistor 11b1 and the transistor 11c.

In FIG. 24, the gate terminal of the driver transistor 11a1 and the gate terminal of the program transistor 11an are common. The transistor 11b1 operates to short-circuit the drain terminal and the gate terminal of the driver transistor 11a1 when the current is programmed. The transistor 11b2 operates to short-circuit the drain terminal and the gate terminal of the program transistor 11an when the current is programmed.

Although one driver transistor 11a1 and one transistor 11an are shown in FIG. 24, the present invention is not limited to that. Two or more driver transistors 11a1 may be formed. Two or more transistors 11an may be formed. It is a matter of course that a plurality of the transistors 11a1 and 11an may be formed.

The transistor 11c is connected to the gate terminal of the driver transistor 11a1, and the transistor 11d is formed or arranged between the driver transistor 11a1 and the EL element 15 for controlling the current flown into the EL element 15. An additional capacitor 19 is formed or arranged between the gate terminal and the anode (Vdd) terminal of the driver transistor 11a1, and the source terminals of the driver transistor 11a1 and program transistor 11an are connected to the anode (Vdd) terminal.

As mentioned above, as the driver transistor 11a1 and the program transistor 11an are adapted to pass through the same number of the transistors, accuracy can be improved. The current flown in the driver transistor 11a1 flows into the source signal line 18 through the transistor 11b1 and the transistor 11c. The current flown in the program transistor 11an flows into the source signal line 18 through the transistor 11b2 and the transistor 11c. Therefore, the current of the driver transistor 11a1 and the current of the program transistor 11an are adapted to flow into the source signal line 18 through the same number of two transistors.

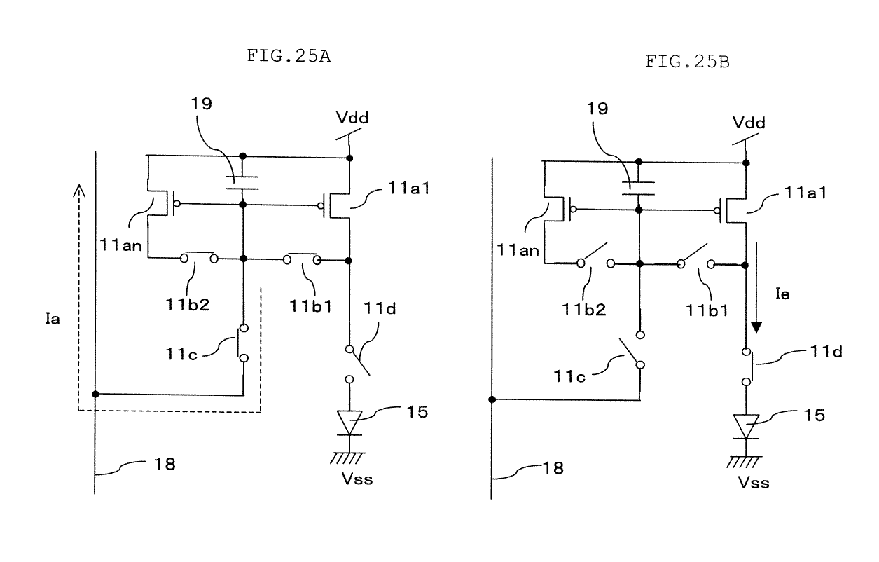

FIGS. 25A and 25B are schematic diagrams of an operation of the pixel configuration of FIG. 24. FIG. 25A is a transmitting circuit diagram in a current programming state or in a state of measuring Va. FIG. 25B shows a state of supplying the current into the EL element 15. It is a matter of course that an intermittent display can be implemented by turning on or off (closing or opening) the transistor 11d in the state of FIG. 25B.

In FIG. 25A, the on voltage is applied to the gate signal line 17a, and the transistors 11b1, 11b2 and 11c are turned on. The transistor 11a1 supplies the current Ie, the transistor 11an supplies the current Ia-Ie so that the combined reset current Ia is the program current (reset current Ia) Ia for the source driver Ic. Therefore, the source driver IC (circuit) 14 supplies the reset current Ia to the pixel 16.

With the abovementioned operation, the reset voltage Va corresponding to the program current Ia is held in the capacitor 52. During the period, the transistor 11d is held in the off state (the off voltage is applied to the gate signal line 17b). Then, the target gradation voltage Vc corresponding to the display gradation is written in the pixel 16.

An operation state of FIG. 25B shows the case where the current flows into the EL element 15. The off voltage is applied to the gate signal line 17a and the on voltage is applied to the gate signal line 17b. In such a state, the transistors 11b1, 11b2 and 11c enter in the off state, and the transistor 11d enters in the on state. Ie current is supplied to the EL element 15.

As mentioned above, the present invention may be applied in various image configurations such as FIG. 2, FIG. 23, FIG. 24, FIG. 26, and FIG. 27.

In FIG. 2, FIG. 5, and FIG. 6, the reference numeral 10 denotes the constant current output circuit. The source driver IC (circuit) 14 will be described focusing on the configuration and the operation of the constant current output circuit 10.

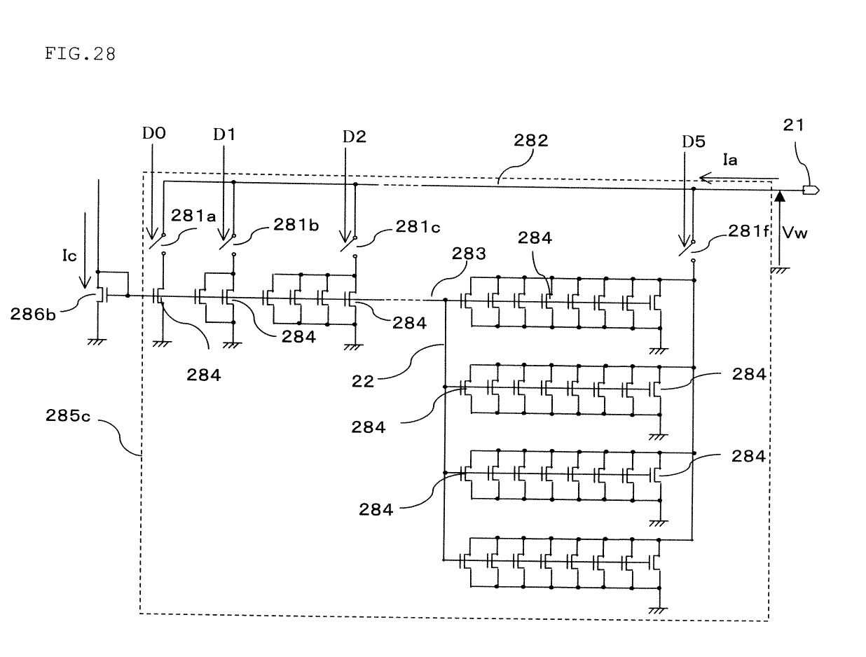

The constant current output circuit 10 is formed as a set of unitary transistors 284 as shown in FIG. 28. The term “unitary current” is the amount of one unit of the program current which is outputted from the unitary transistor corresponding to the amount of a standard current. The term “unitary transistor” is the transistor or the power source, which outputs a unit of or the minimum units of program current. That is to say, the unitary transistor=unitary power source. Alternatively, a configuration or a part of a plurality of unitary transistors that outputs the program current or the reset current Ia is referred to as a group of unitary transistors.

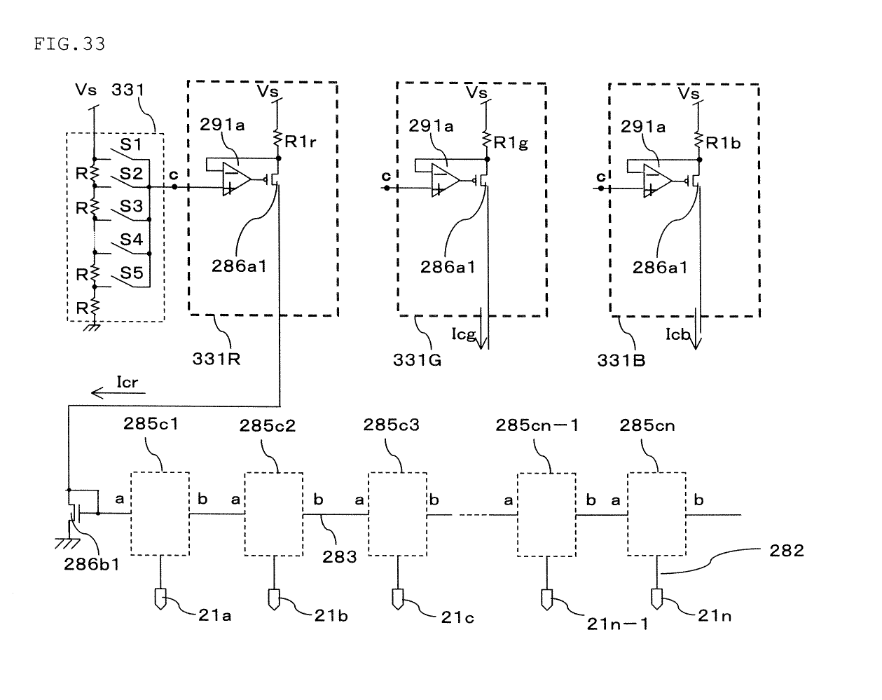

The amount of the unitary current may be variable as the amount or the strength of the standard current Ic outputted from the standard current circuit is adjusted. The standard current is adjusted by an electronic volume 331 built in the source driver IC (circuit) 14. The standard current circuit that generates the standard current is provided for each of red (R), green (G), and blue (B) circuits so that the white balance can be adjusted by adjusting the amount of the standard current of each of the RGB standard current circuits. Therefore, the amount of the reset current Ia, the reset volume Va or the like of each pixel of the R, G, and B can be set independently. The target gradation voltage Vc, the gradation voltage Vx of each pixel of R, G and B can be set independently. FIG. 33 shows the embodiment.

Each output stage of R, G and B is formed by a set of the unitary transistors 284, and the amount of the unitary transistor output current (unitary program current) can be adjusted by the amount of the standard current. If the amount of the standard current is adjusted, the amount of the program current (reset current) Ia of each gradation can be adjusted or variable for each of RGB. Therefore, in the ideal state where the characteristics of the unitary transistor of RGB are the same, the white balance can be achieved as the ratio of the amount of the standard current of RGB is changed.

Although it is described that a group of unitary transistors 285 or the like is formed or arranged in the source driver circuit (IC) 14 in the embodiment below, the present invention is not limited to that. For example, the group of unitary transistors 285 may be formed on the array substrate. The pixels 16, the group of unitary transistors 285 and the gate driver circuit 12 may be formed on the array substrate, while the other parts may be formed on the source driver circuit (IC) 14.

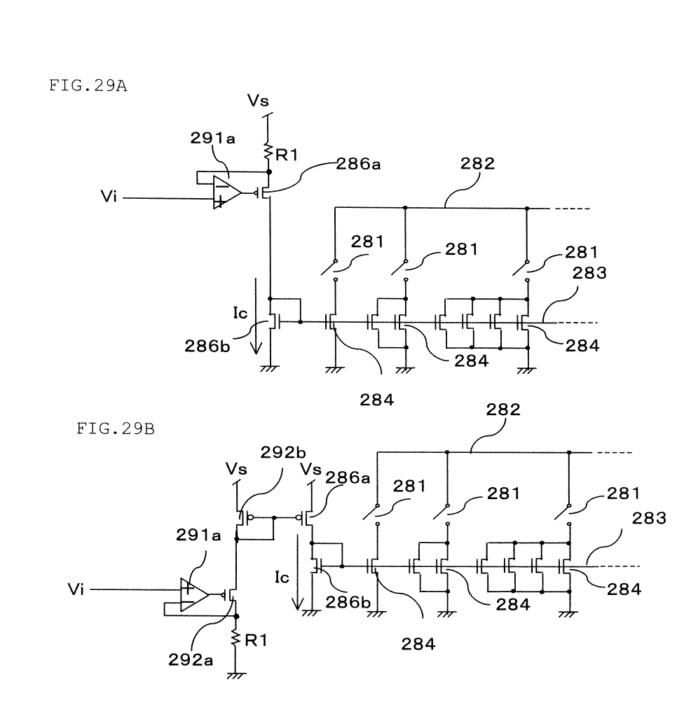

As shown in FIG. 28, FIGS. 29A and 29B, and the like, on the source driver circuit (IC) 14, the output stages (a group of transistors) 285 corresponding to the number of output terminals are formed or arranged. To each output stage of the group of transistors 285, the unitary transistor 284 corresponding to the number of variable bits of the reset current Ia is formed or arranged. For example, if a control signal (increment) of the reset current Ia is basically six bits (D0-D5), six power of two −1=63 transistors 284 are formed. As the gradation 0 is the current 0, any output of the unitary transistor is not outputted to the source signal line 18. If the control signal of the reset current Ia is eight bits (D0-D7), eight power of two −1=255 transistors 284 are formed.

For simplicity of description or diagram, description is made by assuming that the constant current output circuit 10 of the source driver circuit (IC) 14 is six bits. In FIGS. 22A and 22B, each unitary transistor 284 is arranged for each constant current data (D0-D5). On the D0 bit, one unitary transistor 284 is arranged. On the D1 bit, two unitary transistors 284 are arranged. On the D2 bit, four unitary transistors 284 are arranged. On the D3 bit, eight unitary transistors 284 are arranged. On the D4 bit, sixteen unitary transistors 284 are arranged. Similarly, on the D5 bit, 32 unitary transistors 284 are arranged.

Whether output current of the unitary transistors 284 of each bit is outputted to the output terminal 21 or not is achieved by on-off control by the analog switch 281 (281a-281f). The analog switches 281a-281f correspond to each bit (six bit as an example) of a control signal of the constant current. When the switch 281a corresponding to D0 bit closes, one unitary current is outputted from (inputted into) the output terminal 21. To the output terminal 21, the source signal line 18 is connected. Similarly, when the switch 281b corresponding to the D1 bit closes, two unitary currents are outputted from (inputted into) the output terminal 21.

Similarly, when the switch 281c corresponding to the D2 bit closes, four unitary currents are outputted from (inputted into) the output terminal 21. When the switch 281c corresponding to the D3 bit closes, eight unitary currents are outputted from (inputted into) the output terminal 21. When the switch 281d corresponding to the D4 bit closes, 16 unitary currents are outputted from (inputted into) the output terminal 21. When the switch 281c corresponding to the D5 bit closes, 32 unitary currents are outputted from (inputted into) the output terminal 21.

As mentioned above, the switch 281 digitally closes or opens according to the bit of the controlling signal of the reset current Ia and the total of the unitary current (program current) is outputted from the output terminal 21.

The unitary transistor 284 forms the current mirror circuit with the transistor 286b. For easier understanding, one transistor 286b is shown in FIG. 28 and FIGS. 29A and 29B. Actually, it is arranged (formed) by a plurality of transistors (a group of transistors).

The standard current Ic is flown into the transistor 286b, and the current according to the current mirror ratio of the standard current Ic flows in the transistor 284. All the 63 unitary transistors 284 of FIG. 28 output the same unitary current. The corresponding switch 281 needs to close and the current path needs to be formed to flow the unitary current.

The standard current Ic is generated in the constant current generating circuit, which is formed by an operation amplifier 291a and a resistance R1. The standard current Ic becomes constant as the standard voltage Vs is standardized and made more accurate. The voltage Vi and Vs which set the standard current Ic are applied to both sides of the resistance R1. Therefore, the standard current Ic=(Vs−Vi)/R1. The standard current Ic can be set for each of RGB. That is to say, a group of transistors 285 is arranged (formed) for each of RGB.

FIG. 29A shows a circuitry for generating the standard current Ic by using Vs voltage. FIG. 29B shows a configuration for generating a basic current by using the resistance R1 which is arranged (inserted) between a GND and a terminal of the operation amplifier 291a, folding back the current by the current mirror circuit formed by the transistor 292b and the transistor 286a, and flowing the standard current Ic to the transistor 286b. The amount of the standard current Ic can be more easily adjusted in FIG. 29B than in FIG. 29A, however, in FIG. 29B, variations are apt to be generated as the current is folded back by the current mirror circuit formed by the transistor 292b and the transistor 286a.

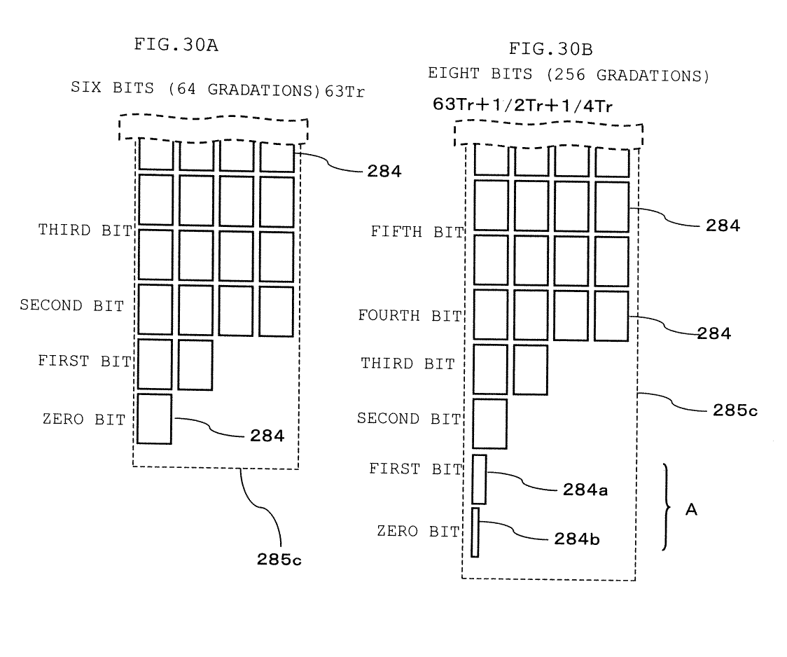

The present invention is adapted to form or arrange one or more unitary transistors 284 in each bit as shown in FIG. 30A. For example, one unitary transistor is formed in the first bit and two unitary transistors are formed in the second bit.

The present invention is not limited to that, however. It is a matter of course that one transistor 284 which outputs a current according to each bit may be formed or arranged in each bit. For example, one transistor that outputs the current double the current of the transistor at the 0^{th} bit is formed or arranged for the first bit. One transistor that outputs the current four-folded the current of the transistor at the 0^{th} bit is formed or arranged for the transistor at the second bit. Alternatively, two transistors that output the current double the current of the transistor at the first bit may be formed or arrange for the transistor at the second bit.

As shown in FIG. 30A, 63 unitary transistors 284 are formed for 64 gradations (six bits for each of RGB). Therefore, 255 unitary transistors 284 are needed for 256 gradations (eight bits for each RGB).

FIG. 30A shows a configuration of the group of transistors 285, in which the unitary transistors 284 in the same size are arranged for each bit. For simplicity of the description, it is assumed that 63 unitary transistors 284 are formed for configuring (forming) the group of transistors 285 of six bits in FIG. 30A. In FIG. 30B, it is assumed that the group of transistors 285 is of eight bits.

In FIG. 30B, the lower two bits (denoted by the reference character A) are formed by transistors, each of which is smaller than the unitary transistor 284. The 0^{th} bit of the minimum bit is formed in one-fourth of the channel width W of the unitary transistor 284 (denoted by a unitary transistor 284b). The first bit is formed in a half of the channel width W of the unitary transistor 284 (denoted by a unitary transistor 284a). The unitary transistor 284a may be formed by two unitary transistors 284b, which is one-fourth of the channel width W of the unitary transistor 284.

The gate terminals of the unitary transistors 284a, 284b and 284 are connected to the same gate wire 282. The gate wire 283 is connected to the gate terminal of the transistor 286b.

As mentioned above, the lower two bits are formed by unitary transistors (284a, 284b), each of which has a size smaller than that of the upper unitary transistor 284. Therefore, the unitary transistors 284a and 284b can output a half unitary current, one-fourth of the unitary current of the unitary transistor 284. The area occupied by the unitary transistors 284a, 284b is quite small. The number of the normal unitary transistors 284 is unchanged 63. Therefore, if the number of the bits is changed from six bits (64 gradations) to eight bits (256 gradations), the area forming a group of the transistors 285 differ little between FIG. 30A and FIG. 30B. That is to say, the chip size of the source driver IC (circuit) 14 used in the program current system little depends on the number of the gradations. In contrast, the source driver IC (circuit) 14 used in the program voltage system largely depends on the number of the gradations.

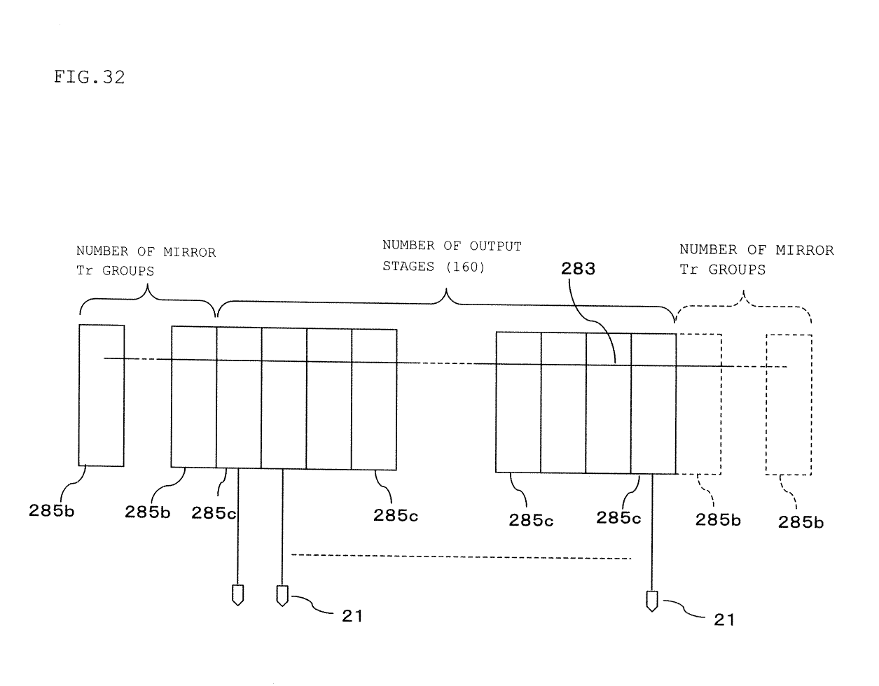

As also shown in FIG. 32, the gate terminal of the unitary transistors 284, which forms the group of transistors 285, is connected by one gate wire 283. The output current of the unitary transistor 284 is decided by the volume applied to the gate wire 283. Therefore, if the shapes of the unitary transistors 284 in the group of the transistors 285 are the same, each unitary transistor 284 outputs the same unitary current.

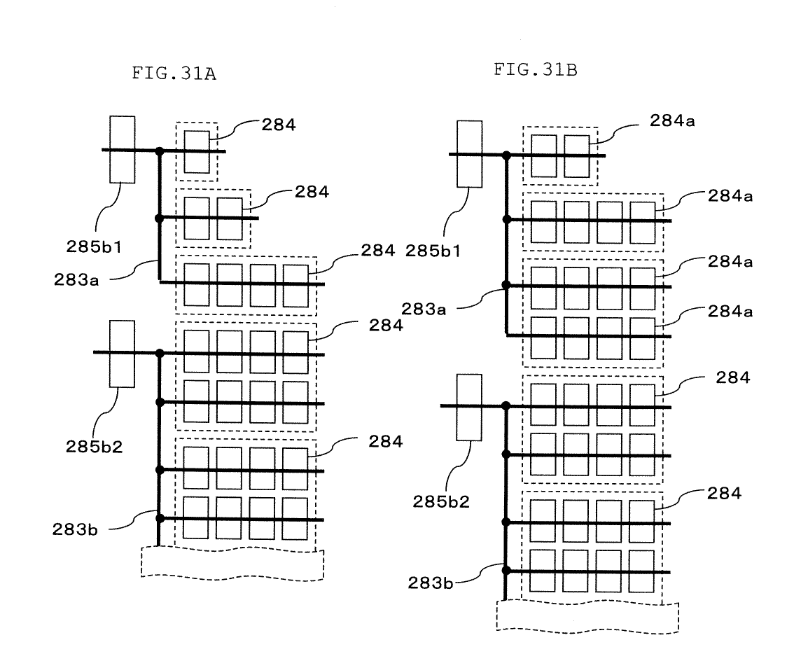

The present invention is not limited to making the gate wire 283 of the unitary transistors 284, which form a group of transistors 285, common. For example, the present invention may be formed as FIG. 31A. The transistor 286b corresponds to the group of transistors 251b. The transistor 286b is formed by the group of transistors 285. In FIG. 31A, a group of transistors 251b1 and the unitary transistor 284, which forms the current mirror circuit, and a group of transistors 251b2 and the unitary transistor 284, which forms the current mirror circuit, are arranged. The group of the transistors 285 can output the gradation current corresponding to the gradation volume. Therefore, the reset current Ia in proportion to or in correspondence with the target gradation voltage Vc and the gradation voltage Vx can be generated. It is a matter of course that the reset current Ia of a predetermined value, the reset current Ia in multiple stages can be generated. The amount of the reset current Ia may be set or adjusted independently from each other in RGB.

The group of transistors 251b is connected to the gate wire 283a. The group of transistors 251b2 is connected by the gate wire 283b. One unitary transistor 284 at the top of FIG. 31A is the LSB (0^{th} bit), two unitary transistors 284 at the second stage are the first bit, and four unitary transistors 284 at the third stage are second bit. Eight unitary transistors in the set of the fourth stage are the third bit.

In FIG. 31A, the output current of each unitary transistor 284 can be changed (adjusted) by changing the voltage applied to the gate wire 283a and the gate wire 283b even if the size and the shape of each unitary transistor 284 are the same.

Although it is described that the size or the like of the unitary transistor 284 is made the same to differentiate the voltage of the gate wires 283a and 283b in FIG. 31A, the present invention is not limited to that. The output current of the unitary transistor 284 with different shapes can be made the same as the size of the unitary transistor 284 is differentiated to adjust the voltage of the gate signals 283a and 283b to be applied.

The standard current Ic is changed by a method for changing the electronic volume 331 such as in FIG. 33. Here, FIG. 33 shows the electronic volume 331 and electronic volumes 331R, 331G and 331 B formed for each RGB. The standard current Ic can be changed in sync with the synchronizing signal (HD) during the horizontal scanning period (H) and the synchronizing signal (VD) during the vertical scanning period (V). VD and HD are generated in synchronization with the clock inside the source driver circuit.

The source driver circuit (IC) 14 includes a pre-charge circuit, which forcedly discharges or charges the charge of the source signal line 18 (see FIG. 12, FIG. 13 and FIG. 14). The voltage (current) output value of a pre-charging or discharging circuit, which forcedly discharges or charges the charge of the source signal line 18, is preferably adapted to be set independently for R, G, and B. This is because that the threshold of the EL element 15 differs for each of the RGB. This is also because that the reset voltage Va differs for each of the RGB.

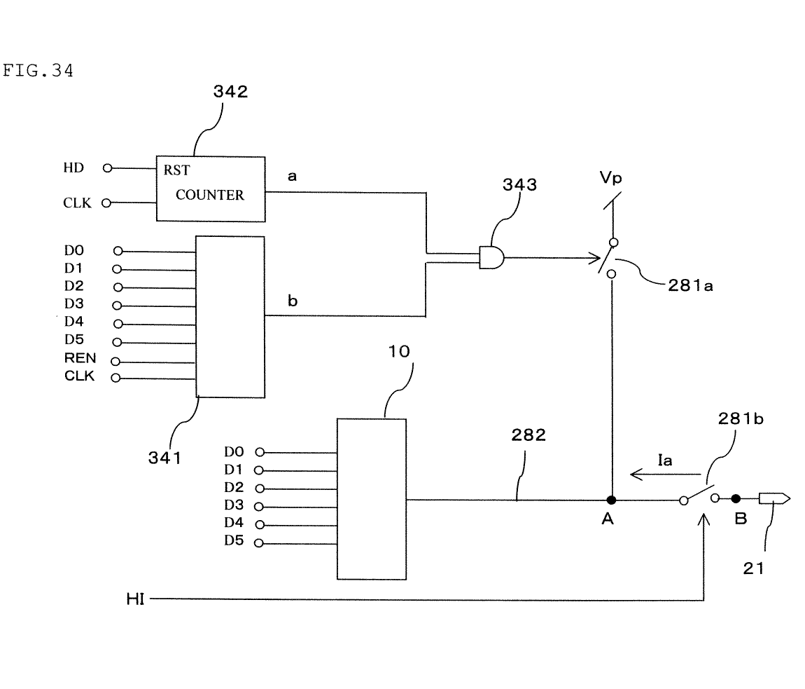

FIG. 34 is a schematic diagram of the pre-charging unit. Vp is the pre-charge voltage. Preferably the applying period of the pre-charge voltage Vp is determined according to the image data D0-D5. Alternatively, it is preferable that the output period is determined according to the gradation voltage Vx. Alternatively, the image data or the gradation voltage Vx preferably decides the amount of the pre-charge voltage Vp.

The pre-charge voltage Vp is outputted in synchronization with HD or VD. The time period for outputting the pre-charge voltage is decided by a set value of the counter 342 with the horizontal synchronization signal HD as a starting point. The counter 342 is counted up as synchronized with a clock CLK signal. The pre-charge voltage output period starts at the beginning of the HD. When the count value that is counted by the counter 342 matches the set value, the output period of the pre-charge voltage ends. The output of the counter circuit 342 is an input of the part “a” of the And (AND) circuit 343. The pre-charge voltage Vp is adapted to switch between on (apply)/off (not apply).

In the configuration of FIG. 34, the condition for pre-charging is decided by a match circuit 341. To the match circuit 341, image data D0-D5 is applied. The match circuit memorizes the range of the pre-charge voltage. The match circuit 341 operates as synchronized with the clock CLK. When the enable signal EN is H, the pre-charge voltage is outputted; and if it is L, the pre-charge voltage is not outputted without regard to the value of the image data. The output of the match circuit 341 is an input of the terminal “b” of the And circuit 343.

When the input of the part “a” of the And circuit 343 is H and the input of the terminal “b” is H, the switch 281a closes and the pre-charge voltage Vp is applied to the inside wire 282, and when also an HI signal is H. the switch 281b closes and the pre-charge voltage is outputted from the output terminal 21.

FIG. 35 is a block diagram focusing on the pre-charge circuit (circuitry part to output a pre-charge voltage) 353 of the source driver circuit (IC) 14. The pre-charge circuit 353 is a circuit which outputs a pre-charge control signal PC signal (red (RPC), green (GPC), blue (BPC)) by the pre-charge control circuit.

The selector circuit 352 latches to the latch circuit 351 corresponding to the output stage in synchronization with a main clock in order. The latch circuit 351 is configured by two stages of the latch circuit 351a and the latch circuit 351b. The latch circuit 351b sends out data to the pre-charge circuit 353 in synchronization with the horizontal scanning clock (1H) That is to say, the selector latches image data and PC data for one line of pixels in order to store the data in the latch circuit 351b in synchronization with the horizontal scanning clock (1H).

In FIG. 35, R, G and B of the latch circuit 351 are the latch circuit of six bits of the image data in RGB, and P is the latch circuit for latching three bits of the pre-charge signal (RPC, GPC, BPC).

When the output of the latch circuit 351b is in the H level, the pre-charge circuit 353 turns on the switch 281a and outputs the pre-charge voltage Vp to the source signal line 18. The constant current output circuit 10 outputs the program current (reset current Ia) to the source signal line 18 according to the image data.

Description will be given to the voltage gradation circuit 20 below. The voltage Vx outputted by the voltage gradation circuit 20 is referred to as a program voltage. The program voltage Vx is added to the reset voltage Va or the reset voltage V0 to be the target gradation voltage Vc (as an example, Vc=Va+Vx).

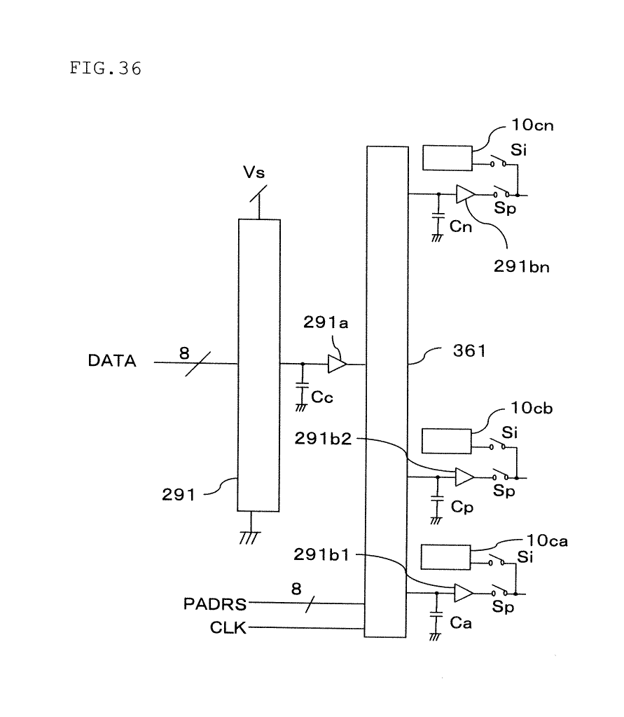

As shown in FIG. 36, a voltage corresponding to the image Data of eight bits (program voltage) is synchronized with an image clock and outputted from the electronic volume 331. The program voltage is temporally held in a Cc capacity and outputted from the buffer amplifier 291a. The outputted voltage is distributed to each output terminal 21 (output terminals 21a, 21b, 21c, 21d . . . , 21n, 21a, 21b, 21c, . . . 21n) by the sample holding circuit (in this embodiment, it is shown as a switching circuit) 361 in order. The distribution is performed in synchronization with the clock CLK.

The voltage outputted from the voltage gradation circuit 20 may reflect the variations of the characteristics of the driver transistor 11a of the EL display panel. The reset voltage Va of each driver transistor 11a or the voltage similar to that is measured in advance. The measurement is exemplified by a method for electronically reading the reset voltage Va as shown in FIG. 1. A predetermined voltage is applied to the display area of the EL display apparatus, the emitting state of each lighting EL element is optically measured by using a scanner or the like. The variations of the characteristics of each driver transistor 11a are obtained from the measured image data. The gradation voltage Vx is corrected by using the measured image data.

### Second Embodiment

A second embodiment of the present invention will be described below. In the embodiment below, description on the parts and the operations same as those of the first embodiment will be omitted. The description focuses on the differences from the first embodiment. The abovementioned description is applied to the embodiments hereafter. For example, a configuration relating to a driver circuit of FIG. 5, FIG. 6, FIG. 8, FIG. 9 and the like can be applied and combined as required. The configuration relating to the pre-charge methods such as in FIG. 12, FIG. 13, FIG. 14 and the like and the pre-charge circuit of FIG. 34 can be applied and combined as required. The configuration relating to the data transmitting method of FIG. 15 can be applied and combined as required. The configuration relating to the gate driver circuit of FIG. 20, the intermittent display of FIGS. 18A and 18B, FIGS. 21A and 21B, and FIGS. 22A and 22B, and the source driver circuit of FIG. 28, FIGS. 29A and 29B, FIGS. 30A and 30B, FIGS. 31A and 31B, FIG. 32, FIG. 33, FIG. 35, FIG. 36 and FIG. 38 can be applied and combined as required. The application of the abovementioned things are not limited to the second embodiment and can also be applied to the other embodiments.

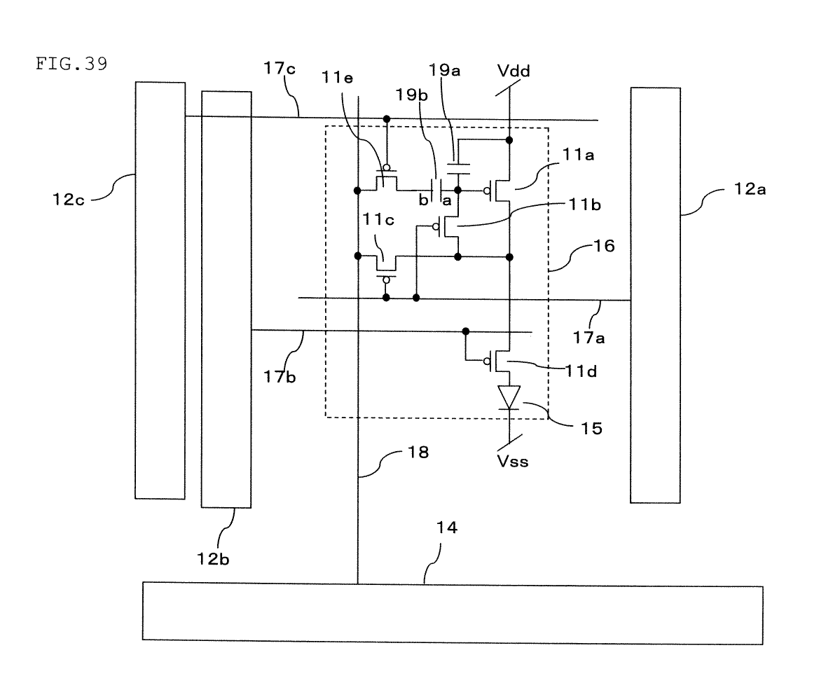

FIG. 39 is a schematic diagram of an image configuration of the EL display apparatus in the second embodiment of the present invention. A difference from FIG. 2 is that the capacitor 19b and the switching transistor 11e are added. The capacitor 19b is arranged between the gate terminal of the driver transistor 11a and the drain terminal of the transistor 11e. The capacitor 19b cuts direct components of a signal. Three kinds of color pixels of RGB are formed on the EL display apparatus in a matrix. For simplicity of description, FIG. 39 also shows that one pixel is extracted as in FIG. 2.

The transistor 11b and the transistor 11c operate to apply the current signal applied to the source signal line 18 to the driver transistor 11a (current program). The capacitor 19b and the transistor 11e operate to apply the voltage signal applied to the source signal line 18 to the driver transistor 11a (voltage program).

There are three gate driver circuits 12 of 12a, 12b and 12c. The gate driver circuit 12a controls the gate signal line 17a. The gate driver circuit 12b controls the gate signal line 17b. The gate driver circuit 12c controls the gate signal line 17c. The gate driver circuits 12a, 12b and 12c have shift register circuits therein respectively to shift the place of the gate signal line 12, which selects a line of pixels, by achieving synchronization.

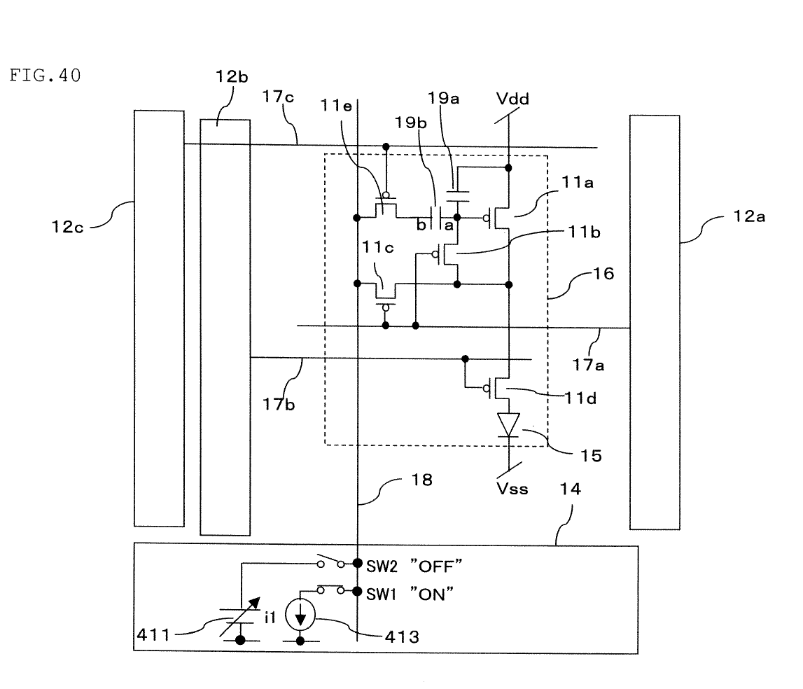

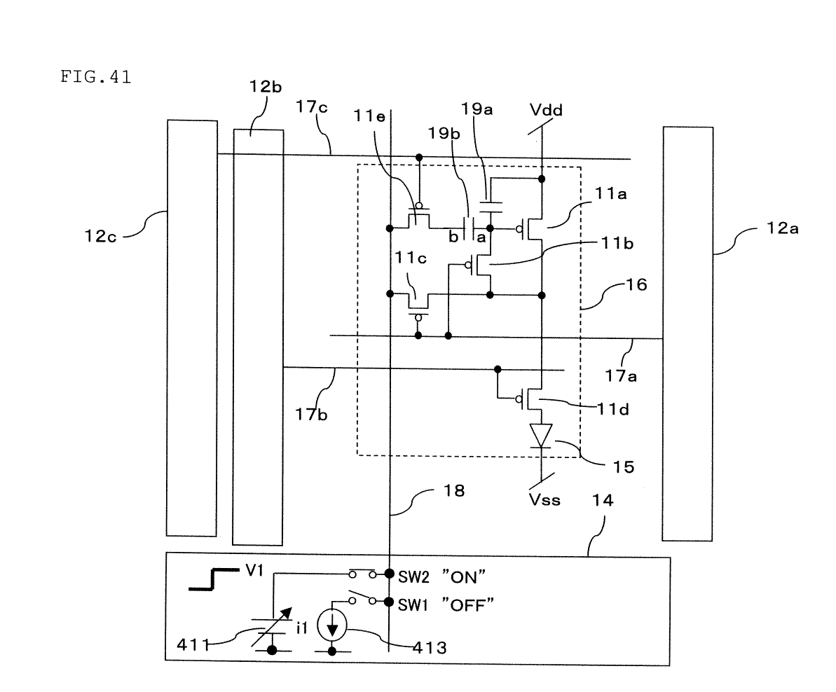

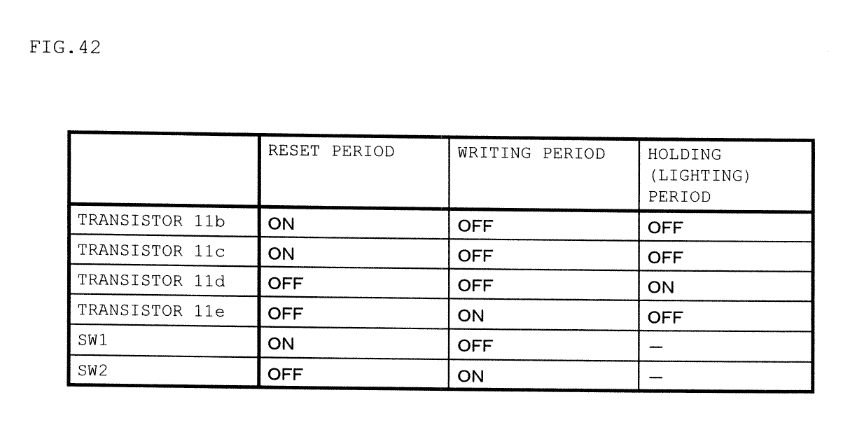

FIG. 40 and FIG. 41 are schematic diagrams of the driving method of the EL display apparatus of the present invention of FIG. 39. The source driver circuit 14 has the constant current output circuit and the voltage gradation circuit as in the abovementioned embodiment. The operation is largely divided into the reset period, the writing period and the holding (emitting) period as shown in FIG. 42. The reset period is a period for applying the reset current Ia to the driver transistor 11a. The writing period is a period for writing the target gradation voltage Vc in the pixel 16. The holding period is a period for the EL element 15 to emit light.

The reset period is implemented at the beginning of IH. After the reset period, the writing period starts. The reset period+ the writing period=one horizontal scanning period (a period for selecting one line of pixels) In some cases, the writing period may start immediately after the reset period.

The second embodiment has a stage for applying the reset current Ia to the pixel 16 and a stage for applying the target gradation voltage Vc to the pixel 16 as in the first embodiment. It also has an operation for generating the target gradation voltage Vc from the reset voltage Va and the gradation voltage Vx.

Description will be given to an operation of the EL display apparatus of the present invention with reference to FIG. 42, FIG. 40 and FIG. 41.

As shown in FIG. 40, the gate driver circuit 12a controls the gate signal line 17a and selects one line of pixels during the reset period. The transistors 11c and 11d of the selected line of pixels enter in the on (close) state. The switch SW1 of the source driver circuit 14 is turned on and the constant current circuit 413 applies the rest current Ia to the source signal line 18. The reset current Ia flows through the anode voltage Vdd→the driver transistor 11a→the transistor 11c→the source signal line 18 of the selected pixel 16. The switch SW2 is in the off state.

As the reset current Ia flows into the driver transistor 11a, the gate terminal of the driver transistor 11a is subjected to the current program to flow the reset current Ia therein. The reset voltage Va, which is set to flow the reset current Ia, is held in the capacitor 19b, which is connected with the gate terminal of the driver transistor 11a as in the first embodiment (point a). At the same time, as the transistor 11c and the transistor 11b are in the on state, the potential of the point “a” of the capacitor 19b and the potential of a point “b” are the same potential. Therefore, no difference in potential occurs at both terminals of the capacitor 19b. As the off voltage is applied to the gate signal line 17c and the gate signal line 17b during the abovementioned operation, the transistor 11e and the transistor 11d are held in the off (open) state.

FIG. 41 is a schematic diagram of an operation of the writing period. The writing period is a period of the voltage program. During the writing period, the gate driver circuit 12c controls the gate signal line 17c and selects one line of pixels to which the reset current Ia is applied. The transistor 11e of the selected line of pixels enters in the on (close) state. The switch SW2 of the source driver circuit 14 is turned on and the gradation voltage circuit 411 applies the gradation voltage Vx to the source signal line 18. The switch SW1 is in the off state. The transistors 11b, 11c, and 11d are in the off state.

The gradation voltage Vx is applied to the terminal “b” of the capacitor 19b of the pixel 16, which is selected via the transistor 11e. The gradation voltage Vx is V1. For simplicity of description, the gradation voltage V1 is assumed to generate a potential difference V1 with the reset voltage Va as a standard.

When the gradation voltage V1 is applied to the terminal “b” of the capacitor 19b, the terminal “a” of the capacitor 19b shifts the potential by the potential of V1. The potential of the terminal “a” of the capacitor 19b is the reset voltage Va+ the gradation voltage V1=the target gradation voltage Vc. The target gradation voltage Vc is applied to the gate terminal of the driver transistor 11a.

During the holding (emitting) period, the on voltage is applied to the gate signal line 17b and the transistor 11d enters in the on state. The on-off control of the transistor 11d is implemented so as to correspond to the driving method of FIGS. 18A and 18B, FIGS. 21A and 21B and FIGS. 22A and 22B. During the holding (emitting) period, the transistors 11e, 11b and 11c are held in the off state. The driver transistor 11a performs voltage/current conversion on the target gradation voltage Vc and applies the converted current to the EL element 15. The EL element 15 emits light in association with the applied current.

As mentioned above, the gate signal line 17a and the gate signal line 17c are combined and select the line of pixels in order. To the selected line of pixels, the reset current Ia and the gradation voltage Vx are applied and the target gradation voltage Vc is applied to each pixel of the line of pixels.

In the first embodiment of the present invention, the target gradation voltage Vc was generated by using the capacitor 52 formed in the source driver or the like. The generated target gradation voltage Vc was outputted to the source signal line 18 and applied to the driver transistor 11a.

In the second embodiment of the present invention, the target gradation voltage Vc is generated as a result of the gradation voltage Vx being outputted to the source signal line 18 and the reset voltage Va and the gradation voltage Vx being added (subtracted) by the capacitor 19b of the pixel 16.

It is a matter of course that when the pre-charge voltage Vp is applied at the beginning of 1H by the pre-charge voltage Vp generating circuit such as in FIG. 34, the driving systems of FIGS. 12 to 14 can be implemented. In the second embodiment, the driving system can be combined with the driving method for selecting a plurality of lines of pixels of FIGS. 16A and 16B. As a constant current output circuit, such a configuration as in FIG. 28 may be adopted.

As mentioned above, the second embodiment of the present invention can be combined with the other embodiments. Each component and the driving method can be adopted. In the pixel configuration described in the specification, they can be adopted. The abovementioned things are similarly applied in the other embodiments.

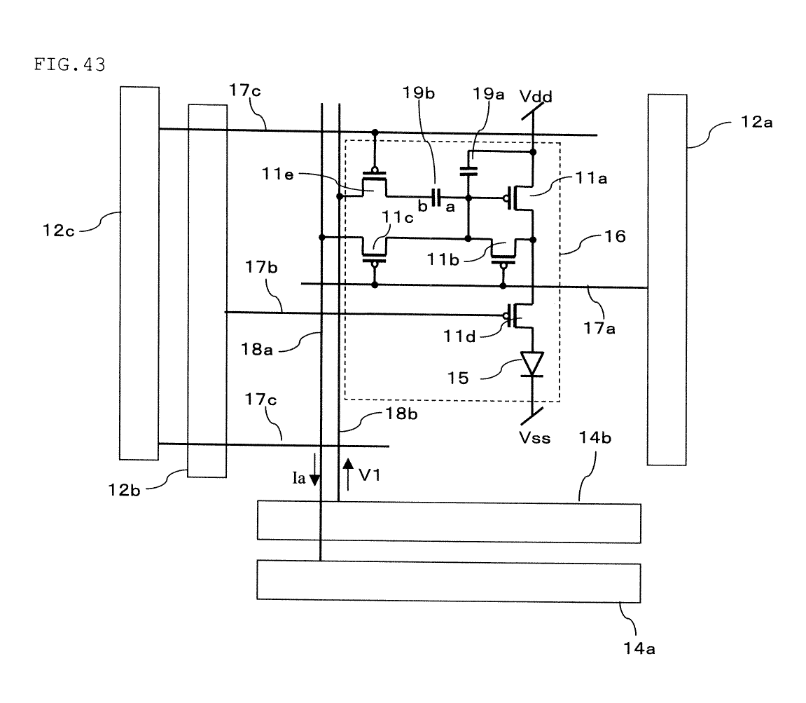

FIG. 43 shows the third embodiment. In FIG. 43, the source driver circuit 14a, which generates the reset current Ia, and the source driver circuit 14b, which generates the gradation voltage Vx, are included. The output terminal of the source driver circuit 14a is connected to the source signal line 18a. The output terminal of the source driver circuit 14a is connected to the source signal line 18b. The source terminal of the transistor 11c is connected to the source signal line 18a and the source terminal of the transistor 11e is connected to the source signal line 18b. The other configurations or the like are the same as those of the first embodiment and the second embodiment.

### Third Embodiment

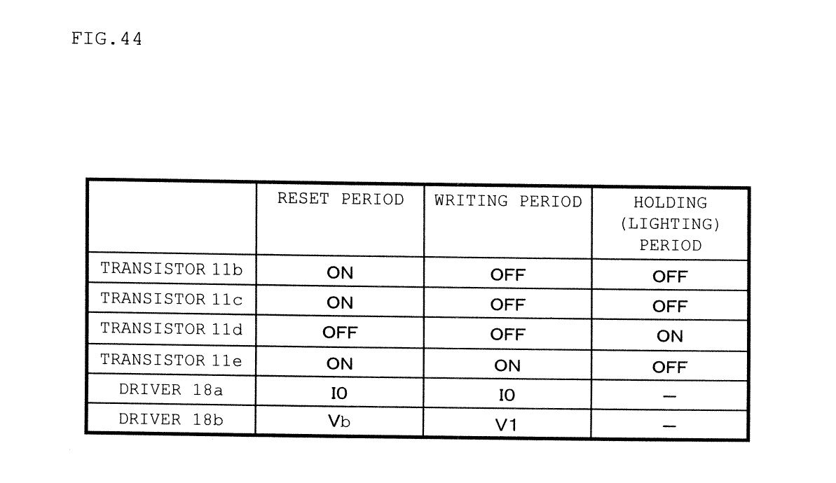

The table shown in FIG. 44 shows an operation state of each component of a third embodiment of the present invention. With reference to FIG. 43 and FIG. 44, the third embodiment of the present invention will be described. Similarly to the second embodiment, the gradation voltage Vx will be described as V1.

During the reset period, the gate driver circuit 12a controls the gate signal line 17a and selects one line of pixels. The transistors 11c and 11b of the selected line of pixels enter in the on state (closed). The source driver circuit 14 applies the reset current Ia to the source signal line 18a. The reset current Ia flows through the anode voltage Vdd→the driver transistor 11a→the transistor 11c→the source signal line 18a of the selected pixel 16. As described in the abovementioned embodiments, for the current direction of the reset current Ia, either the outlet current direction or the inlet current direction is selected and adopted according to a configuration of the pixel 16.

The reset current Ia flows in the driver transistor 11a. To the gate terminal of the driver transistor 11a, the current program is performed to flow the reset current Ia. Accordingly, the reset voltage Va is set to the gate terminal of the driver transistor 11a to flow the reset current Ia. The reset voltage Va is held at the point “a” of the capacitor 19b.

During the writing period, the on voltage is applied to the gate signal line 17c and the transistor 11e is turned on. The transistor 11e may be turned on during the reset period and the on state may be continued during the writing period. During the writing period, the transistors 11b, 11c and 11d are kept in the off state.

During the writing period, the source driver circuit 14b applies the gradation voltage V1 based on the video signal to be inputted to the source signal line 18b. As the transistor 11e is turned on, the voltage V1 applied to the source signal line 18b is applied to the terminal “b” of the capacitor 19b. The potential of the terminal “b” of the capacitor 19b changes from the voltage Vb in an initial state to V1.

As the voltage of the terminal “b” changes from the voltage Vb in an initial state to the V1 voltage, the potential of the terminal “a” of the capacitor 19b changes from the Va voltage to Va+V1 (when it is in the additional direction). Alternatively, it changes to Va−V1 (when it is in the subtraction direction). Therefore, the target gradation voltage Vc=Va±Vx is applied to the gate terminal of the driver transistor 11a.

The voltage Vb in an initial state may be the reset voltage Va. It can be implemented by electrically short-circuiting the source signal line 18a and the source signal line 18b during the reset period. The short-circuiting can be easily implemented as an analog switch is formed between the source signal line 18a and the source signal line 18b. As the analog switch is turned on during the reset period, the voltage Va of the source signal line 18a is applied to the source signal line 18b.

The source driver circuit 14a steadily applies the reset current Ia to each source signal line 18a. Therefore, the potential of the source signal line 18a can be stably held. The reset voltage Va changes in correspondence with the characteristics of the driver transistor 11a according to the selection of a line of pixels.

During the holding (emitting) period, on voltage is applied to the gate signal line 17b and the transistor 11d enters in the on state. The on-off control of the transistor 11d is implemented in correspondence with the driving method of FIGS. 18A and 18B, FIGS. 21A and 21B and FIGS. 22A and 22B. During the holding (emitting) period, the transistors 11e, 11b, 11c are held in the off state. The driver transistor 11a performs voltage/current conversion on the target gradation voltage Vc and applies the converted current to the EL element 15. The EL element 15 emits light according to the applied current.

As mentioned above, the gate signal line 17a and the reset signal line 17c are combined together to select a line of pixels in order. The reset current Ia is applied to the driver transistor of the selected line of pixels, and the target gradation voltage Vc is applied to the gate terminal of the driver transistor 11a.

### Fourth Embodiment

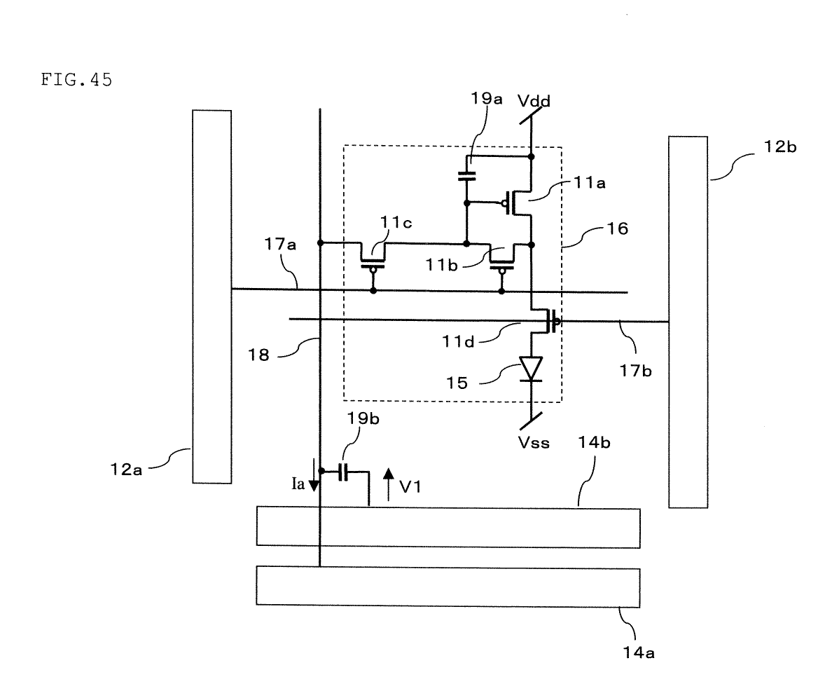

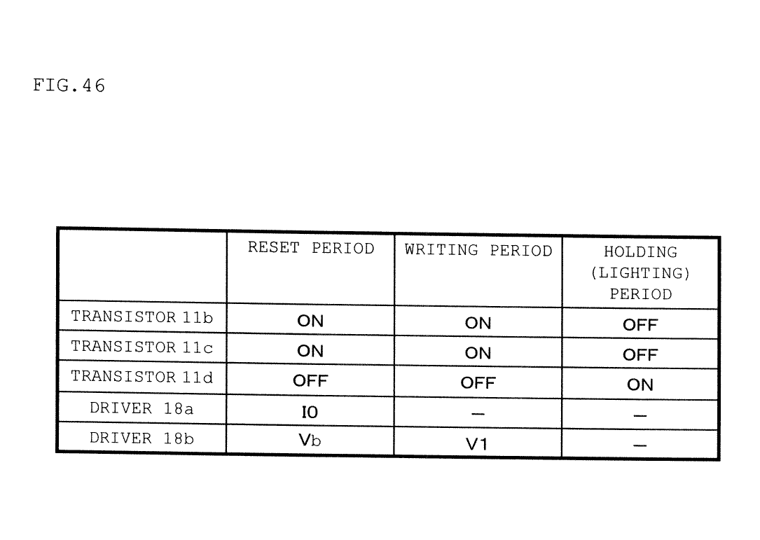

FIG. 45 shows a fourth embodiment. The table of FIG. 46 is a schematic diagram of an operation of FIG. 45. In the embodiment of FIG. 45, each pixel 16 is connected to one source signal line 18 as in the embodiments of FIG. 1 and FIG. 39. The big difference between them is that an output terminal of the source driver circuit 12a having the constant current output circuit and an output terminal of the source driver circuit 12b having the gradation voltage circuit are connected by the capacitor 19b.

During the reset period, the gate driver circuit 12a controls the gate signal line 17a and selects one line of pixels. The transistors 11c and 11b of the selected line of pixels enter in the on (close) state. The source driver circuit 14a applies the reset current Ia to the source signal line 18. The reset current Ia flows through the anode voltage Vdd→the driver transistor 11a→the transistor 11c→the source signal line 18 of the selected pixel 16.

The current program is performed on the gate terminal of the driver transistor 11a so as to flow the reset current Ia. The reset voltage Va, which is set to flow the reset current Ia, is held in the gate terminal of the driver transistor 11a and the source signal line 18 as in the first embodiment. The transistor 11d is in the off state during the reset period and the writing period.

The writing period starts after the reset period. During the writing period, the source driver circuit 14b outputs the gradation voltage Vx. As shown in the table of FIG. 46, it is described that the output voltage of the source driver circuit 14b is Vb voltage during the reset period and the gradation voltage Vx=V1 is outputted during the writing period.

During the writing period, the gradation voltage V1 is outputted from the gradation voltage circuit 411 of the source driver circuit 14b. The gradation voltage V1 is applied to the source signal line 18 via the capacitor 19b. Therefore, for the source signal line 18, the reset voltage Va+ the gradation voltage V1=the target gradation voltage Vc is provided. The target gradation voltage Vc is applied to the gate terminal of the driver transistor 11a.

During the holding (emitting) period, the on voltage is applied to the gate signal line 17b and the transistor 11d enters in the on state. During the holding (emitting) period, the transistors 11b and 11c are held in the off state. The driver transistor 11a performs the voltage/current conversion on the target gradation voltage Vc and applies the converted current to the EL element 15. The EL element 15 emits light in accordance with the applied current.

As mentioned above, the gate signal line 17a selects the line of pixels in order. The reset current Ia is applied to the selected line of pixels, and the reset voltage Va is retrieved to the source signal line 18, the voltage Vc which is by adding the reset voltage Va to the gradation voltage Vx added or subtracting the reset voltage Va from gradation voltage Vx is applied to the gate terminal of the driver transistor 11a.

### Fifth Embodiment

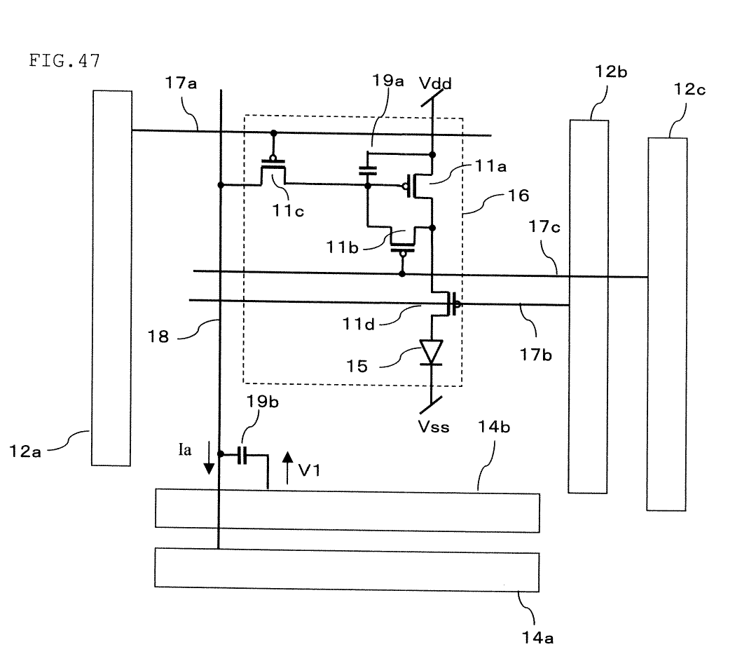

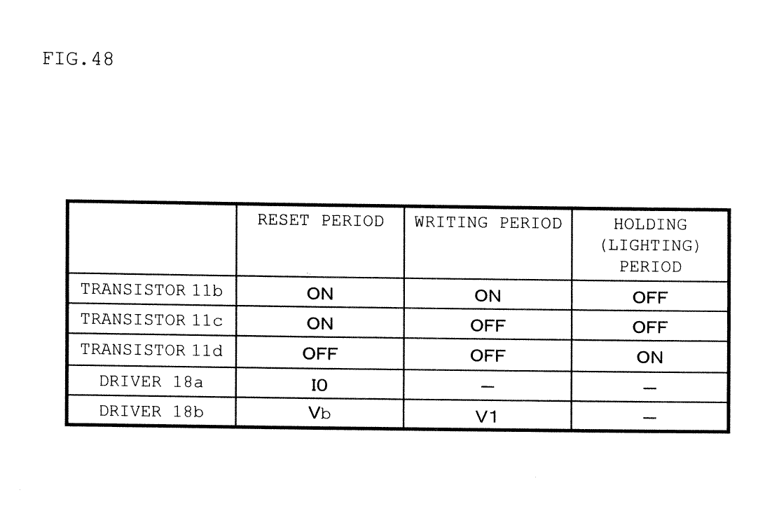

FIG. 47 shows a fifth embodiment. The table of FIG. 48 is a schematic diagram of an operation state of FIG. 47. The difference between the fifth embodiment and the forth embodiment is that the transistor 11b and the transistor 11c can be subjected to on-off control by the gate signal line 17a and the gate signal line 17c.

In FIG. 47, each pixel 16 is connected to one source signal line 18 as in the embodiment of FIG. 45. During the reset period, the gate driver circuit 12a and the gate driver 11c control the gate signal lines 17a and 17c and select one line of pixels. The transistors 11c and 11d of the selected line of pixels enter in the on (close) state. The source driver circuit 14a applies the reset current Ia to the source signal line 18. The reset current Ia flows through the anode voltage Vdd→the driver transistor 11a→the transistor 11c→the source signal line 18 of the selected pixel 16.

To the gate terminal of the driver transistor 11a, the current program is performed to flow the reset current Ia. The reset voltage Va set to flow the reset current Ia is outputted to the gate terminal of the driver transistor 11a and the source signal line 18 as in the fourth embodiment. The transistor 11d is in the off state during the reset period and the writing period.

During the writing period, the on voltage is applied to the gate signal line 17a and the on state of the transistor 11c is kept. The off voltage is applied to the gate signal line 17c and the transistor 11b is controlled to be in the off state. During the writing period, the gradation voltage V1 is outputted from the gradation voltage circuit 411 of the source driver circuit 14b. The gradation voltage V1 is applied to the source signal line 18 via the capacitor 19b. Therefore, the reset voltage Va+ the gradation voltage V1=the target gradation voltage Vc is provided for the source signal line 18. The target gradation voltage Vc is applied to the gate terminal of the driver transistor 11a.

Unlike the fourth embodiment, as the transistor 11b is in the off state during the writing period in the fifth embodiment, the target gradation voltage Vc can be well written into the driver transistor 11a.

During the holding (emitting) period, the on voltage is applied to the gate signal line 17b and the transistor 11d enters in the on state. During the holding (emitting) period, the transistors 11b and 11c are held in the off state. The driver transistor 11a performs voltage/current conversion on the target gradation voltage Vc and applies the converted current to the EL element 15. The EL element 15 emits light according to the applied current.

Although it is described that one kind of reset current Ia is applied to the pixel 16 in the embodiment of the present invention, the present invention is not limited to that. For example, two reset currents of a first reset current Ia1 of 10 μA and a second reset current Ia2 of 20 μA may be generated and the reset currents may be applied to the pixels to obtain respective target gradation voltages. An accurate target gradation voltage can be obtained as the obtained target gradation voltage is averaged.

Although the number of times to apply the reset current Ia to the pixel 16 is described as one in the embodiment of the present invention, the present invention is not limited to that. For example, the reset current Ia of 10 μA may be applied to the pixel 16 four times to obtain respective target gradation voltages. An accurate target gradation voltage can be obtained as the obtained target gradation voltage is averaged.

The things below are common to the first to the fifth embodiments.

In the first to the fifth embodiments, the constant current output circuit is used. The constant current output circuit may be formed in the source driver circuit or may be formed in the array substrate 30. FIG. 49 shows an example where a constant current output circuit is formed in the source driver circuit 14 that is manufactured by the semiconductor IC technique. To the array substrate 31, the current holding circuit 501 is formed. To the output terminal of the source driver circuit 14, two current holding circuits 501 (501a, 501b) are connected. The source driver circuit 14 outputs the reset current Ia in the outlet current direction.

FIG. 50 is a detailed configuration diagram of the two current holding circuits (501a, 501b). The current holding circuit 501 is formed by the capacitor 19 which holds the current and the driver transistor 11 which outputs or generates the written current (held current) It is also formed by the switches SA and SB.

When the reset current Ia of the pixel 16 flows into the current holding circuit 501a, the source driver circuit 14 writes the reset current Ia to the current holding circuit 501b. When the reset current Ib of the pixel 16 flows into the current holding circuit 501b, the source driver circuit 14 writes the reset current Ia to the current holding circuit 501a. The reset current Ia is written from the source driver circuit 14 into the current holding circuits 501a and 501b alternately.

In order to write the reset current Ia from the source driver circuit 14 to the current holding circuit 501a, the transistor (switch) SAa is turned on. At that moment, the transistor (switch) SAb is turned off. In order to flow the current from the pixel 16 to the current holding circuit 501a, the transistor (switch) SAb is turned on. At that moment, the transistor (switch) SAa is turned off.

Similarly, in order to write the reset current Ia from the source driver circuit 14 to the current holding circuit 501b, the transistor (switch) SBa is turned on. At that moment, the transistor (switch) SBb is turned off. In order to flow the current from the pixel 16 to the current holding circuit 501, the transistor (switch) SBb is turned on. At that moment, the transistor (switch) SBa is turned off. With the above configuration, the configuration of the source driver circuit 14 can be simplified and the number of the output terminals can be reduced.

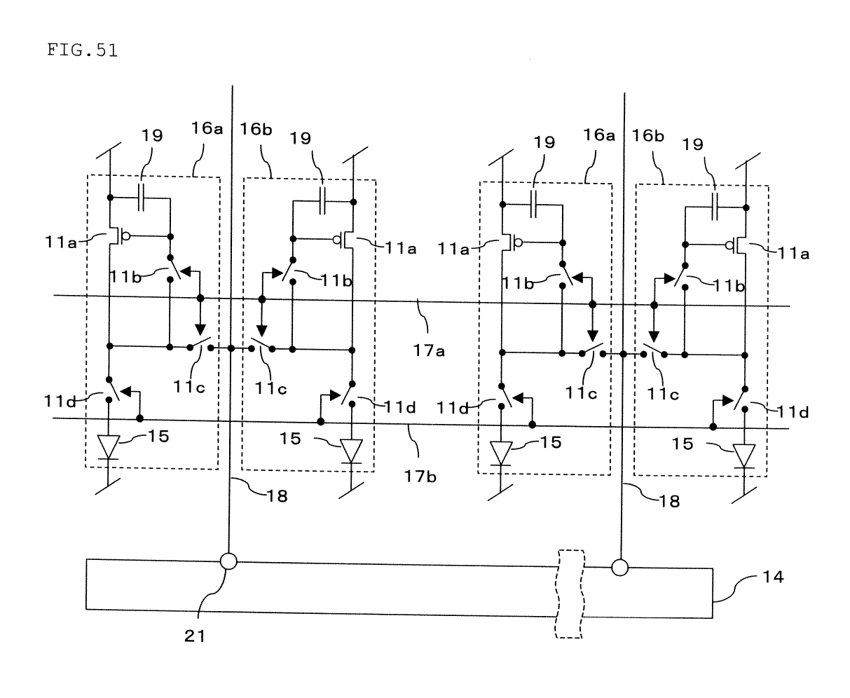

In order to reduce the output terminals 21 of the source driver circuit 14, it is effective to configure the pixels 16a and 16b as in FIG. 51. One source signal line 18 is connected to one output terminal 21. Two lines of pixels are connected to one source signal line. The pixel 16a and the pixel 16b are connected to the same source signal line 18.

The reset current Ia, the gradation voltage Vx or the target gradation voltage Vc is applied to the source signal line 18. With some configurations of the embodiments of the present invention, the reset voltage Va is outputted.

The reset current Ia is applied to the pixel 16a during the first half of one horizontal scanning period, and the reset current Ia is applied to the pixel 16 during the period other than the periods for which the pixel 16 is selected. That is to say, the pixel 16a and the pixel 16b are selected by time-division.

In the voltage program system, temperature compensation is preferably performed on the gradation voltage Vx and the target gradation voltage Vc. That is because that the voltage/current (V-I) characteristics of the driver transistor 11a have the temperature dependency.

In the present invention, as shown in FIG. 52, the temperature detecting circuit (pixel) 521 with a configuration the same as or similar to that of the pixel 16 is formed on the array substrate. The temperature detecting circuit 521 is formed by the driver transistor 11 and the holding capacitor 19 for detecting a change in the temperature of the reset voltage Va.

A plurality of temperature detecting circuits 521 are formed on the array substrate. This is because that if one temperature detecting circuit 521 has a defect in it, the panel module will be defective. As in the embodiment of FIG. 52, at least one temperature detecting circuit 521 needs to be non-defective if only a plurality of temperature detecting circuits 521 are formed. The selector circuit 524 selects one temperature detecting circuit 521 from a plurality of temperature detecting circuits 521.

The constant current circuit 413 is connected to each temperature detecting circuit 521. The constant current circuit 413 is formed in the source driver circuit 14. The constant current circuit 413 is the same as the circuit which outputs the reset current Ia. The constant current circuit 413 flows the current with the same amount as that of the reset current Ia to the temperature detecting circuit 521. Therefore, the reset voltage Va of the driver transistor 11 of the temperature detecting circuit 521 is retrieved to the detecting wire 527.

The selector 524 selects one detecting wire 527 and outputs the reset current Va outputted to the detecting wire 527 to the AD conversion circuit 523. It is a matter of course that the selector 524 may change the temperature detecting circuit 521 to be selected at a VD or an HD timing. In such a case, the output Va of a plurality of temperature detecting circuit 521 is averaged.

The AD conversion circuit 523 converts the reset voltage Va into the digital data. A data comparing circuit 525 compares the reset voltage Va of the converted digital data to the data in the external storage circuit (for example, EEPROM) 522. In the external storage circuit 522, the reset voltage Va of the digital data at a normal temperature or a predetermined temperature is stored.

By comparing the reset voltage Va of the digital data at a normal temperature or a predetermined temperature and the reset temperature Va obtained by the temperature detecting circuit 521, a voltage fluctuation value corresponding to the temperature of the current panel is obtained. The temperature compensation circuit 526 performs temperature compensation on the gradation voltage Vx and the target gradation voltage Vc by using the voltage fluctuation value.

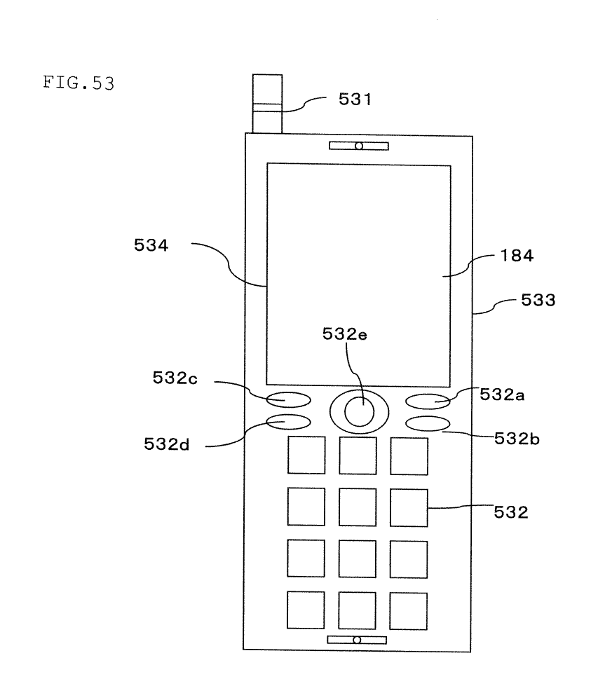

Description will be given to an apparatus or the like using the EL display panel, EL display apparatus or the driving method of the EL display apparatus of the present invention below. The apparatus below implements the apparatus or the method of the present invention mentioned above. FIG. 53 is a plane diagram of a cellular phone as an example of an information terminal device. The antenna 531 and a ten key 532 are attached to a cabinet 533.

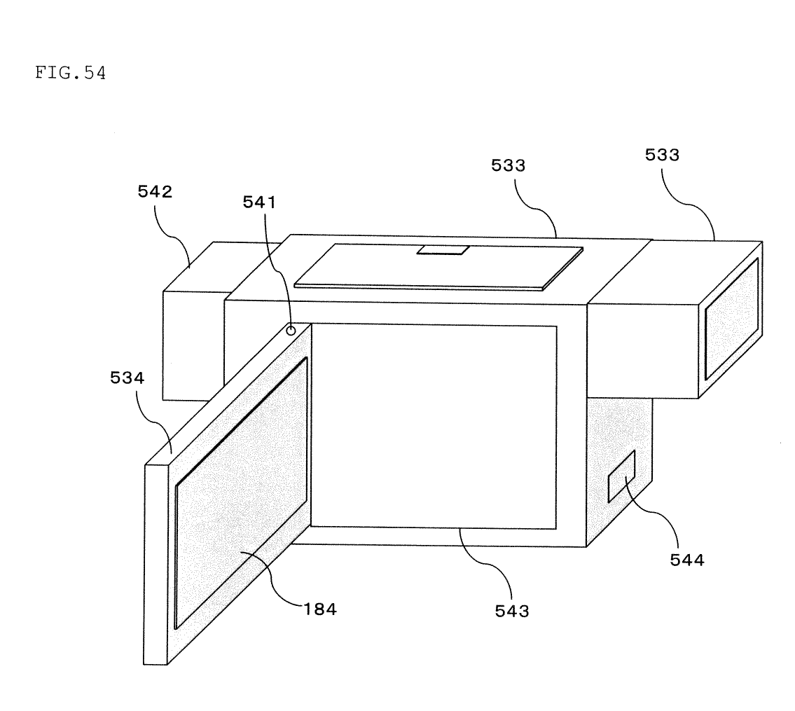

FIG. 54 is an oblique diagram of a video camera. The video camera has a shooting (image capturing) lens part 542 and the video camera body 533, with the shooting lens part 542 and a view finder part 533 are arranged back to back. An eyepiece cover is attached to the view finder 533. The observer (user) observes the display screen 184 of the display panel 534 from the eyepiece cover part.

The EL display panel of the present invention is also used as a display monitor. The display part 184 can freely adjust an angle with its pointing support 541. If the display unit 184 is not used, it is stored in the storing unit 543.

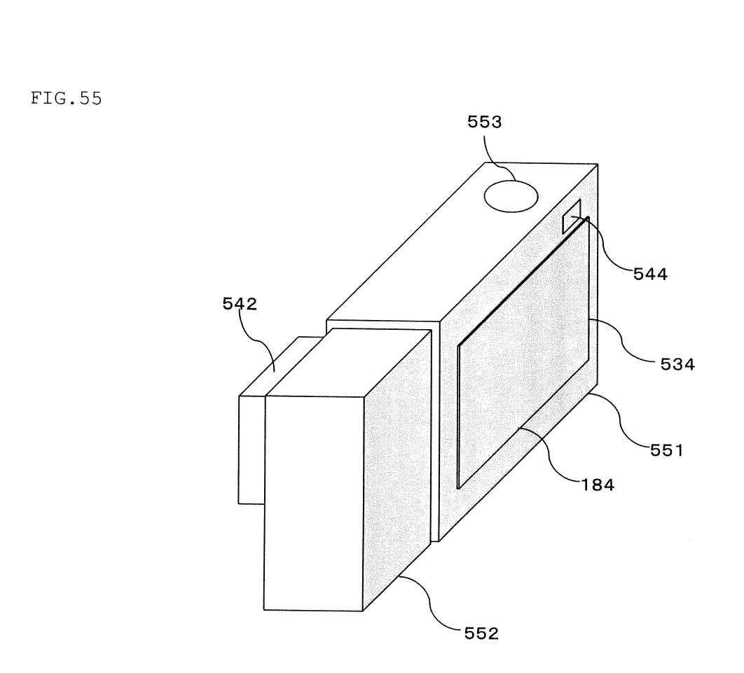

The EL display apparatus of the embodiment can be applied not only to a video camera but also an electronic camera, a steal camera or the like shown in FIG. 55. The display apparatus is used as a monitor 184 attached to the camera body 551. Other than a shutter 553, a switch 544 is attached to the camera body 551.

A technical idea such as the display apparatus, the driving method or a controlling method or system described in the embodiment of the present invention can be applied to a video camera, a projector, a three dimensional (3D) television, a projection television, a field emission display (FED), an SED (a display developed by Canon and Toshiba), and a PDP (plasma display panel) or the like.

The technical idea can be applied to the view finder, a main monitor, a sub monitor or a clock display part of the cellular phone, a PHS, a portable information terminal and its monitor, a digital camera, a satellite television, a satellite mobile television and its monitor. It can also be applied to an electronic photograph system, a head mount display, a direct sight monitor display, a note personal computer, a video camera, a digital steal camera and an electronic steal camera.

Incidentally, in the specification, a driver transistor 11a, a switching transistor 11b or the like is described as a thin film transistor, but they are not limited to the thin film transistor. They maybe a MOS-FET, a MOS transistor or a bipolar transistor.

The source driver circuit (IC) 14 may include not only a merely driver function but also a power source circuit, a buffer circuit (including a circuit such as a shift register), a level shifter circuit, a data conversion circuit, a latch circuit, a command decoder, an address conversion circuit, an image memory (RAM) and the like.

Although an array substrate 382 is described as a glass substrate, it may be formed with silicon wafer. The array substrate 382 may use a metal substrate, a ceramic substrate, a plastic sheet (plate) or the like.

Addition or subtraction in the specification does not mean working out by calculation. It has a wide idea such as voltage level shifting, level conversion, voltage multiplexing, amplification or the like. It is a mater of course that it means converting the obtained analog data into digital data for addition or subtraction. The term “to measure a voltage” is a wide concept including to obtain a voltage, to hold a voltage and to sample hold a voltage.

Description will be made, hereinafter, on an EL display apparatus and a driving method thereof according to embodiments of the present invention.

The present invention is not limited to each of the abovementioned embodiments and can be modified and altered in various ways without departing from the spirit of the present invention at the stages of implementation. Each embodiment can be implemented in combination with each other as required as much as possible.

What is claimed is:

1. An EL display apparatus in which pixels having EL elements are formed in a matrix, comprising:
a constant current circuit which generates a predetermined constant current; and
a gradation voltage circuit which generates a gradation voltage;
wherein said constant current generated by said constant current circuit is supplied to said pixels via a source signal line; and
said gradation voltage generated by said gradation voltage circuit is supplied to said pixels via said source signal line.

2. A driving method of an EL display apparatus in which pixels having EL elements are formed in a matrix, wherein said EL display apparatus comprises:
a constant current circuit which generates a predetermined constant current; and
a gradation voltage circuit which generates a gradation voltage;
wherein said pixel has a driver transistor for supplying a driving current to said EL element and a switching transistor for forming a current path between a source signal line and said driver transistor;
said driving method of the EL display element comprises the steps of:
applying said constant current generated by said constant current circuit to said pixel via said source signal line;
obtaining a potential of said source signal line, while said constant current is applied to said source signal line; and
adding said obtained potential to said gradation voltage or subtracting said gradation voltage from said obtained potential, and applying the result of said addition or subtraction to said driver transistor of said pixels via said source signal line.

3. The driving method of the EL display apparatus according to claim 2, wherein a pre-charge voltage is applied to said source signal line or said pixel during or before a period in which said constant current is applied to said pixel.

4. The driving method of the EL display apparatus according to claim 2, wherein a constant current circuit is formed by a plurality of unitary transistors.

5. An EL display apparatus in which pixels having EL elements are formed in a matrix, comprising:
a constant current circuit which generates a predetermined constant current; and
a gradation voltage circuit which generates a gradation voltage;
wherein said pixel has a driver transistor for supplying a driving current to said EL element, a capacitor connected to a gate terminal of said driver transistor, a first switching transistor for forming a current path between a source signal line and said driver transistor, and a second switching transistor for applying said gradation voltage to said driving transistor via said capacitor.

6. An EL display apparatus in which pixels having EL elements are formed in a matrix, comprising:
a constant current circuit which generates a predetermined constant current; and
a gradation voltage circuit which generates a gradation voltage;
a first signal line which supplies said constant current to said pixel; and
a second source signal line which supplies said gradation voltage to said pixel:
wherein said pixel has a driver transistor for supplying a driving current to said EL element, a capacitor connected to a gate terminal of said driver transistor, a first switching transistor for forming a current path between said first source signal line and said driver transistor, and a second switching transistor for forming an electronic path between said second source signal line and a capacitor.

7. An EL display apparatus in which pixels having EL elements are formed in a matrix, comprising:
a constant current circuit which generates a predetermined constant current;
a gradation voltage circuit which generates a gradation voltage;
a capacitor; and
a source signal line which supplies said constant current to said pixel;
wherein said gradation voltage is applied to said source signal line via said capacitor.

8. An EL display apparatus, comprising:
a display unit in which pixels having EL elements are formed in a matrix;
a constant current output circuit which outputs a reset current to a driver transistor of said EL element;
a voltage holding circuit which obtains a gate terminal potential of said driver transistor while said reset current is applied;
a gradation voltage circuit which outputs a gradation voltage corresponding to a video signal; and
a voltage applying circuit which adds said gate terminal potential, to said gradation voltage or subtracts said gradation voltage from said gate terminal potential, and applying the result of said addition or subtraction to a gate terminal of said driver transistor.
